(19) United States
(12) Patent Application Publication
(10) Pub. No.: US 2024/0228372 A1
(43) Pub. Date: Jul. 11, 2024

(54) FIBERGLASS INSULATION PRODUCT WITH IMPROVED CAVITY RETENTION

(71) Applicant: Owens Corning Intellectual Capital, LLC, Toledo, OH (US)

(72) Inventors: David DeCarolis, Pataskala, OH (US); Kelsey Mullett, Johnstown, OH (US); Tim Slone, Newark, OH (US); Brenna Cuadrado, Columbus, OH (US)

(21) Appl. No.: 18/562,955

(22) PCT Filed: Jun. 3, 2022
(86) PCT No.: PCT/US2022/032050

§ 371 Date: Nov. 21, 2023

Related U.S. Application Data
(60) Provisional application No. 63/196,872, filed on Jun. 4, 2021.

(51) Int. Cl. C03C 25/323; C03C 25/1095; E04B 1/78

(52) U.S. Cl. CPC C03C 25/323; C03C 25/1095; E04B 1/78

(57) ABSTRACT

A fibrous insulation product that exhibits improved cavity retention ability.

### RELATED APPLICATION(S)

This application is the U.S. national stage entry of International Application No. PCT/US2022/032050, filed Jun. 3, 2022, which claims priority to and any benefit of U.S. Provisional Application No. 63/196,872, filed Jun. 4, 2021, the contents of which are incorporated herein by reference in their entireties.

### FIELD

The present application generally relates to fiberglass insulation products, and more particularly, to fiberglass insulation products with improved performance properties.

### BACKGROUND

The term “fibrous insulation product” encompasses a variety of compositions, articles of manufacture, and manufacturing processes. Mineral fibers, such as glass fibers, are commonly used in insulation products and nonwoven mats. Fibrous insulation is typically manufactured by fiberizing a molten composition of polymer, glass, or other mineral fibers from a fiberizing apparatus, such as a rotating spinner. To form an insulation product, fibers produced by the rotating spinner are drawn downwardly from the spinner towards a conveyor by a blower. As the fibers move downward, a binder composition is sprayed onto the fibers and the fibers are collected into a high loft, continuous blanket on the conveyor. The fiber-binder matrix gives the insulation product resiliency for recovery after packaging and provides stiffness and handleability so that the insulation product can be handled and applied as needed in the insulation cavities of buildings. The binder composition also provides protection to the fibers from interfilament abrasion and promotes compatibility between the individual fibers.

The blanket containing the binder-coated fibers is then passed through a curing oven and the binder is cured to set the blanket to a desired thickness. After the binder composition has cured, the fiber insulation may be cut into lengths to form individual insulation products, and the insulation products may be packaged for shipping to customer locations. One typical insulation product produced is an insulation batt or blanket, which is suitable for use as cavity (e.g., wall, floor, ceiling) insulation in residential dwellings or other buildings, and which might also be used to insulate an attic or other portions of a building. Such a batt or blanket is typically a unitary structure that may be relatively flexible or rollable. Another common insulation product is air-blown or loose-fill insulation, which is suitable for use as sidewall and attic insulation in residential and commercial buildings as well as in hard-to-reach locations. Such loose-fill insulation is often formed as many relatively small discrete pieces, tufts, or the like, which may or may not have a binder applied thereto. Loose-fill insulation can also be formed of small cubes that are cut from insulation blankets, compressed, and packaged in bags.

The insulating performance of a thermal insulation material is mainly determined by the ratio of the material's thickness divided by its thermal conductivity (k), which measures the amount of heat (in BTUs per hour) that will be transmitted through one square foot of 1-inch thick insulation in order to cause the temperature to rise or fall one degree from one side of the insulation to the other. The higher the thickness, and the lower the k-value, the better the insulating performance of the material.

Fibrous insulation for building products requires low thermal conductivity to be an effective insulator in wall and ceiling cavities. It is also desirable to reduce overall product weight, although generally, reducing product weight negatively impacts thermal performance. Particularly, attempts have been made to reduce product weight by reducing the diameter of the fibers used to form the fibrous insulation products, which conventionally have an average fiber diameter of about 4 microns (m) (with 1 μm being equal to 3.94 hundred thousandths of an inch or 1.0 HT) or more.

However, such a reduction of fiber diameter has traditionally been found to negatively impact the insulation value (R-value) of a product at a particular area weight and product thickness. Thus, reducing the average fiber diameter of an insulation product below 4 m has previously not been practical, as such products were unable to meet performance requirements while still being economical. Accordingly, there is an unmet need for insulation products formed from fibers thinner than 4 μm that effectively meet the necessary performance requirements, such as thermal performance, and may also improve overall material efficiency.

### SUMMARY

The general inventive concepts relate to a fibrous insulation product having relatively fine average fiber diameter (e.g., less than 3.80 μm (15 HT)) and demonstrates good cavity retention.

In one exemplary embodiment, a fibrous insulation product comprises: a plurality of glass fibers; and a cross-linked formaldehyde-free binder at least partially coating the fibers, wherein the cross-linked formaldehyde-free binder is formed from an aqueous binder composition comprising 5.0% by weight to 37.0% by weight of at least one monomeric polyol having at least four hydroxyl groups, based on the total solids content of the aqueous binder composition; wherein the quantity of the cross-linked formaldehyde-free binder on the fibers is in the range of 2% to 10% by weight of the fibrous insulation product; wherein the R-value of the fibrous insulation product is in the range of 10 to 54; wherein the glass fibers have an average fiber diameter less than or equal to 3.80 μm (15 HT); wherein the fibrous insulation product has a density, when uncompressed, in the range of 4.80 kg/m3 (0.3 pcf) to 43.25 kg/m3 (2.7 pcf); and wherein the fibrous insulation product has a maximum failure force (wall) per product weight of 39.2 N/kg (4.0 lbf/lb.) or greater.

In some exemplary embodiments, a maximum failure force (wall) per product weight of 43.2 N/kg (4.4 lbf/lb.) or greater.

In some exemplary embodiments, the glass fibers have an average fiber diameter in the range of 2.03 μm (8 HT) to 3.81 μm (15 HT).

In some exemplary embodiments, the glass fibers have an average fiber diameter in the range of 3.05 μm (12 HT) to 3.81 μm (15 HT).

In some exemplary embodiments, the glass fibers have an average fiber diameter in the range of 2.03 μm (8 HT) to 3.05 μm (12 HT).

In some exemplary embodiments, the aqueous binder composition further comprises at least 50.0% by weight of a cross-linking agent comprising a polymeric polycarboxylic acid having at least two carboxylic acid groups, based on the total solids content of the aqueous binder composition; wherein a ratio of molar equivalents of carboxylic acid groups to hydroxyl groups in the aqueous binder composition is between 0.60/1.0 and 1.0/0.6.

In some exemplary embodiments, the ratio of molar equivalents of carboxylic acid groups to hydroxyl groups in the aqueous binder composition is between 0.80/1.0 and 1.0/0.8.

In some exemplary embodiments, the quantity of the cross-linked formaldehyde-free binder on the fibers is in the range of 3.6% to 6.3% by weight of the fibrous insulation product.

In some exemplary embodiments, the cross-linking agent is polyacrylic acid.

In some exemplary embodiments, the cross-linking agent is present in the aqueous binder composition in an amount from 50.0% by weight to 85% by weight, based on the total solids content of the aqueous binder composition.

In some exemplary embodiments, the monomeric polyol comprises at least five hydroxyl groups.

In some exemplary embodiments, the monomeric polyol comprises one or more of a sugar alcohol, pentaerythritol, a primary alcohol, 1,2,4-butanetriol, trimethylolpropane, a short-chain alkanolamine, and mixtures thereof.

In some exemplary embodiments, the monomeric polyol has a number average molecular weight of less than 2,000 Daltons.

In some exemplary embodiments, the aqueous binder composition further includes at least one long-chain polyol having at least two hydroxyl groups and a number average molecular weight of at least 2,000 Daltons.

In some exemplary embodiments, the long-chain polyol is selected from the group consisting of polyvinyl alcohol and polyvinyl acetate.

In some exemplary embodiments, the long-chain polyol is present in the binder composition in an amount from about 2.5 wt. % to about 30 wt. %, based on the total solids content of the aqueous binder composition.

In some exemplary embodiments, the aqueous binder composition has a viscosity at 40% solids and 25° C. of 10 cP to 65 cP.

In some exemplary embodiments, the aqueous binder composition has a viscosity at 40% solids and 25° C. of 300 cP to 500 cP.

In some exemplary embodiments, the R-value of the fibrous insulation product is in the range of 10 to 16.

In some exemplary embodiments, the R-value of the fibrous insulation product is in the range of 32 to 54.

In some exemplary embodiments, the quantity of the cross-linked formaldehyde-free binder on the fibers is in the range of 2% to 5% by weight of the fibrous insulation product, the R-value of the fibrous insulation product is in the range of 16 to 28, the glass fibers have an average fiber diameter of 3.05 μm (12 HT) to 3.81 μm (15 HT), and the fibrous insulation product has a density, when uncompressed, in the range of 8.0 kg/m3 (0.5 pcf) to 16.0 kg/m3 (1.0 pcf).

In one exemplary embodiment, a fibrous insulation product comprises: a plurality of glass fibers; and a cross-linked formaldehyde-free binder at least partially coating the fibers, wherein the cross-linked formaldehyde-free binder is formed from an aqueous binder composition comprising 5.0% by weight to 37.0% by weight of at least one monomeric polyol having at least four hydroxyl groups, based on the total solids content of the aqueous binder composition; wherein the quantity of the cross-linked formaldehyde-free binder on the fibers is in the range of 2% to 10% by weight of the fibrous insulation product; wherein the R-value of the fibrous insulation product is in the range of 10 to 54; wherein the glass fibers have an average fiber diameter less than or equal to 3.81 μm (15 HT); wherein the fibrous insulation product has a density, when uncompressed, in the range of 4.80 kg/m3 (0.3 pcf) to 43.25 kg/m3 (2.7 pcf); and wherein the fibrous insulation product has an average normal force of 3781 N (850 lbf) or greater.

In some exemplary embodiments, the fibrous insulation product has a maximum failure force (ceiling) of 2 kg or greater.

In some exemplary embodiments, the glass fibers have an average fiber diameter in the range of 2.03 μm (8 HT) to 3.81 μm (15 HT).

In some exemplary embodiments, the glass fibers have an average fiber diameter in the range of 3.05 μm (12 HT) to 3.81 μm (15 HT).

In some exemplary embodiments, the glass fibers have an average fiber diameter in the range of 2.03 μm (8 HT) to 3.05 μm (12 HT).

In some exemplary embodiments, the aqueous binder composition further comprises at least 50.0% by weight of a cross-linking agent comprising a polymeric polycarboxylic acid having at least two carboxylic acid groups, based on the total solids content of the aqueous binder composition; wherein a ratio of molar equivalents of carboxylic acid groups to hydroxyl groups in the aqueous binder composition is between 0.60/1.0 and 1.0/0.6.

In some exemplary embodiments, the ratio of molar equivalents of carboxylic acid groups to hydroxyl groups in the aqueous binder composition is between 0.80/1.0 and 1.0/0.8.

In some exemplary embodiments, the quantity of the cross-linked formaldehyde-free binder on the fibers is in the range of 3.6% to 6.3% by weight of the fibrous insulation product.

In some exemplary embodiments, the cross-linking agent is polyacrylic acid.

In some exemplary embodiments, the cross-linking agent is present in the aqueous binder composition in an amount from 50.0% by weight to 85% by weight, based on the total solids content of the aqueous binder composition.

In some exemplary embodiments, the monomeric polyol comprises at least five hydroxyl groups.

In some exemplary embodiments, the monomeric polyol comprises one or more of a sugar alcohol, pentaerythritol, a primary alcohol, 1,2,4-butanetriol, trimethylolpropane, a short-chain alkanolamine, and mixtures thereof.

In some exemplary embodiments, the monomeric polyol has a number average molecular weight of less than 2,000 Daltons.

In some exemplary embodiments, the aqueous binder composition further includes at least one long-chain polyol having at least two hydroxyl groups and a number average molecular weight of at least 2,000 Daltons.

In some exemplary embodiments, the long-chain polyol is selected from the group consisting of polyvinyl alcohol and polyvinyl acetate.

In some exemplary embodiments, the long-chain polyol is present in the binder composition in an amount from about 2.5 wt. % to about 30 wt. %, based on the total solids content of the aqueous binder composition.

In some exemplary embodiments, the aqueous binder composition has a viscosity at 40% solids and 25° C. of 10 cP to 65 cP.

In some exemplary embodiments, the aqueous binder composition has a viscosity at 40% solids and 25° C. of 300 cP to 500 cP.

In some exemplary embodiments, the R-value of the fibrous insulation product is in the range of 10 to 16.

In some exemplary embodiments, the R-value of the fibrous insulation product is in the range of 32 to 54.

In some exemplary embodiments, the quantity of the cross-linked formaldehyde-free binder on the fibers is in the range of 2% to 5% by weight of the fibrous insulation product, the R-value of the fibrous insulation product is in the range of 16 to 28, the glass fibers have an average fiber diameter of 3.05 μm (12 HT) to 3.81 μm (15 HT), and the fibrous insulation product has a density, when uncompressed, in the range of 8.0 kg/m3 (0.5 pcf) to 16.0 kg/m3 (1.0 pcf).

Other aspects and features of the general inventive concepts will become more readily apparent to those of ordinary skill in the art upon review of the following description of various exemplary embodiments in conjunction with the accompanying figures.

### BRIEF DESCRIPTION OF THE DRAWINGS

Features and advantages of the present invention will become apparent to those of ordinary skill in the art to which the invention pertains from a reading of the following description together with the accompanying drawings, in which:

Features and advantages of the present invention will become apparent to those of ordinary skill in the art to which the invention pertains from a reading of the following description together with the accompanying drawings, in which:

FIG. 1 is a perspective view of an exemplary embodiment of a fibrous insulation product.

FIG. 2 is an elevational view of an exemplary embodiment of a manufacturing line for producing the fibrous insulation product of FIG. 1.

FIG. 3 is a scanning electron microscope (“SEM”) image illustrating a section of an exemplary fibrous insulation product formed with glass fibers having an average fiber diameter of 3.68 μm (14.5 HT).

FIG. 4 is an SEM image illustrating a section of an exemplary fibrous insulation product formed with glass fibers having an average fiber diameter of 3.68 μm (14.5 HT).

FIG. 5 is an SEM image illustrating a section of a conventional fibrous insulation product formed with glass fibers having an average fiber diameter of 4.24 μm (16.7 HT) and an insulation value of R-21.

FIG. 6 is a graphical representation of the fiber orientation distribution within +/−15° of a plane parallel to the product length L₁ (0°) taken from the cross-section along the machine direction of an exemplary fibrous insulation product formed with glass fibers having an average fiber diameter of 3.68 μm (14.5 HT).

FIG. 7 is a graphical representation of the fiber orientation distribution within +/−30° of a plane parallel to the product length L₁ (0°) taken from the cross-section along the machine direction of an exemplary fibrous insulation product formed with glass fibers having an average fiber diameter of 3.68 μm (14.5 HT).

FIG. 8 is a graphical representation of the fiber orientation distribution within +/−50° of a plane parallel to the product length L₁ (0°) taken from the cross-section along the machine direction of an exemplary fibrous insulation product formed with glass fibers having an average fiber diameter of 3.68 μm (14.5 HT).

FIGS. 9(a)-9(c) are SEM images showing parallel fiber bundles present in an exemplary fibrous insulation product formed with glass fibers having an average fiber diameter of 3.68 μm (14.5 HT).

FIGS. 10(a)-10(c) are SEM images showing parallel fiber bundles present in an exemplary fibrous insulation product formed with glass fibers having an average fiber diameter of 3.68 μm (14.5 HT).

FIGS. 11(a)-11(b) are SEM images showing binder gussets present in an exemplary fibrous insulation product formed with glass fibers having an average fiber diameter of 3.68 m (14.5 HT).

FIG. 12 graphically illustrates a predicted thermal conductivity (k-value) curve per product density compared to an actual thermal conductivity (k-value) curve per product density.

FIG. 13 graphically illustrates a predicted material efficiency curve per product density compared to an actual material efficiency curve per product density.

FIG. 14 is a diagram illustrating a testing system that was used to quantify recovery from and resistance to compressive forces applied to fibrous insulation products.

FIG. 15 is a graph showing improved resistance to compression by a fibrous insulation product according to the general inventive concepts.

FIG. 16 is a graph showing improved recovery from compression by a fibrous insulation product according to the general inventive concepts.

FIG. 17 is a graph showing improved compression recovery capability by a fibrous insulation product according to the general inventive concepts.

FIG. 18 is a graph showing improved resistance to recovery degradation by a fibrous insulation product according to the general inventive concepts.

FIG. 19 is a graph showing improved resistance to compression by a fibrous insulation product according to the general inventive concepts.

FIG. 20 is a graph showing improved recovery from compression by a fibrous insulation product according to the general inventive concepts.

FIG. 21 is a graph showing improved compression recovery capability by a fibrous insulation product according to the general inventive concepts.

FIGS. 22A-22F are diagrams illustrating a testing system that was used to quantify expansion from a compressed (e.g., packaged) state, as well as the rate of the expansion, by fibrous insulation products.

FIG. 23 is a graph showing improved product expansion from a package by a fibrous insulation product according to the general inventive concepts.

FIG. 24 is a graph showing an improved rate of product expansion from a package by a fibrous insulation product according to the general inventive concepts.

FIG. 25 is a graph showing an improved rate of product expansion from a package by a fibrous insulation product according to the general inventive concepts.

FIG. 26 is a graph showing an expansion ratio from a package by a fibrous insulation product according to the general inventive concepts.

FIG. 27 is a graph showing an expansion ratio by weight from a package by a fibrous insulation product according to the general inventive concepts.

FIG. 28 is diagram illustrating a testing system that was used to quantify cavity retention in a ceiling cavity for a fibrous insulation product.

FIG. 29 is a section view of a force sensing arrangement of the system of FIG. 28.

FIG. 30 is a front view of the force sensing arrangement of FIG. 29.

FIG. 31 is a graph showing improved average normal force by a fibrous insulation product according to the general inventive concepts.

FIG. 32 is a graph showing an improved maximum failure force (ceiling) by a fibrous insulation product according to the general inventive concepts.

FIG. 33 is diagram illustrating a testing system that was used to quantify cavity retention in a wall cavity for a fibrous insulation product according to the general inventive concepts.

FIG. 34 is a graph showing improved maximum failure force (wall) by a fibrous insulation product according to the general inventive concepts.

FIG. 35 is a graph showing an improved maximum failure force (wall) per weight by a fibrous insulation product according to the general inventive concepts.

FIG. 36 is a graph showing improved maximum failure force (wall) by a fibrous insulation product according to the general inventive concepts.

FIG. 37 is a graph showing an improved maximum failure force (wall) per weight by a fibrous insulation product according to the general inventive concepts.

### DETAILED DESCRIPTION

Unless otherwise defined, all technical and scientific terms used herein have the same meaning as commonly understood by one of ordinary skill in the art to which these exemplary embodiments belong. The terminology used in the description herein is for describing exemplary embodiments only and is not intended to be limiting of the exemplary embodiments. Accordingly, the general inventive concepts are not intended to be limited to the specific embodiments illustrated herein. Although other methods and materials similar or equivalent to those described herein can be used in the practice or testing of the present invention, the preferred methods and materials are described herein.

As used in the specification and the appended claims, the singular forms “a, “an,” and “the” are intended to include the plural forms as well, unless the context clearly indicates otherwise.

Unless otherwise indicated, all numbers expressing quantities of ingredients, chemical and molecular properties, reaction conditions, and so forth, as well as physical and measured attributes, used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present exemplary embodiments. At the very least each numerical parameter should be construed in light of the number of significant digits and ordinary rounding approaches.

Unless otherwise indicated, any element, property, feature, or combination of elements, properties, and features, may be used in any embodiment disclosed herein, regardless of whether the element, property, feature, or combination of elements, properties, and features was explicitly disclosed in the embodiment. It will be readily understood that features described in relation to any particular aspect described herein may be applicable to other aspects described herein provided the features are compatible with that aspect. In particular: features described herein in relation to the method may be applicable to the fibrous product and vice versa; features described herein in relation to the method may be applicable to the aqueous binder composition and vice versa; and features described herein in relation to the fibrous product may be applicable to the aqueous binder composition and vice versa.

Notwithstanding that the numerical ranges and parameters setting forth the broad scope of the exemplary embodiments are approximations, the numerical values set forth in the specific examples are reported as precisely as possible. Any numerical value, however, inherently contains certain errors necessarily resulting from the standard deviation found in their respective testing measurements. Every numerical range given throughout this specification and claims will include every narrower numerical range that falls within such broader numerical range, as if such narrower numerical ranges were all expressly written herein.

As used herein, the terms “binder composition,” “aqueous binder composition,” “binder formulation,” “binder,” and “binder system” may be used interchangeably and are synonymous. Additionally, as used herein, the terms “formaldehyde-free” or “no added formaldehyde” may be used interchangeably and are synonymous.

All numerical ranges are understood to include all possible incremental sub-ranges within the outer boundaries of the range. Thus, for example, a density range of 0.2 pcf to 2.0 pcf discloses, for example, 0.5 pcf to 1.2 pcf, 0.7 pcf to 1.0 pcf, etc.

By “substantially free” it is meant that a composition includes less than 1.0% by weight of the recited component, including no greater than 0.8% by weight, no greater than 0.6% by weight, no greater than 0.4% by weight, no greater than 0.2% by weight, no greater than 0.1% by weight, no greater than 0.5% by weight, and no greater than 0.01% by weight.

As used herein, the unit “pounds” or “lb” refers to pounds-mass.

The present disclosure relates to fiberglass insulation products formed with fine diameter glass fibers (i.e., fibers having an average fiber diameter less than or equal to 3.81 μm (15 HT) to achieve a more favorable fiber orientation and product structure. The fiberglass insulation products demonstrate surprisingly improved thermal performance and overall material efficiency.

The fibrous insulation products of the present disclosure comprise a plurality of fibers, such as organic or inorganic fibers. In certain exemplary embodiments, the plurality of fibers are inorganic fibers, including, but not limited to glass fibers, glass wool fibers, mineral wool fibers, slag wool fibers, stone wool fibers, ceramic fibers, metal fibers, and combinations thereof.

Optionally, the fibers may comprise natural fibers and/or synthetic fibers such as carbon, polyester, polyethylene, polyethylene terephthalate, polypropylene, polyamide, aramid, and/or polyaramid fibers. The term “natural fiber” as used herein refers to plant fibers extracted from any part of a plant, including, but not limited to, the stem, seeds, leaves, roots, or phloem. Examples of natural fibers suitable for use in the insulation products include wood fibers, cellulosic fibers, straw, wood chips, wood strands, cotton, jute, bamboo, ramie, bagasse, hemp, coir, linen, kenaf, sisal, flax, henequen, and combinations thereof. The fibrous insulation products may be formed entirely of one type of fiber, or they may be formed of a combination of types of fibers. For example, the fibrous insulation products may be formed of combinations of various types of glass fibers or various combinations of different inorganic fibers and/or natural fibers depending on the desired application. In any of the embodiments disclosed herein, the insulation products may be formed substantially of or entirely of glass fibers.

The fibrous insulation products utilize glass fibers having a smaller diameter than the glass fibers used in conventional fiberglass insulation products, particularly residential insulation products that typically have an average fiber diameter greater than 4 μm (15.7 HT), such as 4.24 μm (16 HT) or 4.57 μm (18 HT). In particular, the exemplary fibrous insulation products disclosed or suggested herein may include glass fibers having an average fiber diameter, prior to the application of the binder composition, equal to or less than 3.81 μm (15 HT), including average fiber diameters no greater than 3.76 μm (14.8 HT), no greater than 3.68 m (14.5 HT), no greater than 3.61 μm (14.2 HT), no greater than 3.56 μm (14 HT), no greater than 3.43 μm (13.5 HT), no greater than 3.30 μm (13 HT), no greater than 3.18 μm (12.5 HT), and no greater than 3.05 μm (12 HT). In any of the exemplary embodiments, the fibrous insulation product may include glass fibers having an average fiber diameter in the range of 3.05 μm (12.0 HT) to 3.81 μm (15.0 HT), or in the range of 3.30 μm (13.0 HT) to 3.76 μm (14.8 HT), or in the range of 3.43 μm (13.5 HT) to 3.61 μm (14.2 HT). In other exemplary embodiments, the insulation product may include glass fibers having an average fiber diameter in the range of 2.03 μm (8.0 HT) to 3.05 μm (12.0 HT), or in the range of 2.29 μm (9.0 HT) to 2.79 μm (11.0 HT), or in the range of 2.03 μm (8.0 HT) to 2.54 μm (10.0 HT).

An exemplary procedure used to measure the diameters of the glass fibers utilizes a scanning electron microscope (SEM) to directly measure fiber diameter. In general, a specimen of the fibrous insulation product is heated to remove any organic materials (e.g., binder composition) therefrom, the glass fibers from the specimen are then reduced in length and photographed by the SEM. The diameters of the fibers are then measured from the saved images by image processing software associated with the SEM.

More specifically, a specimen of the fibrous insulation product is heated to 800° F. for a minimum of 30 minutes. The specimen may be heated longer if required to ensure removal of any organic materials. The specimen is then cooled to room temperature and the glass fibers are reduced in length in order to fit onto an SEM planchette. The glass fibers may be reduced in length by any suitable method, such as for example, cut by scissors, chopped by a razor blade, or ground in a mortar and pestle. The glass fibers are then adhered to the surface of the SEM planchette such that the fibers are not overlapping or spaced too far apart.

Once the specimen is prepared for imaging, the specimen is mounted in the SEM using normal operating procedures and photographed by the SEM at appropriate magnification for the diameter size of the fibers being measured. A sufficient number of images are collected and saved to ensure enough fibers are available for measuring. For example, 10 to 13 images may be required where 250 to 300 individual fibers are being measured. The fiber diameters are then measured using an SEM image analysis software program, such as for example, Scandium SIS imaging software. An average fiber diameter of the specimen is then determined from the number of fibers measured. The fibrous insulation product specimen may include glass fibers that are fused together (i.e., two or more fibers joined along their lengths). For the purpose of calculating the average fiber diameter of specimens in the present disclosure, fused fibers are treated as single fibers.

An alternative procedure used to measure the average fiber diameter of the glass fibers utilizes a device that measures air flow resistance to indirectly determine the mean or “effective” fiber diameter of the distributed fibers in a specimen. More specifically, in one embodiment of the alternative procedure, a specimen of the fibrous insulation product is heated to 427-538° C. (800-1,000° F.) for 30 minutes. The specimen may be heated longer if required to ensure removal of any organic materials from the surface of the fibers. The specimen is then cooled to room temperature and a test specimen weighing about 7.50 grams is loaded into the device's chamber. A constant air flow is applied through the chamber, and once the air flow has stabilized, the differential pressure, or pressure drop, through the specimen is measured by the device. Based on the air flow and differential pressure measurements, the device can compute the average fiber diameter of the specimen.

The fibrous insulation products of the present disclosure comprise a formaldehyde-free or “no added formaldehyde” aqueous binder compositions for use in binding the inorganic fibers in the manufacture of the insulation products. The phrase “binder composition” refers to organic agents or chemicals, often polymeric resins, used to adhere the inorganic fibers to one another in a three-dimensional structure. The binder composition may be in any form, such as a solution, an emulsion, or dispersion. “Binder dispersions” or “binder emulsions” thus refer to mixtures of binder chemicals in a medium or vehicle. As used herein, the terms “binder composition,” “aqueous binder composition,” “binder formulation,” “binder,” and “binder system” may be used interchangeably and are synonymous. Additionally, as used herein, the terms “formaldehyde-free” or “no added formaldehyde” may be used interchangeably and refer to a binder composition including less than about 1 ppm formaldehyde when cured or otherwise dried. The 1 ppm is based on the weight of the product being measured for formaldehyde release.

A wide variety of binder compositions may be used with the glass fibers of the present invention. For example, binder compositions fall into two broad, mutually exclusive classes: thermoplastic and thermosetting. Both thermoplastic and thermosetting binder compositions may be used with the invention. A thermoplastic material may be repeatedly heated to a softened or molten state and will return to its former state upon cooling. In other words, heating may cause a reversible change in the physical state of a thermoplastic material (e.g., from solid to liquid) but it does not undergo any irreversible chemical reaction. Exemplary thermoplastic polymers suitable for use in the fibrous insulation product 100 include, but are not limited to, polyvinyls (such as polyvinyl acetate, polyvinyl alcohol, polyvinyl butyral, and the like), polyethylene terephthalate (PET), polypropylene or polyphenylene sulfide (PPS), nylon, polycarbonates, polystyrene, polyamides, polyolefins, acrylic and methacrylic acid ester resins, and certain copolymers of polyacrylates.

In contrast, the term thermosetting polymer refers to a range of systems which exist initially as liquids but which, on heating, undergo a reaction to form a solid, highly crosslinked matrix. Thus, thermosetting compounds comprise reactant systems, often pairs of reactants, that irreversibly crosslink upon heating. When cooled, they do not regain their former liquid state but remain irreversibly crosslinked.

The reactants useful as thermosetting compounds generally have one or more of several reactive functional groups: e.g., amine, amide, carboxyl, or hydroxyl. As used herein, “thermoset compound” (and its derivative clauses like “thermosetting compound,” “thermosetting binder” or “thermoset binder”) refers to at least one of such reactants, it being understood that two or more may be necessary to form the crosslinking system characteristic of thermosetting compounds. In addition to the principal reactants of the thermosetting compounds, there may be catalysts, process aids, and other additives.

One category of thermosetting binders includes a variety of phenol-aldehyde, urea-aldehyde, melamine-aldehyde, and other condensation-polymerization materials.

Phenolic/formaldehyde binder compositions are a known thermosetting binder system and have historically been favored for their low cost and the ability to go from a low viscosity liquid in the uncured state to a rigid thermoset polymer when cured.

Formaldehyde-free, thermosetting binder systems may include those based on polycarboxy polymers and a polyol. An example is the polyacrylic acid/polyol/polyacid binder system described in U.S. Pat. Nos. 6,884,849 and 6,699,945 to Chen et al., the entire contents of which are each expressly incorporated herein by reference. Another example is the polymeric polycarboxylic acid/long chain polyol/short chain polyol binder system described in U.S. Patent Publ. No. 2019/0106564 to Zhang, et al., the disclosure of which being fully incorporated herein by reference. Another example is the polymeric polycarboxylic acid/monomeric polyol binder system described in U.S. Provisional Patent Application No. 63/086,267, the disclosure of which being fully incorporated herein by reference. Yet another example is the polycarboxylic acid/polyol/nitrogen-based protective agent binder system described in U.S. Provisional Patent Application No. 63/073,013, the disclosure of which being fully incorporated herein by reference.

A second category of formaldehyde-free, thermosetting binder compositions are referred to as “bio-based” or “natural” binders. “Bio-based binder” and “natural binder” are used interchangeably herein to refer to binder compositions made from nutrient compounds, such as carbohydrates, proteins, or fats, which have much reactive functionality. Because they are made from nutrient compounds, they are environmentally friendly. Bio-based binder compositions are described in more detail in U.S. Pat. Publication No. 2011/0086567 to Hawkins et al., filed Oct. 8, 2010, the entire contents of which are expressly incorporated herein by reference.

In some exemplary embodiments, the binder includes Owens-Corning's EcoTouch™ binder or EcoPure™ binder, Owens Corning's Sustaina™ binder, or Knauf's ECOSE® binder.

Alternative reactants useful as thermosetting compounds are triammonium citrate-dextrose systems derived from mixing dextrose monohydrate, anhydrous citric acid, water and aqueous ammonia. Additionally, carbohydrate reactants and polyamine reactants are useful thermosetting compounds, wherein such thermosetting compounds are described in more detail in U.S. Pat. Nos. 8,114,210, 9,505,883 and 9,926,464, the disclosures of which are hereby incorporated by reference.

It has surprisingly been discovered that fibrous insulation products manufactured using glass fibers having an average fiber diameter below 3.81 μm (15 HT) have improved properties when manufactured using a formaldehyde-free binder composition comprising a polyol and a primary cross-linking agent, such as a polycarboxylic acid or salt thereof. Particularly notable improvements have been discovered when the polyol included in the binder composition is a monomeric polyol.

The primary crosslinking agent may be any compound suitable for crosslinking a polyol. Non-limiting examples of suitable cross-linking agents include polycarboxylic acid-based materials having one or more carboxylic acid groups (—COOH), such as monomeric and polymeric polycarboxylic acids, including salts or anhydrides thereof, and mixtures thereof. In any of the exemplary embodiments, the polycarboxylic acid may be a polymeric polycarboxylic acid, such as a homopolymer or copolymer of acrylic acid. The polymeric polycarboxylic acid may comprise polyacrylic acid (including salts or anhydrides thereof) and polyacrylic acid-based resins such as QR-1629S and Acumer 9932, both commercially available from The Dow Chemical Company, polyacrylic acid compositions commercially from CH Polymer, and polyacrylic acid compositions commercially available from Coatex. Acumer 9932 is a polyacrylic acid/sodium hypophosphite resin having a molecular weight of about 4,000 and a sodium hypophosphite content of 6-7% by weight, based on the total weight of the polyacrylic acid/sodium hypophosphite resin. QR-1629S is a polyacrylic acid/glycerin resin composition. Aquaset-529 is a composition containing polyacrylic acid crosslinked with glycerol.

The polycarboxylic acid may comprise a polymeric polycarboxylic acid, such as polyacrylic acid, poly(meth)acrylic acid, polymaleic acid, and like polymeric polycarboxylic acids, anhydrides, salts, or mixtures thereof, as well as copolymers of acrylic, methacrylic acid, maleic acid, and like carboxylic acids, anhydrides, salts, and mixtures thereof.

In any of the exemplary embodiments, the polycarboxylic acid may comprise a monomeric polycarboxylic acid, such as citric acid, itaconic acid, maleic acid, fumaric acid, succinic acid, adipic acid, glutaric acid, tartaric acid, trimellitic acid, hemimellitic acid, trimesic acid, tricarballylic acid, and the like, including salts or anhydrides thereof, and mixtures thereof.

The cross-linking agent may, in some instances, be pre-neutralized with a neutralization agent. Such neutralization agents may include organic and/or inorganic bases, such sodium hydroxide, ammonium hydroxide, and diethylamine, and any kind of primary, secondary, or tertiary amine (including alkanol amine). In various exemplary embodiments, the neutralization agents may include at least one of sodium hydroxide and triethanolamine.

The cross-linking agent is present in the binder composition in at least 30.0% by weight, based on the total solids content of the binder composition, including, without limitation at least 40% by weight, at least 45% by weight, at least 50% by weight, at least 52.0% by weight, at least 54.0% by weight, at least 56.0% by weight, at least 58.0% by weight, and at least 60.0% by weight. In any of embodiments disclosed herein, the cross-linking agent may be present in the binder composition in an amount from 30% to 85% by weight, based on the total solids content of the aqueous binder composition, including without limitation 50.0% to 70.0% by weight, greater than 50% by weight to 65% by weight, 52.0% to 62.0% by weight, 54.0% to 60.0% by weight, and 55.0% to 59.0% by weight.

Optionally, in addition to, instead of the polycarboxylic acid cross-linking agent discussed above, the binder composition may include an amine-based reactant, such as ammonium salts (e.g., ammonium salts of a polycarboxylic acid), amines, diammonium sulfate, proteins, peptides, amino acids, and the like. Such amine-based reactants are capable of participating in a Maillard reaction with a reducing sugar to produce melanoidins (high molecular weight, furan ring and nitrogen-containing polymers). Thus, in some exemplary embodiments, the binder composition may comprise melanoidins produced by the reaction of an amine-based reactant and one or more reducing sugars.

The aqueous binder composition may further include at least one polyol. In any of the exemplary embodiments, the polyol may comprise a monomeric polyol. The monomeric polyol may comprise a water-soluble compound having a molecular weight of less than 2,000 Daltons, including less than 1,000 Daltons, less than 750 Daltons, less than 500 Daltons, and having at least two hydroxyl (—OH) groups. Exemplary monomeric polyols include glucose, sucrose, ethylene glycol, sugar alcohols, pentaerythritol, primary alcohols, 2,2-bis(methylol)propionic acid, tri(methylol)propane (TMP), 1,2,4-butanetriol, trimethylolpropane, fructose, high fructose corn syrup (HFCS), and short-chain alkanolamines, such as triethanolamine, comprising at least three hydroxyl groups. In any of the embodiments disclosed herein, the polyol may comprise at least 3 hydroxyl groups, at least 4 hydroxyl groups, or at least five hydroxyl groups.

Sugar alcohol is understood to mean compounds obtained when the aldo or keto groups of a sugar are reduced (e.g., by hydrogenation) to the corresponding hydroxy groups. The starting sugar might be chosen from monosaccharides, oligosaccharides, and polysaccharides, and mixtures of those products, such as syrups, molasses and starch hydrolyzates. The starting sugar also could be a dehydrated form of a sugar. Although sugar alcohols closely resemble the corresponding starting sugars, they are not sugars, and particularly not reducing sugars. Thus, for instance, sugar alcohols have no reducing ability, and cannot participate in the Maillard reaction typical of reducing sugars. In some exemplary embodiments, the sugar alcohol includes glycerol, erythritol, arabitol, xylitol, sorbitol, maltitol, mannitol, iditol, isomaltitol, lactitol, cellobitol, palatinitol, maltotritol, syrups thereof and mixtures thereof. In various exemplary embodiments, the sugar alcohol is selected from glycerol, sorbitol, xylitol, and mixtures thereof. In some exemplary embodiments, the monomeric polyol is a dimeric or oligomeric condensation product of a sugar alcohol. In various exemplary embodiments, the condensation product of a sugar alcohol is isosorbide. In some exemplary embodiments, the sugar alcohol is a diol or glycol.

In some exemplary embodiments, the monomeric polyol is present in the aqueous binder composition in an amount up to about 70% by weight total solids, including without limitation, up to about 60%, 55%, 50%, 40%, 35%, 33%, 30%, 27%, 25%, and 20% by weight total solids. In some exemplary embodiments, the monomeric polyol is present in the aqueous binder composition in an amount from 2.0% to 65.0% by weight total solids, including without limitation 5.0% to 40.0%, 8.0% to 37.0%, 10.0% to 34.0%, 12.0% to 32.0%, 15.0% to 30.0%, and 20.0% to 28.0%, by weight total solids.

In various exemplary embodiments, the cross-linking agent and monomeric polyol are present in amounts such that the ratio of the number of molar equivalents of carboxylic acid groups, anhydride groups, or salts thereof to the number of molar equivalents of hydroxyl groups is from about 0.3/1 to about 1/0.3, such as from about 0.5/1 to about 1/0.5, from about 0.6/1 to about 1/0.6, from about 0.8/1 to about 1/0.8, or from about 0.9/1 to about 1/0.9.

In any of the embodiments disclosed herein, the binder composition may be free or substantially free of polyols comprising less than 3 hydroxyl groups, or free or substantially free of polyols comprising less than 4 hydroxyl groups. In any of the embodiments disclosed herein, the binder composition is free or substantially free of polyols having a number average molecular weight of 2,000 Daltons or above, such as a molecular weight between 3,000 Daltons and 4,000 Daltons. Accordingly, in any of the embodiments disclosed herein, the binder composition is free or substantially free of diols, such as glycols; triols, such as, for example, glycerol and triethanolamine; and/or polymeric polyhydroxy compounds, such as polyvinyl alcohol, polyvinyl acetate, which may be partially or fully hydrolyzed, or mixtures thereof.

In any of the embodiments disclosed herein, the aqueous binder compositions may comprise or consist of a polymeric polycarboxylic acid-based cross-linking agent and a monomeric polyol having at least four hydroxyl groups with a ratio of carboxylic acid groups to hydroxyl groups OH groups between 0.60/1 to 1/0.6.

However, in some exemplary embodiments, the polyol may comprise a polymeric polyol having at least two hydroxyl groups and a number average molecular weight of at least 2,000 Daltons. The polymeric polyol may be included as the only polyol in the binder composition, or the polymeric polyol may be included as a secondary polyol, in addition to the monomeric polyol described above.

In some exemplary embodiments, the secondary polyol comprises one or more of a polymeric polyhydroxy compound, such as a polyvinyl alcohol, polyvinyl acetate, which may be partially or fully hydrolyzed, or mixtures thereof. Illustratively, when a partially hydrolyzed polyvinyl acetate serves as the polyol component, an 80%-89% hydrolyzed polyvinyl acetate may be utilized, such as, for example Poval® 385 (Kuraray America, Inc.) and Sevol™ 502 (Sekisui Specialty Chemicals America, LLC), which are about 85% (Poval® 385) and 88% (Selvol™ 502) hydrolyzed, respectively. Another alternative is ELVANOL 51-05, available from DuPont, having a molecular weight of about 22,000-about 26,000 Daltons and a viscosity of about 5.0-6.0 centipoise, or other partially hydrolyzed polyvinyl acetates.

The secondary polyol may be present in the aqueous binder composition in an amount up to about 30% by weight total solids, including without limitation, up to about 28%, 25%, 20%, 18%, 15%, and 13% by weight total solids. In any of the exemplary embodiments, the secondary polyol may be present in the aqueous binder composition in an amount from 2.5% to 30% by weight total solids, including without limitation 5% to 25%, 8% to 20%, 9% to 18%, and 10% to 16%, by weight total solids.

In such embodiments of the binder composition that include a secondary polyol, the crosslinking agent, monomeric polyol, and secondary polyol may be present in amounts such that the ratio of the number of molar equivalents of carboxylic acid groups, anhydride groups, or salts thereof to the number of molar equivalents of hydroxyl groups is from about 1/0.05 to about 1/5, such as from about 1/0.08 to about 1/2.0, from about 1/0.1 to about 1/1.5, and from about 1/0.3 to about 1/0.66. Within this ratio, the ratio of the secondary polyol to monomeric polyol effects the performance of the binder composition, such as the tensile strength and water solubility of the binder after cure. For instance, a ratio of secondary polyol to monomeric polyol between about 0.1/0.9 to about 0.9/0.1, such as between about 0.3/0.7 and 0.7/0.3, or between about 0.4/0.6 and 0.6/0.4 provides a balance of desirable mechanical properties and physical color properties. In various exemplary embodiments, the ratio of secondary polyol to monomeric polyol is approximately 0.5/0.5.

In any of the aqueous binder compositions disclosed herein, all or a percentage of the acid functionality in the polycarboxylic acid may be temporarily blocked with the use of a protective agent, which temporarily blocks the acid functionality from complexing with the mineral wool fibers, and is subsequently removed by heating the binder composition to a temperature of at least 150° C., freeing the acid functionalities to crosslink with the polyol component and complete the esterification process, during the curing process. In any of the exemplary embodiments, 10% to 100% of the carboxylic acid functional groups may be temporarily blocked by the protective agent, including between about 25% to about 99%, about 30% to about 90%, and about 40% to about 85%, including all subranges and combinations of ranges therebetween. In any of the exemplary embodiments, a minimum of 40% of the acid functional groups may be temporarily blocked by the protective agent.

The protective agent may be capable of reversibly bonding to the carboxylic acid groups of the crosslinking agent. In any of the exemplary embodiments, the protective agent comprises any compound comprising molecules capable of forming at least one reversible ionic bond with a single acid functional group. In any of the exemplary embodiments disclosed herein, the protective agent may comprise a nitrogen-based protective agent, such as an ammonium-based protective agent; an amine-based protective agent; or mixtures thereof. An exemplary ammonium based protective agent includes ammonium hydroxide. Exemplary amine-based protective agents include alkylamines and diamines, such as, for example ethyleneimine, ethylenediamine, hexamethylenediamine; alkanolamines, such as: ethanolamine, diethanolamine, triethanolamine; ethylenediamine-N,N′-disuccinic acid (EDDS), ethylenediaminetetraacetic acid (EDTA), and the like, or mixtures thereof. In addition, the alkanolamine can be used as both a protecting agent and as a participant in the crosslinking reaction to form ester in the cured binder. Thus, the alkanolamine has a dual-functionality of protective agent and polyol for crosslinking with the polycarboxylic acid via esterification.

The protective agent functions differently than a conventional pH adjuster. A protective agent, as defined herein, only temporarily and reversibly blocks the acid functional groups in the polymeric polycarboxylic acid component. In contrast, conventional pH adjusters, such as sodium hydroxide, permanently terminate an acid functional group, which prevents crosslinking between the acid and hydroxyl groups due to the blocked acid functional groups. Thus, the inclusion of traditional pH adjusters, such as sodium hydroxide, does not provide the desired effect of temporarily blocking the acid functional groups, while later freeing up those functional groups during to cure to permit crosslinking via esterification. Accordingly, in any of the exemplary embodiments disclosed herein, the binder composition may be free or substantially free of conventional pH adjusters, such as, for example, sodium hydroxide and potassium hydroxide. Such conventional pH adjusters for high temperature applications will permanently bond with the carboxylic acid groups and will not release the carboxylic acid functionality to allow for crosslinking esterification.

Any of the binder compositions disclosed herein may further include an additive blend comprising one or more processing additives that improves the processability of the binder composition by reducing the viscosity and tackiness of the binder, resulting in a more uniform insulation product with an increased tensile strength and hydrophobicity. Although there may be various additives capable of reducing the viscosity and/or tackiness of a binder composition, conventional additives are hydrophilic in nature, such that the inclusion of such additives increases the overall water absorption of the binder composition. The additive blend may comprise one or more processing additives. Examples of processing additives include surfactants, glycerol, 1,2,4-butanetriol, 1,4-butanediol, 1,2-propanediol, 1,3-propanediol, poly(ethylene glycol) (e.g., Carbowax™), monooleate polyethylene glycol (MOPEG), silicone, dispersions of polydimethylsiloxane (PDMS), emulsions and/or dispersions of mineral, paraffin, or vegetable oils, waxes such as amide waxes (e.g., ethylene bis-stearamide (EBS)) and carnauba wax (e.g., ML-155), hydrophobized silica, ammonium phosphates, or combinations thereof. The surfactants may include non-ionic surfactants, including non-ionic surfactants with an alcohol functional groups. Exemplary surfactants include Surfynol®, alkyl polyglucosides (e.g., Glucopon®), and alcohol ethoxylates (e.g., Lutensol®).

The additive blend may include a single processing additive, a mixture of at least two processing additives, a mixture of at least three processing additives, or a mixture of at least four processing additives. In any of the embodiments disclosed herein, the additive blend may comprise a mixture of glycerol and polydimethylsiloxane.

The additive blend may be present in the binder composition in an amount from 1.0% to 20% by weight, from 1.25% to 17.0% by weight, or from 1.5% to 15.0% by weight, or from about 3.0% to about 12.0% by weight, or from about 5.0% to about 10.0% by weight based on the total solids content in the binder composition. In any of the exemplary embodiments, the binder composition may comprise at least 7.0% by weight of the additive blend, including at least 8.0% by weight, and at least 9% by weight, based on the total solids content in the binder composition. Accordingly, in any of the exemplary embodiments, the aqueous binder composition may comprise 7.0% to 15% by weight of the additive blend, including 8.0% by weight to 13.5% by weight, 9.0% by weight to 12.5% by weight, based on the total solids content in the binder composition.

In embodiments wherein the additive blend comprises glycerol, the glycerol may be present in an amount from at least 5.0% by weight, or at least 6.0% by weight, or at least 7.0% by weight, or at least 7.5% by weight, based on the total solids content of the binder composition. In any of the exemplary embodiments, the binder composition may comprise 5.0% to 15% by weight of glycerol, including 6.5% to 13.0% by weight, 7.0% to 12.0% by weight, and 7.5% to 11.0% by weight of glycerol, based on the total solids content of the binder composition.

In embodiments wherein the additive blend comprises polydimethylsiloxane, the polydimethylsiloxane may be present in an amount from at least 0.2% by weight, or at least 0.5% by weight, or at least 0.8% by weight, or at least 1.0% by weight, or at least 1.5% by weight, or at least 2.0% by weight, based on the total solids content of the binder composition. In any of the exemplary embodiments, the binder composition may comprise 0.5% to 5.0% by weight of polydimethylsiloxane, including 1.0% to 4.0% by weight, 1.2% to 3.5% by weight, 1.5% to 3.0% by weight, and 1.6% to 2.3% by weight of polydimethylsiloxane, based on the total solids content of the binder composition.

In any of the embodiments disclosed herein, the additive blend may comprise a mixture of glycerol and polydimethylsiloxane, wherein the glycerol comprises 5.0% to 15% by weight of the binder composition and the polydimethylsiloxane comprises 0.5% to 5.0% by weight of the binder composition, based on the total solids content of the binder composition. In any of the embodiments disclosed herein, the additive blend may comprise a mixture of glycerol and polydimethylsiloxane, wherein the glycerol comprises 7.0% to 12% by weight of the binder composition and the polydimethylsiloxane comprises 1.2% to 3.5% by weight of the binder composition, based on the total solids content of the binder composition.

In any of the embodiments disclosed herein, the additive blend may comprise an increased concentration of a silane coupling agent. Conventional binder compositions generally comprise less than 0.5% by weight silane and more commonly about 0.2% by weight or less, based on the total solids content of the binder composition. Accordingly, in any of the embodiments disclosed herein, the silane coupling agent(s) may be present in the binder composition in an amount from about 0.5% to about 5.0% by weight of the total solids in the binder composition, including from about 0.7% to about 2.5% by weight, from about 0.85% to about 2.0% by weight, or from about 0.95% to about 1.5% by weight. In any of the embodiments disclosed herein, the silane coupling agent(s) may be present in the binder composition in an amount up to about 1.0% by weight.

The silane concentration may further be characterized by the amount of silane on the fibers in a fibrous insulation product. Typically, fiberglass insulation products comprise between 0.001% by weight and 0.03% by weight of the silane coupling agent on the glass fibers. However, by increasing the amount of silane coupling agent that is included applied to the fibers, the amount of silane on the glass fibers increases to at least 0.10% by weight.

Alternatively, the binder composition may comprise a conventional amount of silane coupling agent, if any. In such embodiments, the silane coupling agent(s) may be present in the binder composition in an amount from 0% to less than 0.5% by weight of the total solids in the binder composition, including from about 0.05% to about 0.4% by weight, from about 0.1% to about 0.35% by weight, or from about 0.15% to about 0.3% by weight.

Non-limiting examples of silane coupling agents that may be used in the binder composition may be characterized by the functional groups alkyl, aryl, amino, epoxy, vinyl, methacryloxy, ureido, isocyanato, and mercapto. In exemplary embodiments, the silane coupling agent(s) include silanes containing one or more nitrogen atoms that have one or more functional groups such as amine (primary, secondary, tertiary, and quaternary), amino, imino, amido, imido, ureido, or isocyanato. Specific, non-limiting examples of suitable silane coupling agents include, but are not limited to, aminosilanes (e.g., triethoxyaminopropylsilane; 3-aminopropyl-triethoxysilane and 3-aminopropyl-trihydroxysilane), epoxy trialkoxysilanes (e.g., 3-glycidoxypropyltrimethoxysilane and 3-glycidoxypropyltriethoxysilane), methyacryl trialkoxysilanes (e.g., 3-methacryloxypropyltrimethoxysilane and 3-methacryloxypropyltriethoxysilane), hydrocarbon trialkoxysilanes, amino trihydroxysilanes, epoxy trihydroxysilanes, methacryl trihydroxy silanes, and/or hydrocarbon trihydroxysilanes. In one or more exemplary embodiment, the silane is an aminosilane, such as γ-aminopropyltriethoxysilane.

Any of the aqueous binder compositions disclosed herein may further include an esterification catalyst, also known as a cure accelerator. The catalyst may include inorganic salts, Lewis acids (i.e., aluminum chloride or boron trifluoride), Bronsted acids (i.e., sulfuric acid, p-toluenesulfonic acid and boric acid) organometallic complexes (i.e., lithium carboxylates, sodium carboxylates), and/or Lewis bases (i.e., polyethyleneimine, diethylamine, or triethylamine). Additionally, the catalyst may include an alkali metal salt of a phosphorous-containing organic acid; in particular, alkali metal salts of phosphorus acid, hypophosphorus acid, or polyphosphoric. Examples of such phosphorus catalysts include, but are not limited to, sodium hypophosphite, sodium phosphate, potassium phosphate, disodium pyrophosphate, tetrasodium pyrophosphate, sodium tripolyphosphate, sodium hexametaphosphate, potassium phosphate, potassium tripolyphosphate, sodium trimetaphosphate, sodium tetrametaphosphate, and mixtures thereof. In addition, the catalyst or cure accelerator may be a fluoroborate compound such as fluoroboric acid, sodium tetrafluoroborate, potassium tetrafluoroborate, calcium tetrafluoroborate, magnesium tetrafluoroborate, zinc tetrafluoroborate, ammonium tetrafluoroborate, and mixtures thereof. Further, the catalyst may be a mixture of phosphorus and fluoroborate compounds. Other sodium salts such as, sodium sulfate, sodium nitrate, sodium carbonate may also (or alternatively) be used as the catalyst.

The catalyst may be present in the aqueous binder composition in an amount from about 0% to about 10% by weight of the total solids in the binder composition, including without limitation, amounts from about 1% to about 5% by weight, or from about 2% to about 4.5% by weight, or from about 2.8% to about 4.0% by weight, or from about 3.0% to about 3.8% by weight.

Optionally, the aqueous binder composition may contain at least one coupling agent. In at least one exemplary embodiment, the coupling agent is a silane coupling agent. The coupling agent(s) may be present in the binder composition in an amount from about 0.01% to about 5% by weight of the total solids in the binder composition, from about 0.01% to about 2.5% by weight, from about 0.05% to about 1.5% by weight, or from about 0.1% to about 1.0% by weight.

Non-limiting examples of silane coupling agents that may be used in the binder composition may be characterized by the functional groups alkyl, aryl, amino, epoxy, vinyl, methacryloxy, ureido, isocyanato, and mercapto. In any of the embodiments, the silane coupling agent(s) may include silanes containing one or more nitrogen atoms that have one or more functional groups such as amine (primary, secondary, tertiary, and quaternary), amino, imino, amido, imido, ureido, or isocyanato. Specific, non-limiting examples of suitable silane coupling agents include, but are not limited to, aminosilanes (e.g., triethoxyaminopropylsilane; 3-aminopropyl-triethoxysilane and 3-aminopropyl-trihydroxysilane), epoxy trialkoxysilanes (e.g., 3-glycidoxypropyltrimethoxysilane and 3-glycidoxypropyltriethoxysilane), methyacryl trialkoxysilanes (e.g., 3-methacryloxypropyltrimethoxysilane and 3-methacryloxypropyltriethoxysilane), hydrocarbon trialkoxysilanes, amino trihydroxysilanes, epoxy trihydroxysilanes, methacryl trihydroxy silanes, and/or hydrocarbon trihydroxysilanes. In any of the embodiments disclosed herein, the silane may comprise an aminosilane, such as γ-aminopropyltriethoxysilane.

The aqueous binder composition may further include a process aid. The process aid is not particularly limiting so long as the process aid functions to facilitate the formation and/or orientation of the fibers. The process aid can be used to improve binder application distribution uniformity, to reduce binder viscosity, to increase ramp height after forming, to improve the vertical weight distribution uniformity, and/or to accelerate binder de-watering in both forming and oven curing processes. The process aid may be present in the binder composition in an amount from 0% to about 10.0% by weight, from about 0.1% to about 5.0% by weight, or from about 0.3% to about 2.0% by weight, or from about 0.5% to about 1.0% by weight, based on the total solids content in the binder composition. In some exemplary embodiments, the aqueous binder composition is substantially or completely free of any process aids.

Examples of process aids include defoaming agents, such as, emulsions and/or dispersions of mineral, paraffin, or vegetable oils; dispersions of polydimethylsiloxane (PDMS) fluids, and silica which has been hydrophobized with polydimethylsiloxane or other materials. Further process aids may include particles made of amide waxes such as ethylene bis-stearamide (EBS) or hydrophobized silica. A further process aid that may be utilized in the binder composition is a surfactant. One or more surfactants may be included in the binder composition to assist in binder atomization, wetting, and interfacial adhesion.

The surfactant is not particularly limited, and includes surfactants such as, but not limited to, ionic surfactants (e.g., sulfate, sulfonate, phosphate, and carboxylate); sulfates (e.g., alkyl sulfates, ammonium lauryl sulfate, sodium lauryl sulfate (SDS), alkyl ether sulfates, sodium laureth sulfate, and sodium myreth sulfate); amphoteric surfactants (e.g., alkylbetaines such as lauryl-betaine); sulfonates (e.g., dioctyl sodium sulfosuccinate, perfluorooctanesulfonate, perfluorobutanesulfonate, and alkyl benzene sulfonates); phosphates (e.g., alkyl aryl ether phosphate and alkyl ether phosphate); carboxylates (e.g., alkyl carboxylates, fatty acid salts (soaps), sodium stearate, sodium lauroyl sarcosinate, carboxylate fluorosurfactants, perfluoronanoate, and perfluorooctanoate); cationic (e.g., alkylamine salts such as laurylamine acetate); pH dependent surfactants (primary, secondary or tertiary amines); permanently charged quaternary ammonium cations (e.g., alkyltrimethylammonium salts, cetyl trimethylammonium bromide, cetyl trimethylammonium chloride, cetylpyridinium chloride, and benzethonium chloride); and zwitterionic surfactants, quaternary ammonium salts (e.g., lauryl trimethyl ammonium chloride and alkyl benzyl dimethylammonium chloride), and polyoxyethylenealkylamines.

Suitable nonionic surfactants that can be used in conjunction with the binder composition include polyethers (e.g., ethylene oxide and propylene oxide condensates, which include straight and branched chain alkyl and alkaryl polyethylene glycol and polypropylene glycol ethers and thioethers); alkylphenoxypoly(ethyleneoxy)ethanols having alkyl groups containing from about 7 to about 18 carbon atoms and having from about 4 to about 240 ethyleneoxy units (e.g., heptylphenoxypoly(ethyleneoxy) ethanols, and nonylphenoxypoly(ethyleneoxy) ethanols); polyoxyalkylene derivatives of hexitol including sorbitans, sorbides, mannitans, and mannides; partial long-chain fatty acids esters (e.g., polyoxyalkylene derivatives of sorbitan monolaurate, sorbitan monopalmitate, sorbitan monostearate, sorbitan tristearate, sorbitan monooleate, and sorbitan trioleate); condensates of ethylene oxide with a hydrophobic base, the base being formed by condensing propylene oxide with propylene glycol; sulfur containing condensates (e.g., those condensates prepared by condensing ethylene oxide with higher alkyl mercaptans, such as nonyl, dodecyl, or tetradecyl mercaptan, or with alkylthiophenols where the alkyl group contains from about 6 to about 15 carbon atoms); ethylene oxide derivatives of long-chain carboxylic acids (e.g., lauric, myristic, palmitic, and oleic acids, such as tall oil fatty acids); ethylene oxide derivatives of long-chain alcohols (e.g., octyl, decyl, lauryl, or cetyl alcohols); and ethylene oxide/propylene oxide copolymers.

In at least one exemplary embodiment, the surfactants include one or more of Dynol 607, which is a 2,5,8,11-tetramethyl-6-dodecyne-5,8-diol, SURFONYL® 420, SURFONYL® 440, and SURFONYL® 465, which are ethoxylated 2,4,7,9-tetramethyl-5-decyn-4,7-diol surfactants (commercially available from Evonik Corporation (Allentown, Pa.)), Stanfax (a sodium lauryl sulfate), Surfynol 465 (an ethoxylated 2,4,7,9-tetramethyl 5 decyn-4,7-diol), Triton™ GR-PG70 (1,4-bis(2-ethylhexyl) sodium sulfosuccinate), and Triton™ CF-10 (poly(oxy-1,2-ethanediyl), alpha-(phenylmethyl)-omega-(1,1,3,3-tetramethylbutyl)phenoxy).

Optionally, the aqueous binder composition may contain a dust suppressing agent to reduce or eliminate the presence of inorganic and/or organic particles which may have adverse impact in the subsequent fabrication and installation of the insulation materials. The dust suppressing agent can be any conventional mineral oil, mineral oil emulsion, natural or synthetic oil, bio-based oil, or lubricant, such as, but not limited to, silicone and silicone emulsions, polyethylene glycol, as well as any petroleum or non-petroleum oil with a high flash point to minimize the evaporation of the oil inside the oven.

The aqueous binder composition may include up to about 15% by weight of a dust suppressing agent, including up to about 14% by weight, or up to about 13% by weight. In any of the embodiments disclosed herein, the aqueous binder composition may include between 1.0% by weight and 15% by weight of a dust suppressing agent, including about 3.0% by weight to about 13.0% by weight, or about 5.0% by weight to about 12.8% by weight.

The aqueous binder composition may also optionally include organic and/or inorganic acids and bases as pH adjusters in an amount sufficient to adjust the pH to a desired level. The pH may be adjusted depending on the intended application, to facilitate the compatibility of the ingredients of the binder composition, or to function with various types of fibers. In some exemplary embodiments, the pH adjuster is utilized to adjust the pH of the binder composition to an acidic pH. Examples of suitable acidic pH adjusters include inorganic acids such as, but not limited to sulfuric acid, phosphoric acid and boric acid and also organic acids like p-toluenesulfonic acid, mono- or polycarboxylic acids, such as, but not limited to, citric acid, acetic acid and anhydrides thereof, adipic acid, oxalic acid, and their corresponding salts. Also, inorganic salts that can be acid precursors. The acid adjusts the pH, and in some instances, as discussed above, acts as a cross-linking agent. Organic and/or inorganic bases can be included to increase the pH of the binder composition. The bases may be volatile or non-volatile bases. Exemplary volatile bases include, for example, ammonia and alkyl-substituted amines, such as methyl amine, ethyl amine or 1-aminopropane, dimethyl amine, and ethyl methyl amine. Exemplary non-volatile bases include, for example, sodium hydroxide, potassium hydroxide, sodium carbonate, and t-butylammonium hydroxide.

In any of the exemplary embodiments, when in an un-cured state, the binder composition may have an acidic pH, such as a pH in the range of from about 2.0 to about 5.0, including all amounts and ranges in between. In any of the embodiments disclosed herein, the pH of the binder composition, when in an un-cured state, is about 2.2 to about 4.0, including about 2.5 to about 3.8, and about 2.6 to about 3.5. After cure, the pH of the binder composition may rise to at least a pH of about 5.0, including levels between about 6.5 and about 8.8, or between about 6.8 and about 8.2.

Alternatively, the binder composition, when in an un-cured state, may be adjusted to a more alkaline pH, such as, for example, a pH between about 5 and about 10, or a pH between about 6 and about 9, or between about 7 and about 8.

The binder further includes water to dissolve or disperse the active solids for application onto the reinforcement fibers. Water may be added in an amount sufficient to dilute the aqueous binder composition to a viscosity that is suitable for its application to the reinforcement fibers and to achieve a desired solids content on the fibers. It has been discovered that the present binder composition may contain a lower solids content than traditional phenol-urea formaldehyde or carbohydrate-based binder compositions. In particular, the binder composition may comprise 5% to 35% by weight of binder solids, including without limitation, 10% to 30%, 12% to 20%, and 15% to 19% by weight of binder solids. This level of solids indicates that the subject binder composition may include more water than traditional binder compositions.

Table 1 below provides exemplary binder compositions comprising the materials discussed above. The exemplary compositions listed in Table 1 may include optional additives or materials, as set forth above.

TABLE 1

| | Exemplary | Exemplary | Exemplary | Exemplary |
|---|---|---|---|---|
| | Composition | Composition | Composition | Composition |
| | 1 (% By | 2 (% By | 3 (% By | 4 (% By |
| | Weight of | Weight of | Weight of | Weight of |
| Component | Total Solids) | Total Solids) | Total Solids) | Total Solids) |
| Poly- | 30-85 | 55-65 | 60-80 | At least 50 |
| carboxylic | | | | |
| acid | | | | |
| Polyvinyl | — | — | 2.5-30 | — |
| alcohol | | | | |
| Monomeric | 15-70 | 20-35 | 8-30 | 10-35 |
| Polyol | | | | |
| Additive | Optional | Optional | — | 1.5-15 |
| blend | | | | |
| Catalyst | 0.5-5.0 | 2.0-3.5 | 2-10 | 0.5-5 |
| Coupling | 0-2.0 | 0.12-0.5 | 0.1-3 | 0-3 |
| agent | | | | |
| Uncured pH | 2-5 | 2.2-4.0 | 2-5 | 4-7 |

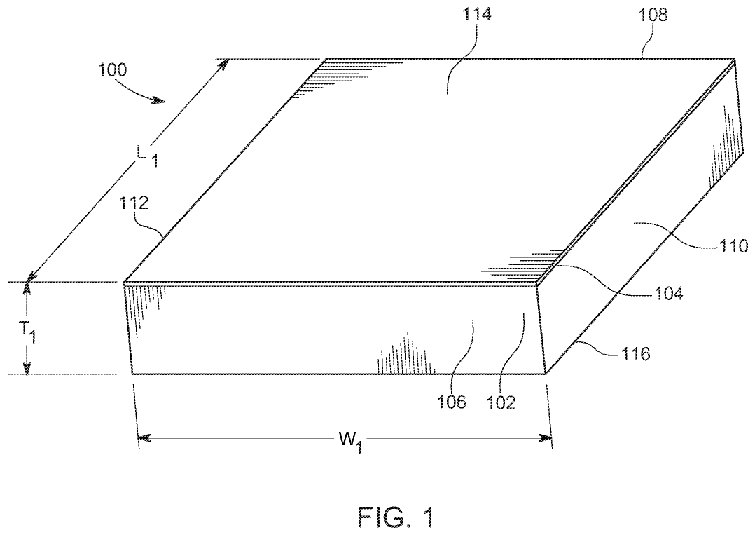

An exemplary fibrous insulation product 100 is illustrated in FIG. 1. The fibrous insulation product 100 may be configured in a variety of ways. In the illustrated embodiment of FIG. 1, the fibrous insulation product 100 is a generally box-shaped fiberglass insulation batt; however, the insulation product can be any suitable shape or size, such as for example, a rolled product or a blanket. As an insulation batt or blanket, the fibrous insulation product 100 may be placed in the insulation cavities of buildings. For example, the fibrous insulation product 100 may be placed in the space or cavity between two parallel, spaced apart framing members in a wall, roof, or floor frame of a building.

The fibrous insulation product 100 includes an insulation layer 102 comprising nonwoven glass fibers and a binder composition to adhere the glass fibers together. Optionally, the fibrous insulation product 100 may also include a facing 104 attached or otherwise adhered to the insulation layer 102. The fibrous insulation product 100 includes a first side surface 106, a second side surface 108 spaced apart from and opposite the first side surface 106, a third side surface 110 extending between the first side surface 106 and the second side surface 108, and a fourth side surface 112 spaced apart from and opposite the third side surface 110 and extending between the first side surface 106 and the second side surface 108. The fibrous insulation product 100 also includes a first face 114 connecting the side surfaces 106, 108, 110, 112 and a second face 116 parallel to, or generally parallel to, and opposite the first face 114 and connecting the side surfaces 106, 108, 110, 112. The fibrous insulation product 100, when uncompressed, has a length L1, a width W1, and a thickness T1. In some embodiments, the length L1 is greater than the width W1 which is greater than the thickness T1.

A facing 104 may be disposed on the insulation layer 102 to cover the entirety of, or a portion of, the first face 114, the second face 116, or both faces of the fibrous insulation product 100. The facing 104 may take a wide variety of different forms. The facing 104 can be a single piece or multiple different pieces or sheets of material and may include a single layer or several layers of material. In the exemplary embodiment of FIG. 1, the facing 104 is a single piece of material that covers all of the first face 114 of the fibrous insulation product 100.

The facing 104 may be made from a variety of different materials. Any material suitable for use with a fibrous insulation product may be used. For example, the facing 104 may comprise nonwoven fiberglass and polymeric media; woven fiberglass and polymeric media; sheathing materials, such as sheathing films made from polymeric materials; scrim; cloth; fabric; fiberglass reinforced kraft paper (FRK); a foil-scrim-kraft paper laminate; recycled paper; and calendared paper.

A significant amount of the insulation placed in the insulation cavities of buildings is in the form of insulation blankets rolled from insulation products such as those described herein. Faced insulation products are installed with the facing 104 placed flat on the edge of the insulation cavity, typically on the interior side of the insulation cavity. Insulation products where the facing is a vapor retarder are commonly used to insulate wall, floor, or ceiling cavities that separate a warm interior space from a cold exterior space. The vapor retarder is placed on one side of the insulation product to retard or prohibit the movement of water vapor through the insulation product.

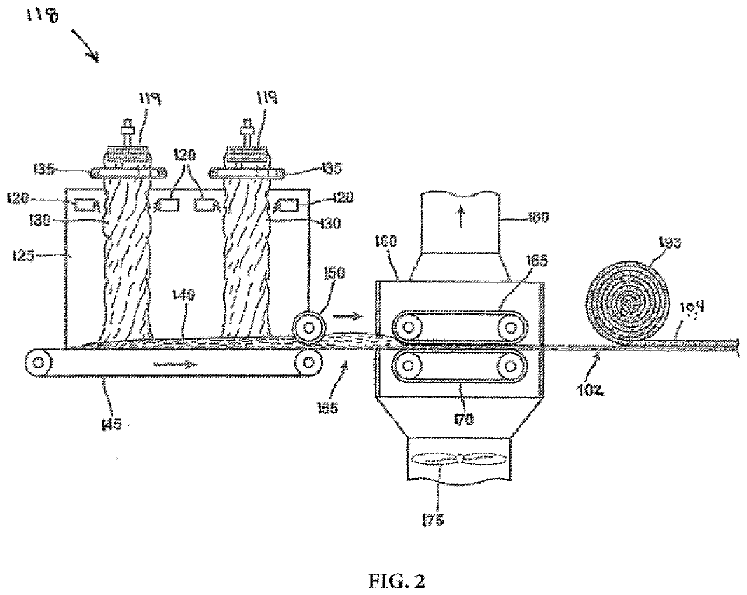

FIG. 2 illustrates an exemplary embodiment of an apparatus 118 for manufacturing the fibrous insulation product 100. The manufacture of the fibrous insulation product 100 may be carried out in a continuous process by fiberizing molten glass, coating the molten glass fibers with a binder, forming a fibrous glass pack on a porous moving conveyor (also known as a “forming chain”), and curing the binder composition to form an insulation blanket as depicted in FIG. 2. Glass may be melted in a tank (not shown) and supplied to a fiber forming device, such as one or more fiberizing spinners 119. Although spinners 119 are shown as the fiber forming device in the exemplary embodiment, it will be understood that other types of fiber forming units may be used to form the fibrous insulation product 100. The spinners 119 are rotated at high speeds. Centrifugal force causes the molten glass to pass through small orifices in the circumferential sidewalls of the fiberizing spinners 119 to form glass fibers. Glass fibers 130 of random lengths may be attenuated from the fiberizing spinners 119 and blown generally downwardly (i.e., generally perpendicular to the plane of the spinners 119) by blowers 120 positioned within a forming chamber 125.

The blowers 120 turn the glass fibers 130 downward. The glass fibers 130, prior to entering and while in transit downward in the forming chamber 125 and while still hot from the drawing operation, are sprayed with an aqueous binder composition by an annular spray ring 135 so as to result in a relatively even distribution of the binder composition throughout the glass fibers 130. Water may also be applied to the glass fibers 130 in the forming chamber 125, such as by spraying, prior to the application of the binder composition to at least partially cool the glass fibers 130.

The glass fibers 130 having the uncured aqueous binder composition adhered thereto may be gathered and formed into a fibrous pack 140 on an endless forming conveyor 145 within the forming chamber 125 with the aid of a vacuum (not shown) drawn through the fibrous pack 140 from below the forming conveyor 145. The residual heat from the glass fibers 130 and the flow of air through the fibrous pack 140 during the forming operation are generally sufficient to volatilize a majority of the water from the binder composition before the glass fibers 130 exit the forming chamber 125, thereby leaving the remaining components of the binder composition on the glass fibers 130 as a viscous or semi-viscous high-solids liquid.

The resin-coated fibrous pack 140, which is in a compressed state due to the flow of air through the fibrous pack 140 in the forming chamber 125, is then transferred out of the forming chamber 125 under exit roller 150 to a transfer zone 155 where the fibrous pack 140 vertically expands due to the resiliency of the glass fibers 130. The expanded fibrous pack 140 is then heated, such as by conveying the fibrous pack 140 through a curing oven 160 where heated air is blown through the fibrous pack 140 to evaporate any remaining water in the binder composition, cure the binder composition, and rigidly bond the glass fibers 130 together. The curing oven 160 includes a foraminous upper oven conveyor 165 and a foraminous lower oven conveyor 170, between which the fibrous pack 140 is drawn. Heated air is forced through the lower oven conveyor 170, the fibrous pack 140, and the upper oven conveyor 165 by a fan 175. The heated air exits the curing oven 160 through an exhaust apparatus 180.

Also, in the curing oven 160, the fibrous pack 140 may be compressed by the upper and lower foraminous oven conveyors 165, 170 to form the insulation layer 102 of the fibrous insulation product 100. The distance between the upper and lower oven conveyors 165, 170 may be used to compress the fibrous pack 140 to give the insulation layer 102 its predetermined thickness T1. It is to be appreciated that although FIG. 2 depicts the conveyors 165, 170 as being in a substantially parallel orientation, they may alternatively be positioned at an angle relative to each other (not illustrated).

The cured binder composition imparts strength and resiliency to the insulation layer 102. It is to be appreciated that the drying and curing of the binder composition may be carried out in either one or two different steps. The two stage (two-step) process is commonly known as B-staging. The curing oven 160 may be operated at a temperature from 100° C. to 325° C., or from 250° C. to 300° C. The fibrous pack 140 may remain within the curing oven 160 for a period of time sufficient to crosslink (cure) the binder composition and form the insulation layer 102.

Once the insulation layer 102 exits the curing oven 160, a facing material 193 may be placed on the insulation layer 102 to form the facing layer 104. The facing material 193 may be adhered to the first face 114, to the second face 116, or both faces of the insulation layer 102 by a bonding agent (not shown) or some other means (e.g., stitching, mechanical entanglement) to form the fibrous insulation product 100. Suitable bonding agents include adhesives, polymeric resins, asphalt, and bituminous materials that can be coated or otherwise applied to the facing material 193. The fibrous insulation product 100 may subsequently be rolled for storage and/or shipment or cut into predetermined lengths by a cutting device (not illustrated). It is to be appreciated that, in some exemplary embodiments, the insulation layer 102 that emerges from the curing oven 160 is rolled onto a take-up roll or cut into sections having a desired length and is not faced with a facing material 193.

It has been surprisingly discovered that fibrous insulation products with desirable thermal and material efficiency can be manufactured utilizing fine glass fibers with diameters of 3.81 μm (15 HT) or less, at a lower than expected product weight and thickness. Insulation products formed with fibers of an average diameter of 3.81 μm (15 HT) or less may hereinafter be referred to interchangeably as “fine fiber” insulation products or “inventive” fibrous insulation products.

Not wishing to be bound by theory, it is believed that a unique combination of thin, sub-3.81 μm (15 HT) diameter fibers, a low viscosity formaldehyde-free binder composition, and certain processing parameters facilitates the orientation of more fibers (or fiber segments) along a plane that is generally parallel to the forming chain (referred to herein at the L1 direction or machine direction) within a certain degree. Therefore, the inventive fibrous insulation product produced therefrom has a fiber orientation more aligned along the L1 direction than is seen in otherwise comparable insulation products formed with fibers having an average fiber diameter above 3.81 μm (15 HT). Thus, when the inventive fibrous insulation product is installed into a wall cavity, ceiling, floor, or similar building structure, the oriented fibers are aligned in a plane more perpendicular to the direction of heat flow, thereby reducing the product's ability to conduct heat through the thickness of the material.

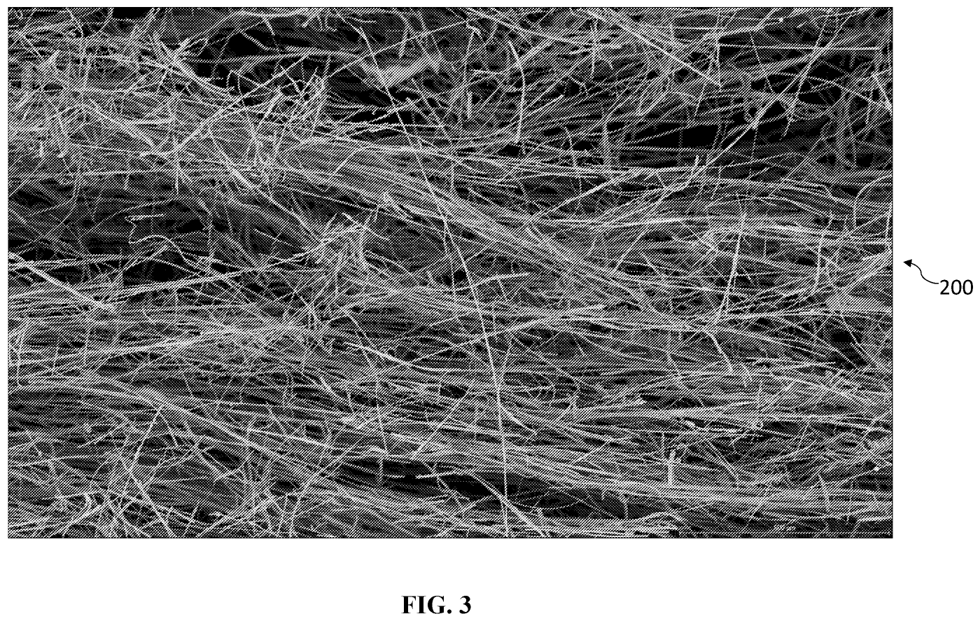

FIG. 3 is an SEM image illustrating the above-described orientation of fibers (or fiber sections) along a plane that is generally more parallel to the plane in the L1 direction. The SEM image was acquired from a fine fiber insulation product 200 having an R-value of 22, comprising glass fibers with an average fiber diameter of 3.68 μm (14.5 HT) and a formaldehyde-free binder composition comprising a monomeric polyol and a polycarboxylic acid cross-linking agent. The SEM image in FIG. 3 illustrates a 2.5 mm×1.5 mm product sample and measures localized fiber vectors (fiber sections in a particular plane).

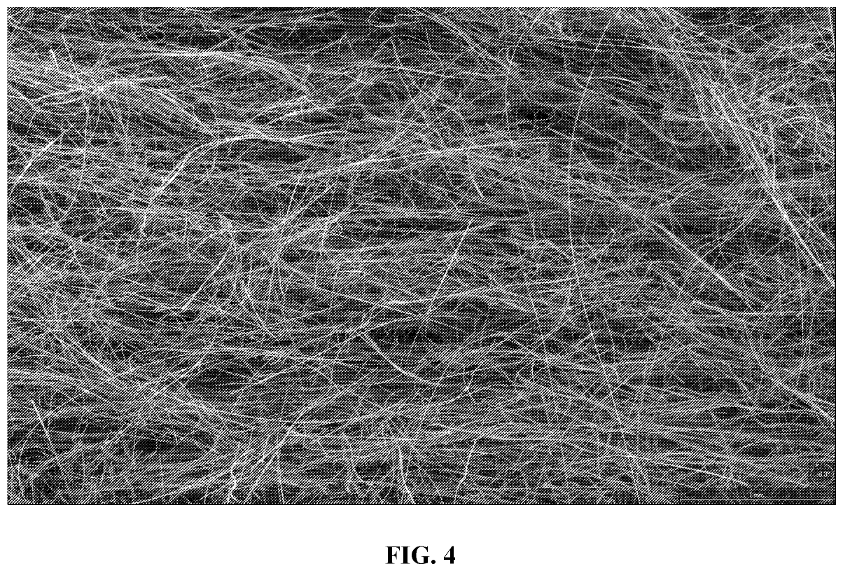

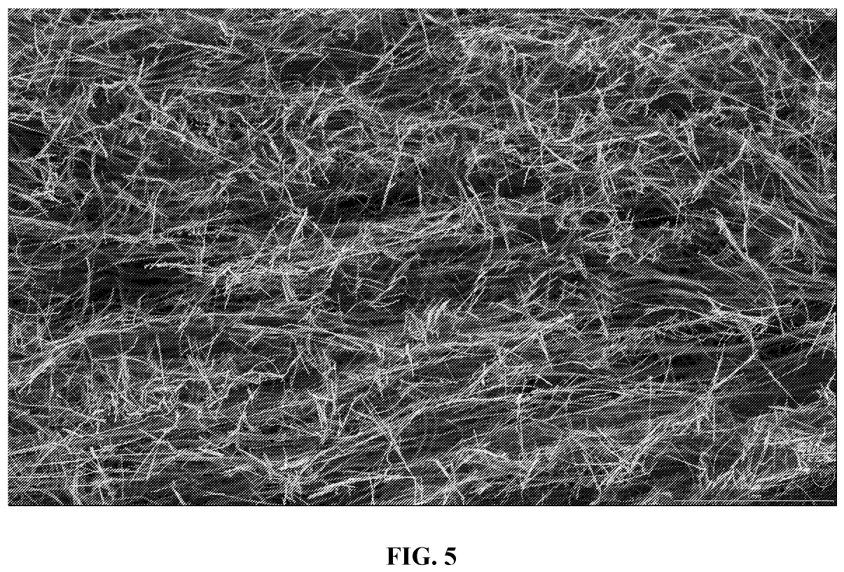

FIGS. 4 and 5 are SEM images that further illustrate fibrous insulation product samples, with the product sample in FIG. 4 comprising glass fibers with an average fiber diameter of 3.68 μm (14.5 HT) and an R-value of 22 (hereinafter referred to as Sample A); and the product sample in FIG. 5 comprising glass fibers with an average fiber diameter of 4.24 μm (16.7 HT), the product sample having an insulation value of R21 (hereinafter referred to as Sample B). The SEM images of Samples A and B were acquired using Thermo Scientific Prisma SEM and the images were stitched using the Thermo Scientific MAPS software. The samples were cut in machine direction cross sections, mounted on SEM stubs using carbon glue and carbon paste, and sputter coated with Au. The fiber orientation measurements and quantifications were accessed using the Orientation J plug-in from the Image J software. Gaussian window sigma was set to 1 pix and Gaussian Gradient was selected for Structure Tensor.

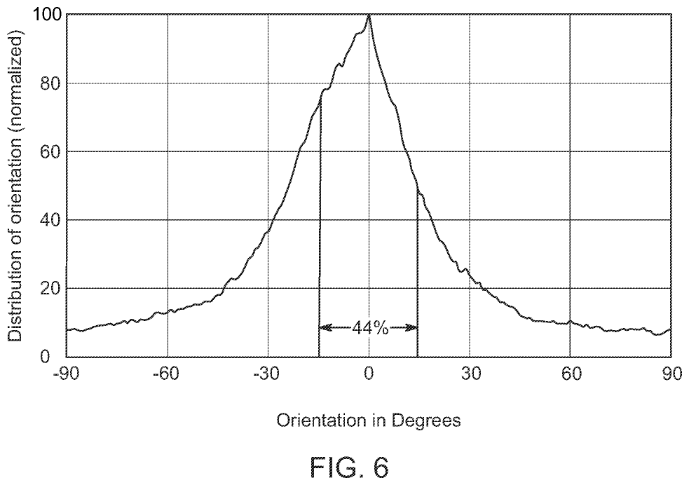

The surface area (5.24 mm×3.14 mm) for each of Samples A and B in the machine direction was imaged and analyzed for orientation distribution. To analyze orientation distribution, localized glass fibers (or fiber vectors or sections thereof) were measured. The orientation frequency (normalized) versus orientation (degrees) was plotted and provided for each sample. FIGS. 6-8 illustrate the weight percent of the fibers (or fiber vectors or sections thereof) in Sample A within ranges of +/−50°, +/−30°, and +/−15° from a common plane (0°), horizontal to the product length L1.

It was surprisingly discovered that an increased proportion of glass fibers (or fiber vectors or sections thereof) were oriented along a common plane, compared to insulation products having the same R-value, but with glass fibers with an average diameter of greater than 3.81 μm (15 HT). Particularly, in any of the exemplary embodiments, at least 30% by weight of the fibers (or fiber vectors or sections thereof) in the fine fiber insulation product may be oriented within +/−15° of a common plane. FIG. 6 illustrates a graph outlining the exemplary fiber orientation distribution within +/−15° of a common plane in an inventive fibrous insulation product comprising glass fibers with an average fiber diameter of 3.68 μm (14.5 HT). In such embodiments, the fine fiber insulation product may comprise or consist of fibers whereby at least 35% by weight, at least 40% by weight, and at least 44% by weight, of the fibers (or fiber vectors or sections thereof) are oriented within +/−15° of a common plane. In any of the exemplary embodiments, the common plane may be a plane parallel to the insulation product's length and width.

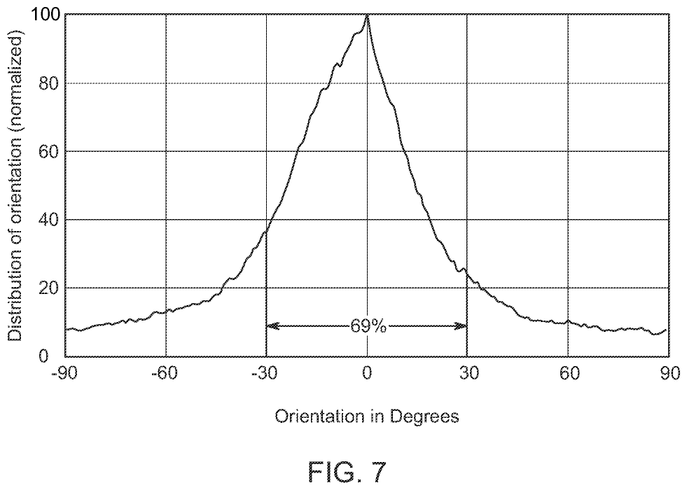

It was further discovered that in any of the exemplary embodiments, at least 50% by weight, or at least 55% by weight of the glass fibers (or fiber vectors or sections thereof) in the fibrous insulation products may be oriented within +/−30° of a common plane. FIG. 7 illustrates a graph outlining the exemplary fiber orientation distribution within +/−30° of a common plane within an inventive fibrous insulation product comprising glass fibers with an average fiber diameter of 3.68 μm (14.5 HT). In such embodiments, the fibrous insulation product may comprise or consist of fibers whereby at least 57% by weight, at least 60% by weight, at least 65% by weight, and at least 69% by weight of the fibers (or fiber vectors or sections thereof) are oriented within +/−30° of a common plane. In any of the exemplary embodiments, the common plane may be a plane parallel to the insulation product's length and width.

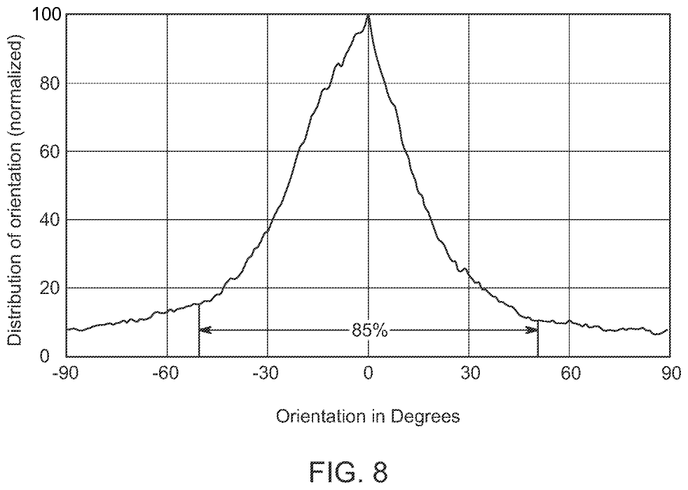

It yet further exemplary embodiments, at least 75% by weight of the fibers (or fiber vectors or sections thereof) in the fine fiber insulation product are oriented within +/−500 of a common plane. FIG. 8 illustrates a graph outlining the exemplary fiber orientation distribution within +/−50° of a common plane within an inventive fibrous insulation product comprising glass fibers with an average fiber diameter of 3.68 μm (14.5 HT). In such embodiments, the fibrous insulation product may comprise or consist of fibers whereby at least 78% by weight, at least 80% by weight, at least 82% by weight, and at least 85% by weight of the fibers (or fiber vectors or sections thereof) are oriented within +/−50° of a common plane. In any of the exemplary embodiments, the common plane may be a plane parallel to the insulation product's length and width.

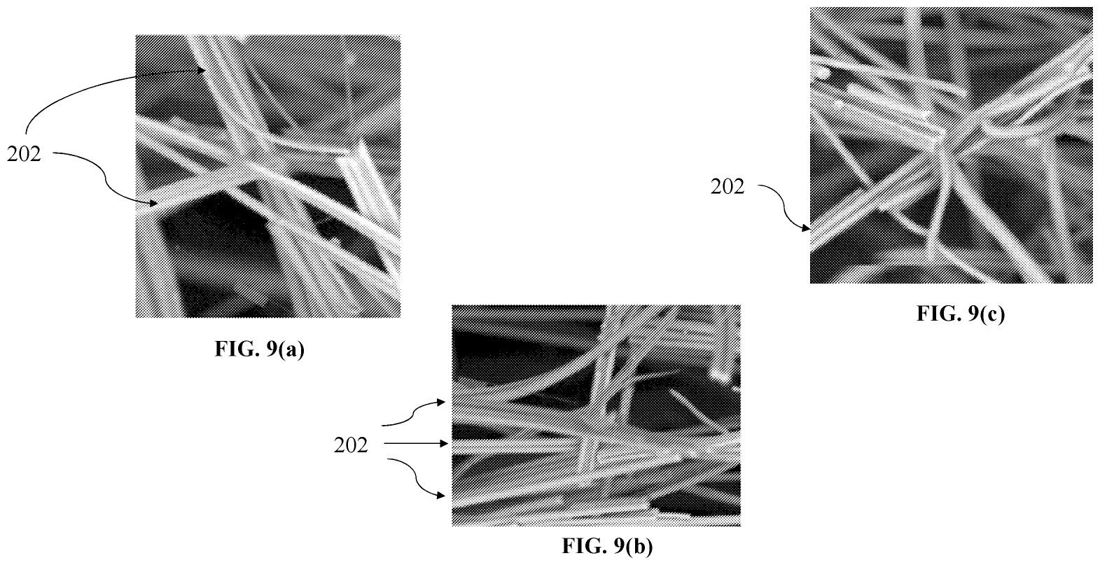

FIG. 9(a) is an SEM image illustrating the fiber orientation of an enlarged sample size area (24 mm×16 mm) of an exemplary fine fiber insulation product, formed in accordance with the subject invention (herein after referred to as Sample C). Sample C has an R-value of 22 and comprises glass fibers with an average fiber diameter of about 3.55 μm (14 HT) and a formaldehyde-free binder composition comprising between about 25-30 wt. % of sorbitol and between about 65-70 wt. % of a polyacrylic acid cross-linking agent, with a viscosity of about 2,000-3,000 cps at 60%-65% solids. The aqueous binder composition of Sample C has a viscosity of less than 12,000 cps at a solids content of 74.5%, and a viscosity below 6,000 cps at 70% solids and below.

The SEM image in FIG. 9(a) was used to measures localized fiber vector orientation (fiber sections in a particular plane).

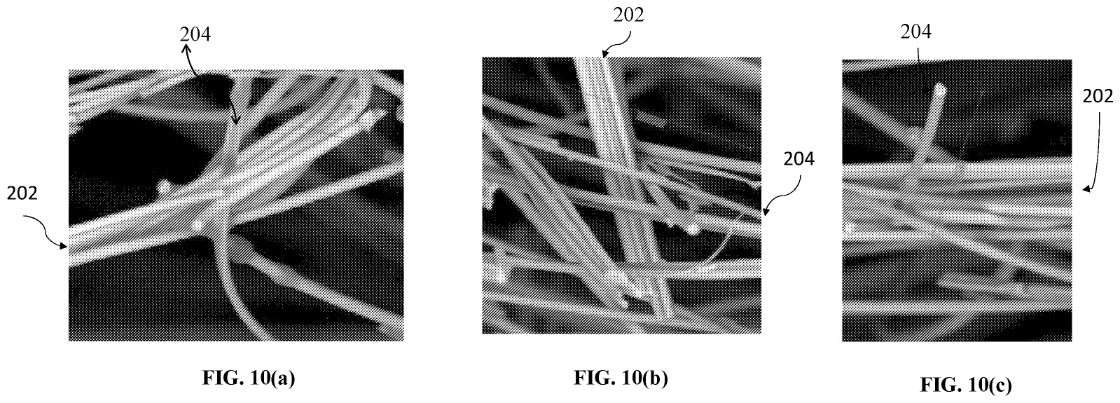

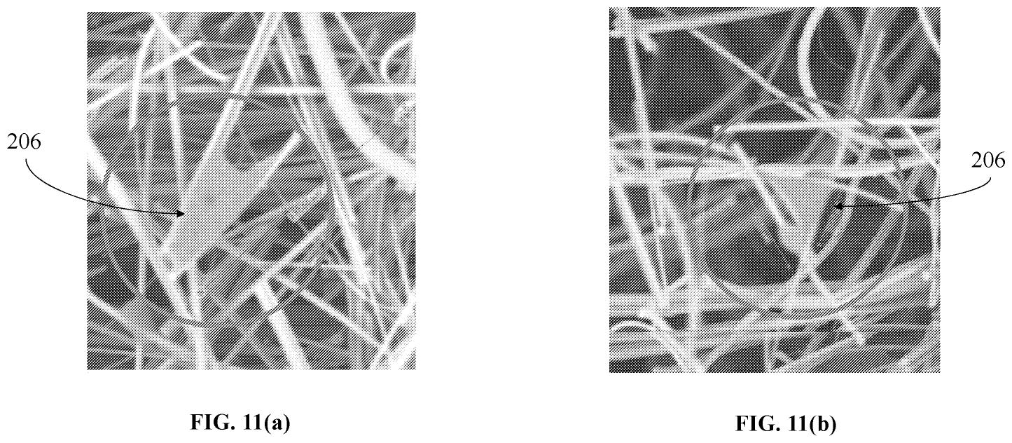

Comparatively, but also within the present inventive concepts, FIG. 10(a) is an SEM image illustrating the fiber orientation of a fine fiber insulation product with an R-value of 22, comprising glass fibers with an average fiber diameter of about 3.55 μm (14 HT) and a formaldehyde-free binder composition comprising between about 35-45 wt. % of sorbitol and between about 35-45 wt. % of a polyacrylic acid cross-linking agent, with a viscosity of less than 2,000 cps at 60%-65% solids (hereinafter referred to as Sample D). The aqueous binder composition of Sample D has a viscosity of less than 12,000 cps at a solids content of 74.5%, and a viscosity below 6,000 cps at 70% solids and below.

The SEM images of Samples C and D were acquired using Thermo Scientific Prisma SEM and the images were stitched using the Thermo Scientific MAPS software. The samples were cut in machine direction cross sections, mounted on SEM stubs using carbon glue and carbon paste, and sputter coated with Au. Fiber orientation measurements and quantifications were accessed using the Orientation J plug-in from the Image J software. Gaussian window sigma was set to 1 pix and Gaussian Gradient was selected for Structure Tensor.

The surface area (24 mm*16 mm) for each of Sample C and Sample D in the machine direction was imaged and analyzed for orientation distribution. As with Samples A and D, localized glass fibers (or fiber vectors or sections thereof) from Samples C and D were measured and analyzed for orientation distribution. The orientation frequency (normalized) versus orientation (degrees) was plotted and provided for each sample. Table 2 illustrates the weight percent of the fibers (or fiber vectors or sections thereof) in Samples C and D, respectively, within ranges of +/−50°, +/−30°, and +/−15° from a common plane (0°), horizontal to the product length L1.

It was surprisingly discovered that decreasing the binder viscosity used to form Sample D increased the proportion of glass fibers (or fiber vectors or sections thereof) oriented along a common plane. Particularly, as illustrated in Table 2, 32.94% by weight of the fibers (or fiber vectors or sections thereof) in Sample C were oriented within +/−15° of a common plane, 57.07% by weight were oriented within +/−30° of a common plane, and 78.87% by weight were oriented within +/−50° of a common plane. As further illustrated in Table 2, 45.14% by weight of the fibers (or fiber vectors or sections thereof) in Sample D were oriented within +/−15° of a common plane, 66.23% by weight were oriented within +/−30° of a common plane, and 84.03% by weight were oriented within +/−50° of a common plane. As explained above, the common plane may be a plane parallel to the insulation product's length and width.

TABLE 2

| Orientation within degree | | |
|---|---|---|
| of common plane | Sample C | Sample D |
| +/−15° | 32.94% | 45.14% |
| +/−30° | 57.07% | 66.23% |
| +/−50° | 78.87% | 84.03% |

Additionally, although at least a portion of the fibers (or fiber vectors or sections thereof) within the fibrous insulation product are oriented along a plane generally parallel to the forming chain or “L1 direction,” the fibrous insulation product may further include a portion of fibers (or fiber vectors or sections thereof) oriented along a plane generally perpendicular to the L1 direction. Such “dual oriented” fibrous insulation products demonstrate superior thermal properties, while also exhibit improved recovery and/or resistance to compressive forces. The dual oriented fibrous insulation products may comprise at least 10% by weight of the fibers (or fiber vectors or sections thereof) oriented along a plane generally perpendicular to the L1 direction, including at least 15% by weight, at least 18% by weight, at least 20% by weight, at least 25% by weight, at least 28% by weight, and at least 30% by weight of the fibers (or fiber vectors or sections thereof).

In some exemplary embodiments, the fibrous insulation product has an increased presence of parallel fiber bundles 202, comprising at least two fibers oriented in a substantially parallel direction and bound to one another at one or more points along the length of the fibers. The magnified SEM images of FIGS. 9(a)-9(c) illustrate the parallel fiber bundles present in the fibrous insulation product. FIGS. 10(a)-10(c) provide further magnified SEM images of the fibrous insulation product shown in FIG. 3, further illustrating the prevalence of parallel fiber bundles. The parallel fiber bundles 202 may form junctions with a single fiber 204 or with other parallel fiber bundles 202.

In any of the exemplary embodiments, at least 15% by weight of the fibers in the fibrous insulation product 200 may be at least partially included in a parallel fiber bundle. In other exemplary embodiments, at least 20% by weight of the fibers in the fibrous insulation product are at least partially included in a parallel fiber bundle, including at least 25% by weight, at least 28% by weight, at least 30% by weight, at least 35% by weight, at least 40% by weight, at least 45% by weight, and at least 50% by weight of the fibers in fibrous insulation product.

It has further been discovered that in any of the exemplary embodiments disclosed herein, the fibrous insulation product may have a reduced presence of binder gussets extending between at least two fibers. As defined herein, a binder “gusset” means a portion of cured binder composition extending between at least two fibers, usually in a triangular or rhomboidal shape, similar to an angled bracket. The binder gussets are measured by means of microscopy (e.g., optical microscopy or scanning electron microscopy). In the case of optical microscopy, the use of a refractive index solution to “hide” the glass fibers facilitates the identification of binder-fiber junctions and gussets. SEM images illustrating exemplary binder gussets are provided in FIGS. 11(a) and 11(b).

Binder gussets form between non-parallel fibers, indicating that the fibers are oriented in distinct planes. Not wishing to be bound by theory, it is believed that minimizing binder gussets and increasing the presence of binder composition along the length of fibers is beneficial in both improving uniform orientation and also increasing the presence of parallel fiber bundles.

Due to the increased uniformity in fiber orientation, in some exemplary embodiments, no more than 40% by weight of the binder composition present in the fibrous insulation product is located within a binder gusset. In any of the exemplary embodiments, no more than 35% by weight of the binder composition is located within binder gussets, including no more than 30% by weight, no more than 25% by weight, no more than 20% by weight, no more than 15% by weight, no more than 10% by weight, and no more than 5% by weight.

Moreover, further due to the increased uniformity in fiber orientation, no greater than 75% by weight of the binder is located within a binder node, which is the portion of the binder composition distributed at the intersection between two or more crossed fibers. In some exemplary embodiments, the amount of binder located within binder nodes is limited to no greater than 60% by weight, including no greater than 50% by weight, no greater than 45% by weight, and no greater than 40% by weight.

As mentioned above, it is believed that various product and product parameters impact the orientation of the fibers in the fine fiber insulation product. Not intended to be bound by theory, it is believed that the increased presence of fibers (or fiber vectors or sections thereof) oriented in a plane generally parallel to the L1 direction at least partially results from the synergistic combination of small diameter glass fibers (i.e., average fiber diameter of less than or equal to 3.81 μm (or 15 HT) with a low-viscosity formaldehyde-free binder composition. Particularly, at a temperature of 25° C., the binder composition has a viscosity of no greater than 90,000 cP at a solids concentration of 65%-70% by weight, including a viscosity of no greater than 50,000 cP, no greater than 25,000 cP, no greater than 15,000 cP, no greater than 10,000 cP, and no greater than 4,000 cP at 25° C. and a solids concentration of 65%-70% by weight.

In addition to impacting fiber orientation, the low viscosity of the binder composition allows for a reduction in fiber pack moisture on the “ramp” as the pack moves from the forming chamber into the curing oven. It is important that the ramp moisture be low enough as the fiber pack enters the curing oven in order for the product to fully and consistently cure throughout the entire thickness of the pack. In some exemplary embodiments, the viscosity of the binder composition is adjusted to ensure a ramp moisture level of no greater than 7%, including no greater than 5%, no greater than 3%, and no greater than 2%.

The fibrous insulation product has a binder content (LOI) of less than or equal to 10% by weight of the fibrous insulation product, or less than or equal to 8.0% by weight of the fibrous insulation product, or less than or equal to 6.0% by weight of the fibrous insulation product, or less than or equal to 3.0% by weight of the fibrous insulation pack. In any of the exemplary embodiments, the insulation product has a binder content (LOI) of 1.0% to 10.0% by weight of the fibrous insulation product, including between 2.0% to 8.0% by weight, 2.5% to 6.0% by weight, or 3.0% to 5.0% by weight. The relatively low amount of binder contributes to the flexibility of the final insulation product. In any of the exemplary embodiments, the fibrous insulation product has an LOI that is less than 4.5%, including less than 4.2%, less than 4.0%, less than 3.8%, and less than 3.5%.

Not intending to be bound by theory, the orientation of fine diameter fibers (i.e., fibers having an average fiber diameter less than or equal to 3.81 μm (15 HT) in a plane that is generally more parallel to the L₁ (or machine) direction plane has resulted in the formation of fibrous insulation products with surprisingly improved thermal performance and overall material efficiency. The thermal performance of a fiberglass insulation product is based on the R-value of the fiberglass insulation product, which is a measure of the product's resistance to heat flow. The R-value is defined by Equation (1):

$$\begin{matrix}Equation ( 1 ) & \\ R = {T}_{1} / k & ( 1 )\end{matrix}$$

where “T₁” is the thickness of the insulation product expressed in inches, “k” is the thermal conductivity of the insulation product expressed in BTU·in/hr·ft²·° F., and “R” is the R-value of the insulation expressed in hr·ft²·° F./BTU.

As used herein, an insulation product's thickness (T1) may be determined in accordance with ASTM C167-18 and both k-value and area weight (in lb/ft2) may be determined in accordance with ASTM C518-17 or ASTM C177-19.

An insulation product's R-value, thermal conductivity, and material efficiency are parameters that provide an indication of the thermal performance of the insulation product.

Material efficiency (“ME”) may be defined by Equation (2):

$$ME = R - value / W , \qquad Equation ( 2 )$$

expressed in R·ft²/lb, where “R” is the R-value of the insulation product and “W” is the insulation product's area weight in lb/ft². ME measures how efficiently an insulation product resists heat flow and is a metric that can be used to quantify the performance of a fiberglass insulation batt. To achieve greater values of R·ft², insulation providers generally increase the amount of insulation material (in pounds-mass (lb)). Thus, insulation that provides higher R·ft² per pound of material is desirable and this is measured by ME (i.e., thermal insulating benefit of a product divided by the amount of material used to provide the thermal insulating benefit).

### Thermal Conductivity

The fine fiber insulation products of the subject invention have demonstrated a surprisingly larger decrease in thermal conductivity for a given density than expected. For example, a 1995 publication by Saint Gobain (Langlais, C., Guilbert, G., Banner, D., and Klarsfeld, S (1995). Influence of the Chemical Composition of Glass on Heat Transfer through Glass Fiber Insulations in Relation to Their Morphology and Temperature. J. Thermal Insulation and Building Envs., 18, 350-376) (hereinafter “SG Publication”) details a theoretical approach to predicting thermal performance of fibrous insulants. The SG Publication indicates that apart from temperature and density, the mean diameter of fibers has been found as a means to reduce thermal conductivity and provides data illustrating the impact of fiber diameter on thermal conductivity. Applicants have developed proprietary modeling teachings, independent of the SG Publication, that predict near identical curves as shown in the SG Publication. Thus, the data presented in the SG Publication (hereinafter “Expected Results”) is considered indicative of the expected thermal performance of fiberglass insulation at various density and fiber diameters.

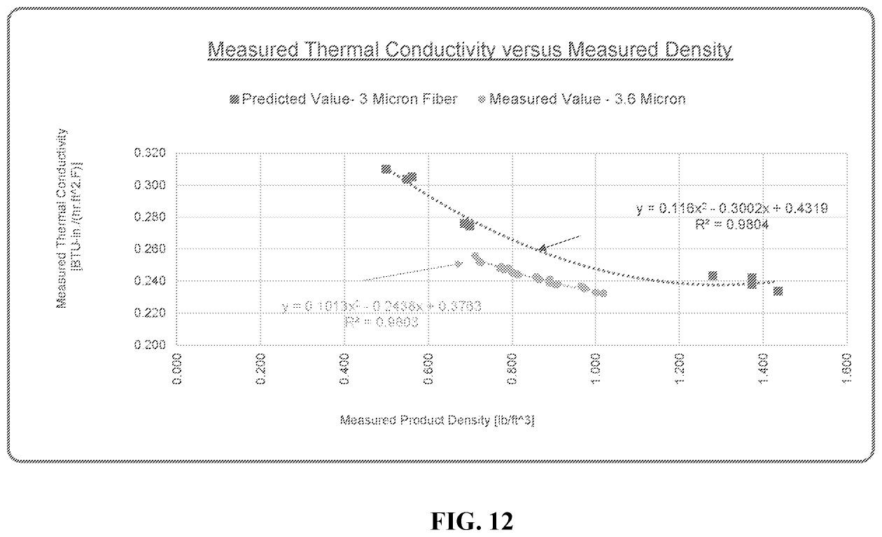

However, the thermal conductivity values of the inventive fiberglass insulation product having an average fiber diameter of 3.6 μm over a density range of 3.20 kg/m3 (0.2 pcf) to 25.63 kg/m3 (1.6 pcf) is unexpectedly lower than the predicted thermal conductivity values, based on the Expected Results. FIG. 12 illustrates the difference between the Expected Results (based on a fiberglass insulation product having an average fiber diameter of 3 μm) and the measured thermal conductivity of the inventive 3.6 μm fiberglass insulation product. As illustrated, the thermal conductivity values established by the Expected Results correspond to Formula (I):

$$y = 0.116 {x}^{2} - 0.3002 x + 0.4319 \qquad Formula ( I )$$

where y is the thermal conductivity (k-value), expressed as BTU·in/(hr·ft²·° F.), and x is the product density, expressed in lb/ft³ (“pcf”). Formula (I) has a R²=0.9804, indicating a high degree of accuracy in the equation. In contrast, the measured thermal conductivity values for the inventive 3.6 μm insulation product produced Formula (II):

$$y = 0.1013 {x}^{2} - 0.2438 x + 0.3763 \qquad Formula ( II )$$

where y is the thermal conductivity (k-value) expressed as BTU·in/(hr·ft²·° F.), and x is the product density, expressed in lb/ft³ or pcf. Formula (II) has a R²=0.9803, indicating a high degree of accuracy in the equation.

Accordingly, at a given density, the inventive 3.6 μm insulation product demonstrated a significantly lower thermal conductivity than expected, based on an insulation product having an even smaller fiber average fiber diameter (3.0 μm vs. 3.6 μm). For example, at a density of 0.8 pcf, Formula (I) outputs a thermal conductivity prediction of 0.2660 BTU-in/(hr·ft2·° F.), while the inventive 3.6 μm fiberglass insulation product demonstrated a lower measured thermal conductivity (k-value) of 0.2461 BTU·in/(hr·ft2·° F.). A k-value reduction of 0.0199 is a statistically significant reduction.

In some embodiments, the fibrous insulation product of the subject disclosure demonstrates a reduction in k-value of at least 0.01 BTU·in/(hr·ft²·° F.) compared to the Expected Results over a density range of 0.2 pcf to 1.35 pcf, including a reduction in k-value of at least 0.015, at least 0.03, at least 0.05, at least 0.075, at least 0.1, at least 0.15, at least 0.2, and at least 0.23 BTU·in/(hr·ft²·° F.).

In any of the exemplary embodiments provided herein, the fibrous insulation product may have a thermal conductivity (k-value (y)) expressed as BTU·in/(hr·ft²·° F.) equal to or less than that which satisfies Formula (III):

$$y = 0.116 {x}^{2} - 0.3002 x + 0.4219 \qquad Formula ( III )$$

where x is the product density within the range of 0.2 pcf and 1.6 pcf. Formula (III) is based on Formula (I), but reduced by 0.01 to ensure sufficient separation over expected results. In these or other exemplary embodiments, the fibrous insulation product may have a thermal conductivity (k-value (y) expressed as BTU·in/(hr·ft²·° F.) within 10%, or at least within 5%, of a value (y) that satisfies Formula (IV):

$$y = 0.1013 {x}^{2} - 0.2438 x + 0.3763 \qquad Formula ( IV )$$

where x is the product density within the range of 0.2 pcf and 1.6 pcf.

Although particular benefits may be exemplified in low density insulation products (i.e., less than 1.6 pcf), the density of the fibrous insulation product may vary in different embodiments. As used in this application, the density of the fibrous insulation product is the density of the product after the binder composition has been cured and the cured product is in a free state (i.e., not compressed or stretched). In various embodiments, the density of the fibrous insulation product is in the range of 3.20 kg/m3 (0.2 pcf) to 43.25 kg/m3 (2.7 pcf). Table 3 lists the original density, in pcf, for various exemplary embodiments of fibrous insulation products having fine fibers in the range of 2.03 μm (8.0 HT) to 3.81 μm (15 HT). In Table 3, the fiber diameters refer to an average fiber diameter, prior to the application of the binder composition, as measured by the air flow resistance method described above. The thickness and original density refer to the thickness and density of the product after the binder composition has been cured and the cured product being in a free state (i.e., not compressed or stretched).

TABLE 3

| | Thickness | | | | | | | | |
|---|---|---|---|---|---|---|---|---|---|
| | 3.50 | 3.50 | 3.50 | 6.25 | 5.50 | 5.50 | 9.50 | 12.00 | 14.00 |
| | Binder Content (% wt.) | | | | | | | | |
| | 5.50 | 5.50 | 4.00 | 5.50 | 5.50 | 4.00 | 5.50 | 5.50 | 4.00 |
| | R-Value | | | | | | | | |
| | R11 | R13 | R15 | R19 | R20 | R21 | R30 | R38 | R49 |
| Fiber Diameter | Product Density | | | | | | | | |
| 8 | 0.353 | 0.549 | 0.950 | 0.326 | 0.513 | 0.589 | 0.355 | 0.357 | 0.453 |
| 9 | 0.363 | 0.569 | 0.987 | 0.336 | 0.530 | 0.611 | 0.366 | 0.369 | 0.468 |
| 10 | 0.377 | 0.590 | 1.025 | 0.348 | 0.550 | 0.631 | 0.379 | 0.381 | 0.483 |
| 11 | 0.387 | 0.607 | 1.063 | 0.359 | 0.567 | 0.652 | 0.392 | 0.394 | 0.500 |
| 12 | 0.401 | 0.627 | 1.097 | 0.371 | 0.585 | 0.674 | 0.403 | 0.406 | 0.515 |
| 13 | 0.411 | 0.645 | 1.135 | 0.382 | 0.602 | 0.694 | 0.416 | 0.418 | 0.531 |
| 14 | 0.425 | 0.665 | 1.173 | 0.392 | 0.622 | 0.716 | 0.428 | 0.430 | 0.547 |
| 15 | 0.435 | 0.686 | 1.214 | 0.403 | 0.639 | 0.737 | 0.440 | 0.443 | 0.563 |

The data in Table 3 shows fibrous insulation products having R-values from 11 to 49 produced with average fiber diameters less than or equal to 3.81 μm (15 HT), original densities in the range of 0.371 pcf (5.943 kg/m3) to 1.214 pcf (19.446 kg·m3), and less than or equal to 6% by weight of the binder composition.

### Material Efficiency

As mentioned above, material efficiency is a measurement of a product's insulation value (R·ft2) per pound of insulation material and is expressed as R·ft2/lb. By maximizing material efficiency, an insulation product can offer high insulation performance at as low of a weight as possible. Stated another way, because of its improved material efficiency, the inventive insulation products can achieve equivalent insulation performance at a lower weight/density. Lowering product weight allows for a reduction in the amount of fiberglass and binder material needed and thus reduces overall cost (e.g., production, storage, shipping, and/or disposal costs). Additionally, lower density products are lighter and easier to handle that higher density products for the same square footage of product a bag.

It has unexpectedly been discovered that the fibrous insulation products of the present disclosure demonstrate a surprising increase in material efficiency compared to what would be expected, based on the Expected Results. At a higher material efficiency, the inventive fibrous insulation product can provide a desired insulation performance, (R-value) at a lower than predicted area weight.

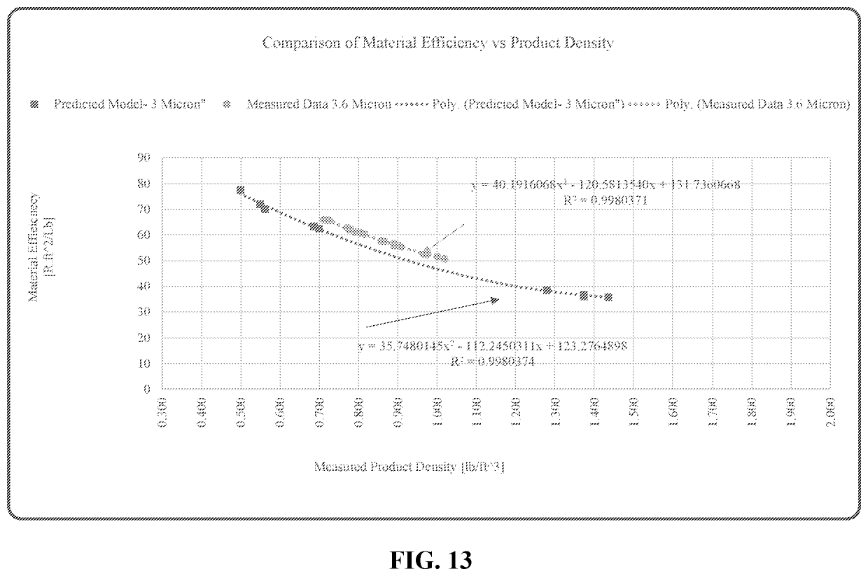

FIG. 13 illustrates the material efficiency difference between the output of the Expected Results, based on a fiberglass insulation product with an average fiber diameter of 3 m and a thickness of 13.97 cm (5.5 inches), and the actual material efficiency of the inventive 3.6 μm insulation product at a thickness of 13.97 cm (5.5 inches). As illustrated in FIG. 13, the predicted material efficiency of a fibrous insulation product determined by the Expected Results corresponds to Formula (V), below:

$$y = 35.7480145 {x}^{2} - 112.2450311 x + 123.2764898 \qquad Formula ( V )$$

where y is material efficiency, expressed as R·ft²/lb, and x is the product density over a density range of about 0.5 pcf to about 1.5 pcf. Formula (V) has a R²=0.9980374, indicating a high degree of accuracy in the model. In contrast, the actual material efficiency of the inventive 3.6 m insulation product corresponds to Formula (VI):

$$y = 40.1916068 {x}^{2} - 120.5813540 x + 131.7360668 \qquad Formula ( VI )$$

where y is the material efficiency, expressed as R·ft²/lb, and x is the product density, over a density range of about 0.7 pcf to about 1.35 pcf. Formula (V) has a R²=0.9980374, indicating a high degree of accuracy in the equation.

At a given density, the inventive 3.6 μm insulation product demonstrates a higher material efficiency than predicted, based on an insulation product having an even smaller fiber average fiber diameter (3.0 μm versus 3.6 μm). For example, at a density of 0.8 pcf (12.81 kg/m3), Formula (V) predicts a material efficiency of 56.36 R·ft2/lb, while the inventive 3.6 m fiberglass insulation product demonstrates an actual material efficiency of 60.99 R·ft2/lb, an increase of over 4 units. Similarly, at a density of 0.6 pcf (9.61 kg/m3), Formula (V) predicts a material efficiency of 68.80 R·ft2/lb, while the inventive 3.6 μm fiberglass insulation product demonstrates an actual material efficiency of 73.86 R·ft2/lb an increase of over 5 units.

Thus, the fibrous insulation product of the subject disclosure demonstrates an increased material efficiency of at least 4.0 units compared to that expected, over a density range of 0.2 pcf (3.20 kg/m3) to 1.6 pcf (25.63 kg/m3), and at some instances at least 5.0 units, at least 5.5 units, at least 5.8 units, and at least 6.0 units.

In any of the exemplary embodiments provided herein, the fibrous insulation product, at an R-value between 19 and 24, an area weight between 0.3 lb/ft2 (1.46 kg/m2) and 0.5 lb/ft2 (2.44 kg/m2) and density between 0.7 pcf (11.21 kg/m3) and 1.35 pcf (21.62 kg/m3), may have a material efficiency in accordance with the formula ME=R-value/area weight (W) of at least 50, such as at least 55, at least 58, at least 60, at least 63, at least 65, at least 68, at least 70, at least 75, and at least 80.

As an individual insulation product may include a certain degree of variation within the product itself, it is to be appreciated that the thermal performance values provided above are average predicted values that do not consider this natural variation. Thus, to account for natural product variation, Formula (VI) above may be adjusted by the variation value, which has been calculated as 2.1076693 at 95% confidence level. Thus, taking into consideration this variation value, the adjusted material efficiency of the inventive insulation product corresponds to Formula (VII):

$$y = 40.1916068 {x}^{2} - 120.5813540 x + 129.628397 \qquad Formula ( VII )$$

where y is adjusted material efficiency, expressed as R·ft²/lb, and x is the product density over a density range of about 0.5 pcf to about 1.5 pcf.

FIG. 13 graphically illustrates the material efficiency difference between the output of the Expected Results, based on a fiberglass insulation product with an average fiber diameter of 3 μm and a thickness of 13.97 cm (5.5 inches), and the adjusted material efficiency of the inventive 3.6 μm insulation product at a thickness of 13.97 cm (5.5 inches) and including the variation variable.

As illustrated in FIG. 13, the adjusted material efficiency of the inventive 3.6 μm insulation product demonstrates a higher material efficiency than the Expected Results, based on an insulation product having an even smaller fiber average fiber diameter (3.0 μm versus 3.6 μm). For instance, at a density of 0.8 pcf, Formula (V) (the Expected Results) predicts a material efficiency of 56.36 R·ft2/lb, while the inventive 3.6 μm fiberglass insulation product demonstrates an adjusted material efficiency of 58.89 R·ft2/lb, an increase of over 2 units. Similarly, at a density of 0.6 pcf, Formula (V) predicts a material efficiency of 68.80 R·ft2/lb, while the inventive 3.6 μm fiberglass insulation product demonstrates an adjusted material efficiency of 71.75 R·ft2/lb an increase of almost 3 units.

Although particular benefits may be exemplified in products having a variety of area weights, particular benefits may be captured at relatively low area weights, while maintaining desirable thermal properties. As used in this application, the area weight of the fibrous insulation product is the weight of the insulation product after the binder composition has been cured per square foot (lb/ft2). In various embodiments, the area weight of the fibrous insulation product is in the range of 0.49 kg/m2 (0.1 lb/ft2) to 9.76 kg/m2 (2.0 lb/ft2), including between 0.98 kg/m2 (0.2 lb/ft2) and 8.79 kg/m2 (1.8 lb/ft2), between 1.22 kg/m2 (0.25 lb/ft2) and 7.32 kg/m2 (1.5 lb/ft2), between 1.46 kg/m2 (0.3 lb/ft2) and 5.86 kg/m2 (1.2 lb/ft2), between 1.71 kg/m2 (0.35 lb/ft2) and 4.88 kg/m2 (1.0 lb/ft2), and between 1.86 kg/m2 (0.38 lb/ft2) and 2.93 kg/m2 (0.6 lb/ft2). In any of the exemplary embodiments, the area weight of the fibrous insulation product may be less than 2.69 kg/m2 (0.55 lb/ft2), including less than 2.44 kg/m2 (0.5 lb/ft2), less than 2.34 kg/m2 (0.48 lb/ft2), less than 2.20 kg/m2 (0.45 lb/ft2), and less than 2.05 kg/m2 (0.42 lb/ft2).

Additionally, as mentioned above, the improved thermal and material efficiency benefits may be captured at any insulation product thicknesses, and particular benefits may be seen at relatively low product thicknesses. Generally, the R-value of an insulation product can be improved by increasing the thickness (T1) of the insulation product, which in turn may lower the product's density (assuming no other changes to the product). However, increasing product thicknesses is not possible for constrained products (i.e., those installed into a fixed thickness wall cavity). Accordingly, there is no R-value advantage obtained by making a product thicker than the thickness of the wall cavity, as the insulation product can only expand to the thickness of the wall opening. In any of the exemplary embodiments, the fibrous insulation product thickness T1 may be less than about 50.8 cm (20 inches), including a thickness no greater than 45.7 cm (18 inches), no greater than 38.1 cm (15 inches), no greater than 30.5 cm (12 inches), no greater than 25.4 cm (10 inches), no greater than 20.3 cm (8 inches), no greater than 17.8 cm (7 inches), no greater than 16.5 cm (6.5 inches), and no greater than 15.2 cm (6 inches). For example, in some thickness-constrained products, the fibrous insulation product may have a thickness that is less than 17.8 cm (7 inches), including less than 16.5 cm (6.5 inches), less than 6 inches, less than 14.0 cm (5.5 inches), less than 12.7 cm (5 inches), less than 11.4 cm (4.5 inches), and less than 10.2 cm (4 inches). In these or other embodiments, the fibrous insulation product may have a thickness of, for example, 1.27 cm (0.5 inches) to 20.3 cm (8 inches), including thicknesses between 1.9 cm (0.75 inches) and 19.1 cm (7.5 inches), between 2.3 cm (0.9 inches) and 17.8 cm (7 inches), between 2.5 cm (1.0 inch) and 17.3 cm (6.8 inches), between 3.8 cm (1.5 inches) and 16.0 (6.3 inches), and between 5.1 cm (2.0 inches) and 15.2 cm (6.0 inches).

Table 4 illustrates the structural and thermal properties for two exemplary fibrous insulation products (Examples 1 and 2) formed with fibers having an average fiber diameter of 3.68 μm (14.5 HT) and 3.65 μm (14.4 HT), respectively. Each of the products of Example 1 and 2 was formed with a formaldehyde-free binder composition comprising a monomeric polyol and polymeric polycarboxylic acid crosslinking agent. Examples 1 and 2 had thicknesses of 14.0 cm (5.5 inches), and insulation values of R-22. As shown in Table 4, below, at k-values of 0.25 BTU·in/hr ft2·° F., Examples 1 and 2 demonstrated low densities of 0.746 lb/ft3 (11.950 kg/m3) and 0.759 lb/ft3 (12.158 kg/m3), respectively, with LOI values below 4%. In contrast, Comparative Example 1 was formed with 4.05 μm (15.9 HT) glass fibers and a binder composition comprising a polymeric polyol and monomeric polycarboxylic acid cross-linking agent. The product of Comparative Example 1, at a thickness of 14.0 cm (5.5 inches) and k-value of 0.25 BTU·in/hr ft2·° F. demonstrated a density of 0.830 lb/ft3 (13.295 kg/m3), which is at least 7%, and particularly at least 9% higher than the densities of Example 1 and 2.

Further surprisingly, Comparative Example 2 was formed with 3.62 μm (14.3 HT) glass fibers (thereby considered “fine fiber” as defined herein) and a binder composition comprising a polymeric polyol and monomeric polycarboxylic acid cross-linking agent. The product of Comparative Example 2, at a thickness of 14.0 cm (5.5 inches) and k-value of 0.23 BTU·in/hr ft2·° F. demonstrated a density of 1.25 lb/ft3 (20.023 kg/m3), at least 39% higher than the densities of Example 1 and 2.

TABLE 4

| | | | | | | | | | Average | |
|---|---|---|---|---|---|---|---|---|---|---|
| | | k-Value | R-Value | | | Density Δ | Density Δ | | Fiber | Material |
| | T₁ | (BTU · in/ | hr · ft² · ° F./ | Area Wt. | Density | from Comp. | from Comp. | LOI | Diameter | Eff. |
| | (in) | hr · ft² · ° F.) | BTU) | (lb/ft²) | (lb/ft³) | Ex. 1 | Ex. 2 | (%) | (HT) | (R.ft²/lb) |
| Comp. EX. 1 | 5.5 | 0.25 | 22.0 | 0.380 | 0.830 | 0% | 33.6% | 4.28 | 15.9 | 57.89 |
| (ET) R-22 | | | | | | | | | | |
| Comp. Ex. 2 | 5.5 | 0.23 | 23.8 | 0.531 | 1.25 | 33.6% | 0% | 6.58 | 14.3 | 44.8 |
| (ET) R-24 | | | | | | | | | | |
| Example 1 | 5.5 | 0.25 | 22.0 | 0.342 | 0.746 | 10% | 40.3% | 3.75 | 14.5 | 64.33 |
| R-22 | | | | | | | | | | |
| Example 2 | 5.5 | 0.25 | 22.0 | 0.348 | 0.759 | 9% | 39.3% | 3.79 | 14.4 | 63.21 |
| R-22 | | | | | | | | | | |

Moreover, at the same thickness and roughly the same R-values, Examples 1 and 2 increased material efficiency by over 5 units, compared to the products of Comparative Examples 1 and 2. These differences can be attributed at least to the increase in area weight required in Comparative Examples 1 and 2 to achieve a k-value comparable to that of Examples 1 and 2. Accordingly, it can be seen that the fibrous insulation products of the present disclosure are capable of providing improved thermal properties at a reduced area weight, thereby improving the efficiency of the product as a whole.

While the use of fibers having a smaller average fiber diameter has been shown to achieve improved properties, such as thermal performance, the use of smaller diameter fibers and/or the orientation of those fibers to be more parallel to main faces of the insulation product presents challenges to other performance properties. For example, properties such as the compression recovery, the package expansion rate, the cavity fit, and the cavity retention of the fibrous insulation product would necessarily be expected to decrease as a result of using the finer (e.g., weaker, less stiff) fibers. However, the fibrous insulation products disclosed herein were able to retain or improve upon these other performance properties when pairing the finer fibers with particular binder systems.

As the fiber diameter gets smaller, there will be more fibers in the same volume. For example, as the fiber diameter decreases from 4.12 μm (16.3 HT) to 3.50 μm (13.8 HT), there are approximately 40% more fibers in the same volume. In general, at lower diameters, the fibers become more flexible. Likewise, thicker glass fibers are more prone to breaking because they are not as flexible. Not only do the individual finer fibers better resist damage, but since there is a higher number of such fibers intermingled together (and interconnected by the binder), having more and finer fibers creates an even more damage resistant matrix, as the fibers will work and bend together to resist breaking. On the negative side, the increased flexibility of the finer fibers will cause the insulation product to be less stiff, which is often an undesirable trait.

### Compression Resistance and Compression Recovery

The thermal performance of a fibrous insulation product is directly related to its thickness. In other words, the R-value of the insulation product is a measure of its thermal resistance for its specific thickness. The thickness of such an insulation product can become compromised when exposed to compressive forces, such as from routine handling and or packaging (described in more detail below) thereof. In the field, this may require an installer to manipulate the insulation product in an attempt to restore it to its original thickness, which is both a time consuming and imprecise exercise.

The fibrous insulation products, according to the general inventive concepts disclosed and suggested herein, are believed to exhibit superior recovery from and/or resistance to compressive forces. This results in a product that is more consistently at the correct thickness, even after packaging and additional handling. This performance property of the insulation product may be characterized as the “push-back” force when compressed to a specific thickness, the recovered thickness after one or more loadings, and/or the creep under load.

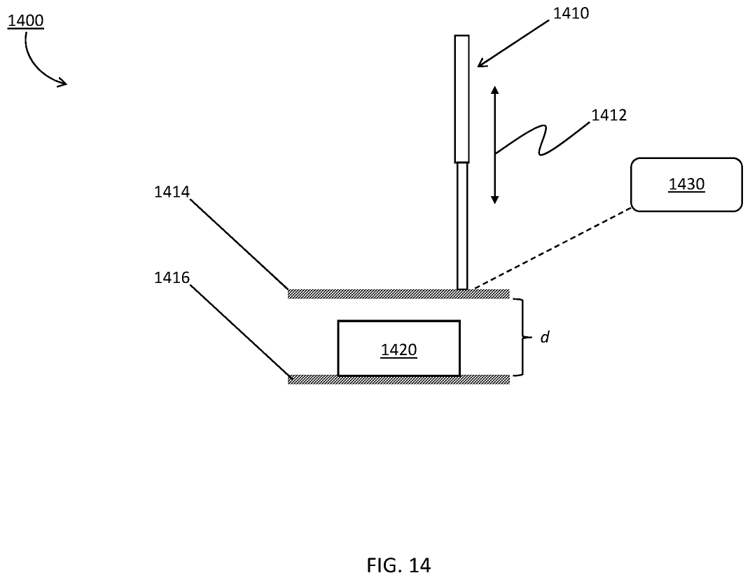

A thickness testing system 1400, as shown in FIG. 14, was designed to quantify this performance property consistently and accurately. The system 1400 uses an electrically controlled linear actuator 1410 that moves up and down as shown by arrow 1412. In this manner, the actuator 1410 can move an upper flat plate 1414 relative to a fixed lower flat plate 1416. The system 1400 knows the position of the two plates 1414,1416 and, thus, can calculate the distance d between the two plates 1414,1416. In this manner, a thickness of a sample 1420 situated between the upper plate 1414 and the lower plate 1416 can be measured. Furthermore, the actuator 1410 contains a load cell to measure the force at which it is pressing the upper plate 1414 downwards. A processing unit 1430 (e.g., a touchscreen computer) is connected to the system 1400. The processing unit 1430 can, among other things, measure the initial thickness of the sample 1420, that is, the sample 1420 under no (or a negligible) load; compress the sample 1420 to a specific thickness; apply a specific load (e.g., pound-force) to the sample 1420; and log the current thickness and applied force. Some or all of the components of the system 1400 can be interfaced with one another view a frame, housing, or the like.

The processing unit 1430 can be driven by software routines (e.g., scripts). In one exemplary embodiment, a script was used to measure the initial thickness of the sample 1420; apply a 5.0 lbf (22.2 N) force on the sample 1420 for 60 seconds, while measuring the compressed thickness of the sample 1420; and then release the 5.0 lbf (22.2 N) and measure the thickness to which the sample 1420 returns. The script caused the system 1400 to repeat the loading and measurement cycle five times on the sample 1420 and logged the force and thickness measurements every second.

More specifically, the script was used to run a first trial of the tests on 10 samples of a conventional R22 fiberglass insulation product (labeled “Control”) and 10 samples of an inventive R22 fiberglass insulation product (labeled “NGFG”). Each of the samples were 15.24 cm wide×15.24 cm long (6-inch wide×6-inch long) specimens taken from larger insulation products. Each of the samples had approximately the same initial thickness. More specifically, the control samples were measured to have an initial (unpackaged) thickness of 15.72 cm (6.19 inches), while the NGFG sample were measured to have an initial (unpackaged) thickness of 15.47 cm (6.09 inches). Each of the control samples included fibers having an average diameter of about 4.06 μm (16 HT) and a binder lacking a monomeric polyol, while each of the NGFG samples included fibers having an average diameter of 3.65 μm (14.4 HT) and a binder including a monomeric polyol. The control samples had a density of 12.33 kg/cm3 (0.77 pcf), while the NGFG samples had a density of 12.01 kg/m3 (0.75 pcf). Furthermore, the control samples had a higher binder loading than the NGFG samples. Typically, the control samples represent an insulation product having a binder loading in the range of 4% to 7% (measured loss-on-ignition, LOI), while the NGFG samples represent an insulation product having a lower (e.g., 10% or more) binder loading in the range of 3.6% to 6.3% LOI. For purposes of the tests, the control samples had an LOI of 4.3%, while the NGFG samples had an LOI of 3.7%.

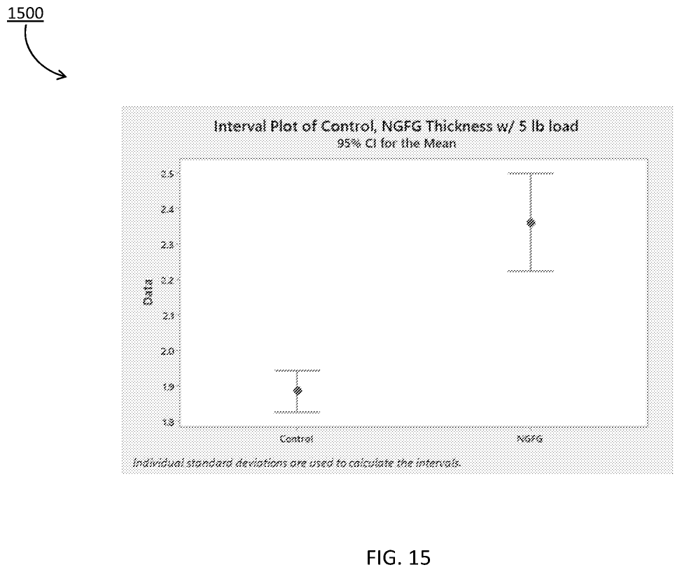

As shown in the graph 1500 of FIG. 15, the NGFG insulation product does not initially compress as far as the control sample, under the same load (i.e., 5.0 lbf (22.2 N)). Thus, the NGFG insulation product has a greater resistance to compression than the control insulation product.

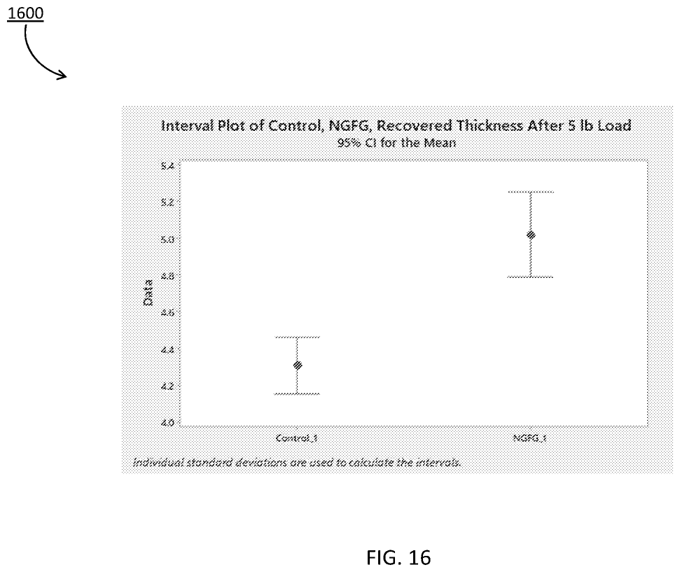

Furthermore, as shown in the graph 1600 of FIG. 16, the NGFG insulation product recovers more (i.e., to a greater thickness) when the load is removed. Thus, the NGFG insulation product has a greater compression recovery than the control insulation product.

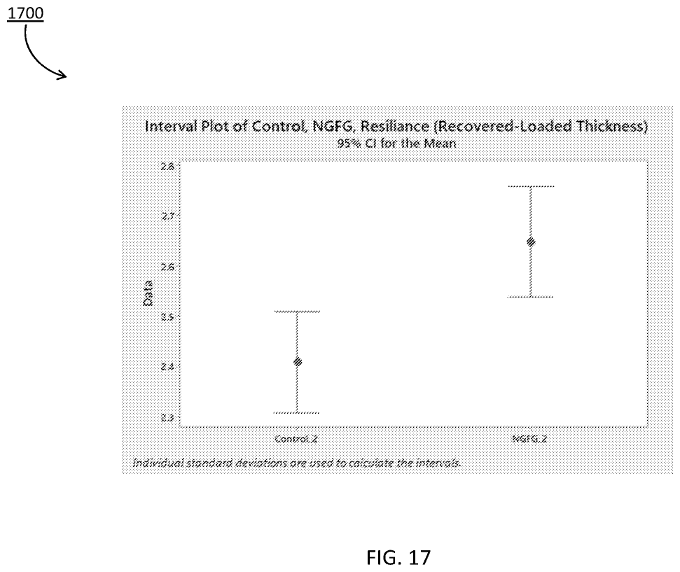

As shown in the graph 1700 of FIG. 17, the difference between the loaded and recovered thickness is higher with the NGFG insulation product than the control sample, demonstrating that the NGFG product has a higher recovery capability.

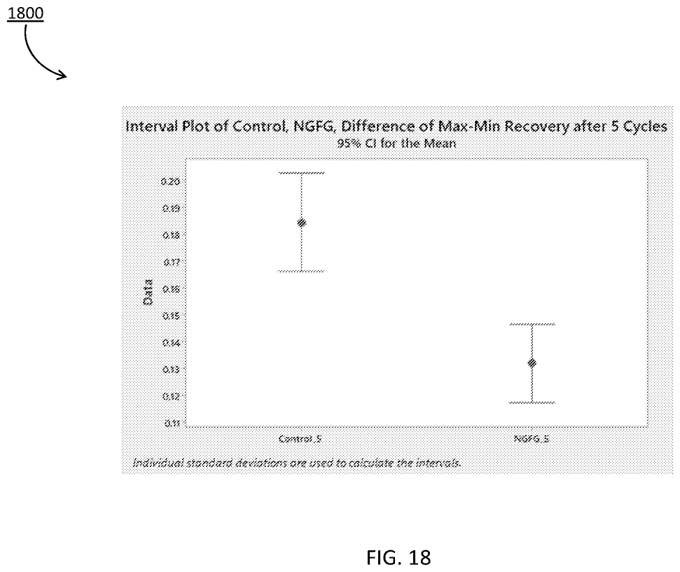

Further still, as shown in the graph 1800 of FIG. 18, the difference between the maximum recovery and the minimum recovery taken from repeated instances (i.e., 5 cycles) of engaging and removing the 5.0 lbf (22.2 N) loading, the NGFG insulation product shows lower degradation in its ability to recover when compared to the control sample.

Thus, notwithstanding that the inventive insulation product (i.e., the NGFG insulation product) is made of finer fibers, has less binder, and may have a lower ratio of fibers oriented in a direction perpendicular to the major faces of the insulation product than the conventional insulation product (i.e., the control insulation product), the inventive insulation product surprisingly exhibits superior compression resistance (e.g., the thickness of the fibrous insulation product changes by less than 65% in response to application of 5.0 lbf (22.2 N) on the fibrous insulation product, or less than 62%) and recovery (e.g., greater than 75% recovered thickness after a 5.0 lbf (22.2 N) loading, or greater than 80%). The use of a binder having a monomeric polyol with the finer fibers is believed to contribute to the enhanced compressive strength and resiliency of the NGFG insulation product. Additionally, this recovery performance extends to hot/humid conditions, such as encountered when the product is stored or placed somewhere hot and moist (e.g., a truck during transportation, an unconditioned building in the Summer, etc.), which allows the inventive insulation product to achieve even better long-term performance.

In addition, the script was used to run a second trial of the tests on 10 samples of a first conventional R22 fiberglass insulation product (labeled “C1”), 10 samples of a second conventional R22 fiberglass insulation product (labeled “C2”), and 10 samples of an inventive R22 fiberglass insulation product (labeled “NGFG”). The C1 sample and the C2 sample were different fiberglass insulation products than the Control conventional fiberglass insulation product of the first trial. Each of the samples were 15.24 cm wide×15.24 cm long (6-inch wide×6-inch long) specimens taken from larger insulation products. Each of the samples had approximately the same initial thickness. More specifically, the C1 samples were measured to have an initial (unpackaged) thickness of 16.0 cm (6.3 inches), the C2 samples were measured to have an initial (unpackaged) thickness of 14.5 cm (5.7 inches), and the NGFG samples were measured to have an initial (unpackaged) thickness of 15.5 cm (6.1 inches). Each of the C1 samples included fibers having an average diameter of about 5.41 μm (21.3 HT) and a binder lacking a monomeric polyol, each of the C2 samples includes fibers having an average diameter of about 5.08 μm (20 HT) and a binder lacking a monomeric polyol, and each of the NGFG samples included fibers having an average diameter of 3.68 μm (14.5 HT) and a binder including a monomeric polyol. The C1 samples had a density of 17.14 kg/m3 (1.07 pcf), the C2 samples had a density of 15.70 kg/m3 (0.98 pcf), and the NGFG samples had a density of 13.94 kg/m3 (0.87 pcf). Furthermore, the C1 samples had an LOI of 4.1%, the C2 samples had an LOI of 3.6% and the NGFG samples had an LOI of 3.8%.

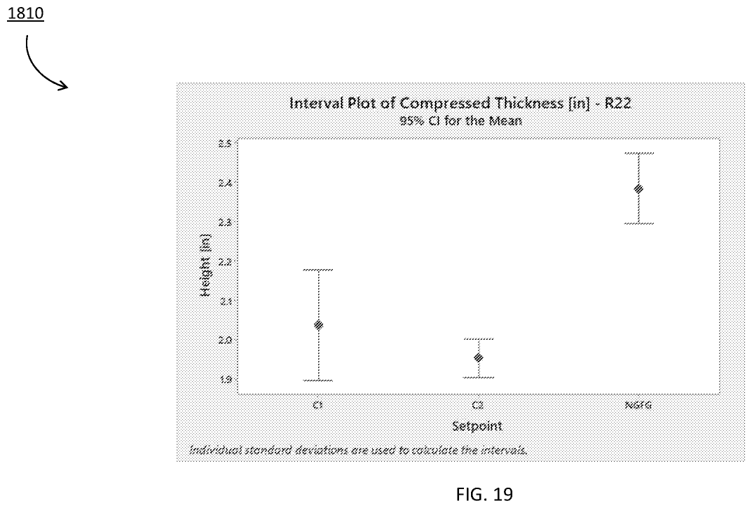

As shown in the graph 1810 of FIG. 19, the NGFG insulation product does not initially compress as far as either the C1 sample or the C2 sample, under the same load (i.e., 5 pounds). Thus, the NGFG insulation product has a greater resistance to compression than the control insulation product.

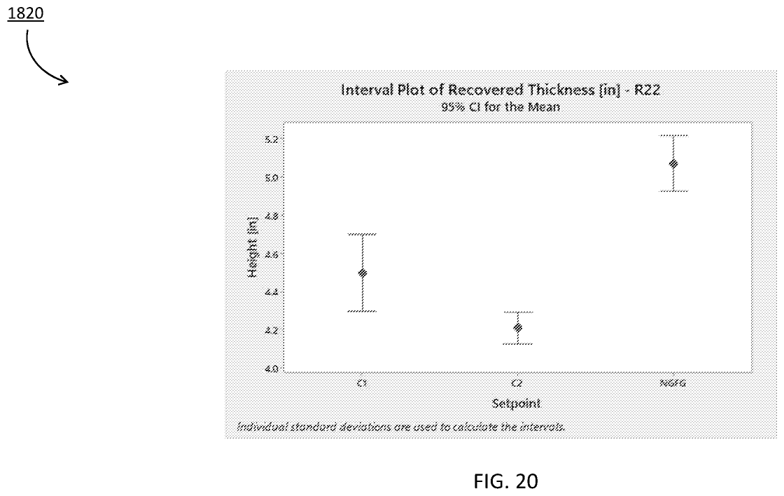

Furthermore, as shown in the graph 1820 of FIG. 20, the NGFG insulation product recovers more (i.e., to a greater thickness) when the load is removed. Thus, the NGFG insulation product has a greater compression recovery than either the C1 or the C2 insulation product.

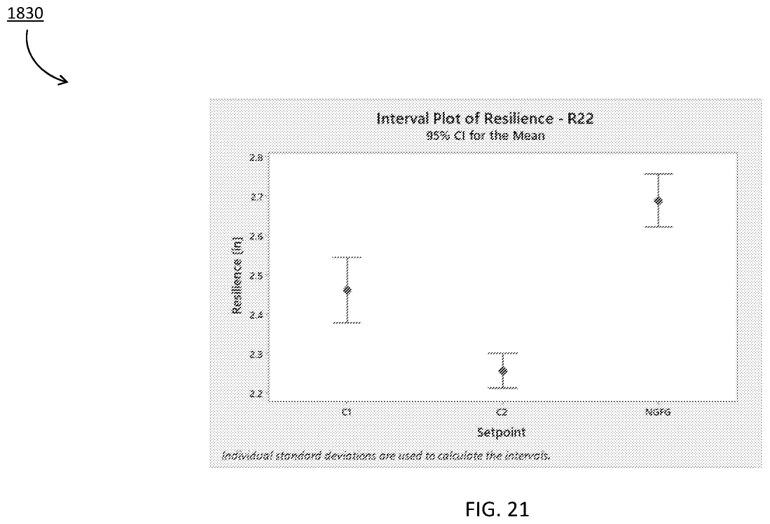

As shown in the graph 1830 of FIG. 21, the difference between the loaded and recovered thickness is higher with the NGFG insulation product than the either the C1 or the C2 sample, demonstrating that the NGFG product has a higher recovery capability.

Thus, notwithstanding that the inventive insulation product (i.e., the NGFG insulation product) is made of finer fibers, has less or approximately the same binder loading, and may have a lower ratio of fibers oriented in a direction perpendicular to the major faces of the insulation product than the conventional insulation product (i.e., the control insulation product), the inventive insulation product surprisingly exhibits superior compression resistance (e.g., the thickness of the fibrous insulation product changes by less than 65% in response to application of 5.0 lbf (22.2 N) on the fibrous insulation product, or less than 62%) and recovery (e.g., greater than 75% recovered thickness after a 5.0 lbf (22.2 N) loading, or greater than 80%). The use of a binder having a monomeric polyol with the finer fibers is believed to contribute to the enhanced compressive strength and resiliency of the NGFG insulation product. Additionally, this recovery performance extends to hot/humid conditions, such as encountered when the product is stored or placed somewhere hot and moist (e.g., a truck during transportation, an unconditioned building in the Summer, etc.), which allows the inventive insulation product to achieve even better long-term performance.

### Package Expansion and Package Expansion Rate

The inventive insulation products (i.e., the packaged NGFG batts) are believed to have an improved stiffness owing, at least in part, to the use of a binder containing a monomeric polyol, the processing/curing of which leads to stronger cross-linking in the fiber matrix. In general, the binder adds strength to the insulation products by being located at the junctions between fibers and, upon curing, binding those two fibers together, solidifying the overall fibrous matrix. Because there are more overall fibers (for the same volume of material), there will likely be more fiber-to-fiber junctions, thereby increasing the overall strength of the insulation products.

Based on the trials described herein, and the resulting data, it was found that application of a stronger binder to finer (more resilient) fibers resulted in an improved insulation product. In other words, the binder improves the stiffness enough to account for (i.e., offset) the lower stiffness expected from using finer fibers.

As noted above, the inventive insulation product exhibits superior compression resistance and recovery. This improved performance can also be measured by examining how the insulation product behaves as it transitions from a packaged state to an unpackaged state. By way of background, multiple (e.g., 10) fibrous insulation batts are typically compressed (i.e., compacted at a high pressure) to fit into relatively small packages (e.g., bags) that make it easier to handle, store, and transport the insulation products.

It was found that when fiberglass batts are released from a bag, the finer fiber material was able to “recover” and be more similar to the original (manufactured) product as compared to the larger fiber material, at least in part because the finer fibers were more resistant to breaking during compression. As described below, the inventive insulation product not only achieved improved recovery when unpackaged, the recovery unexpectedly occurred at an increased rate.

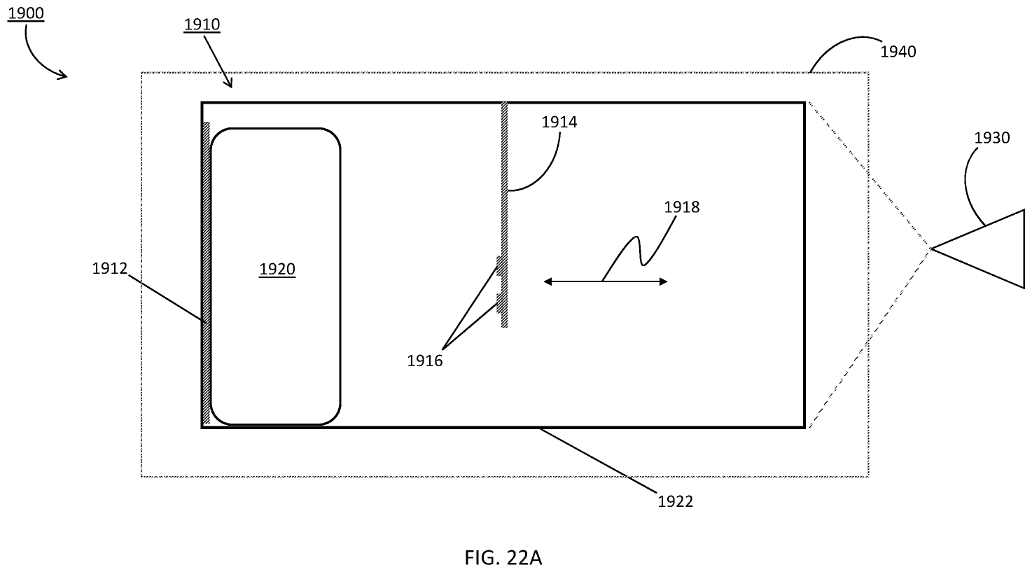

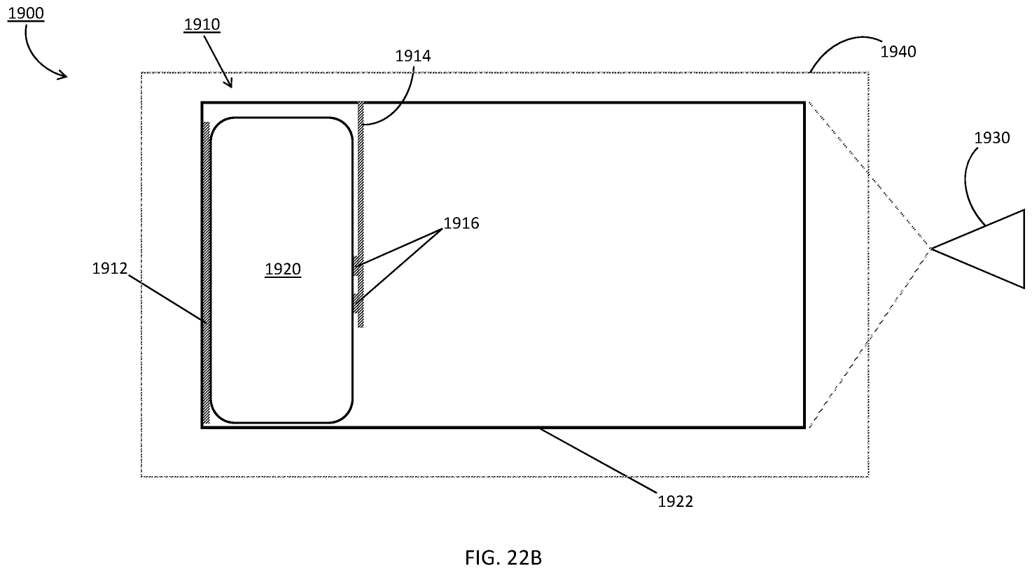

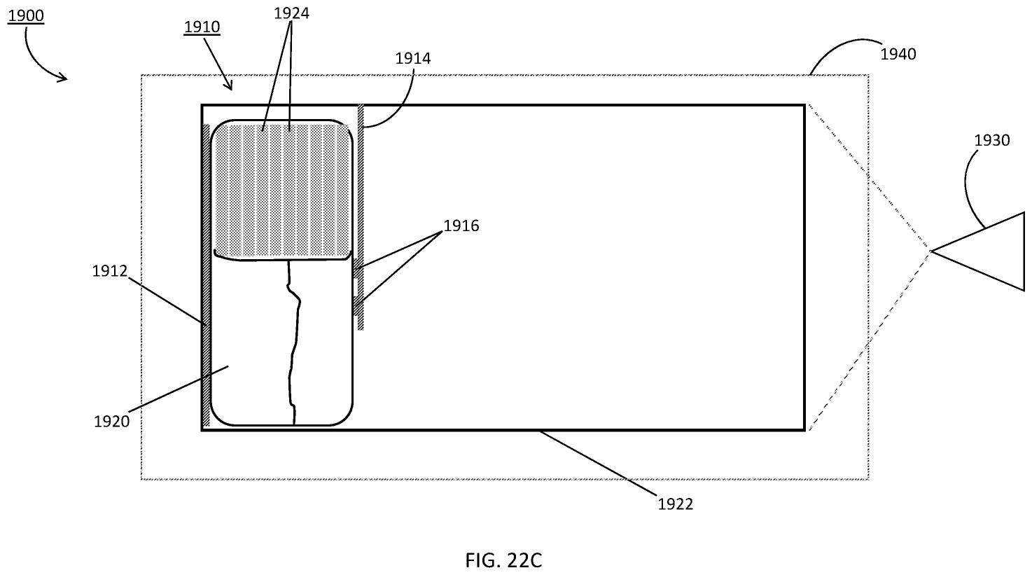

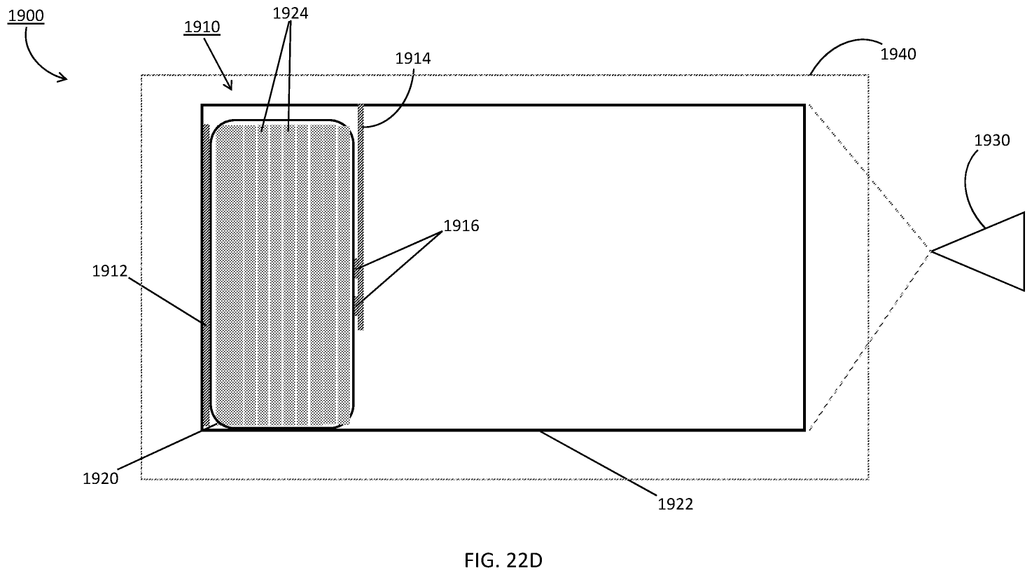

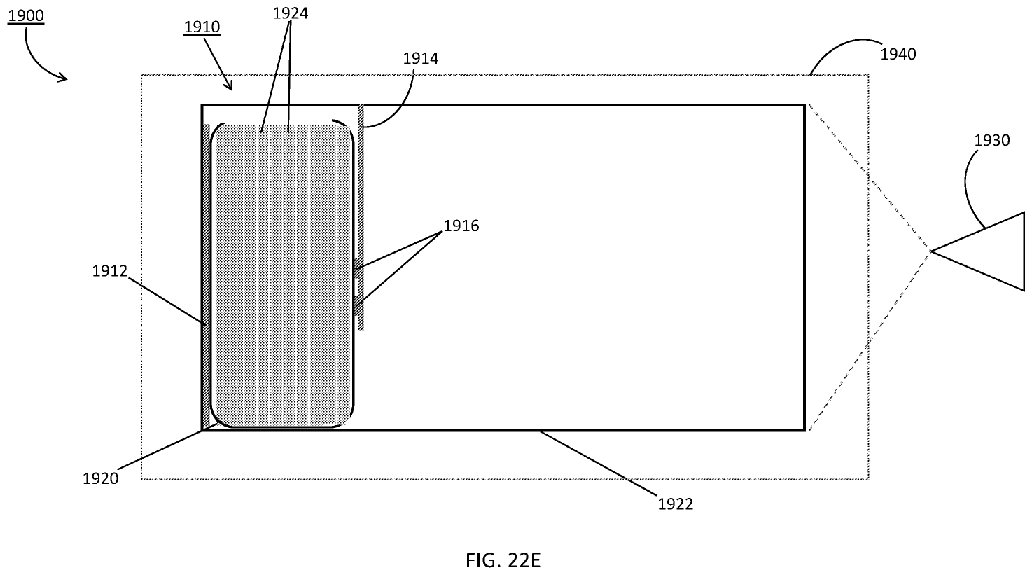

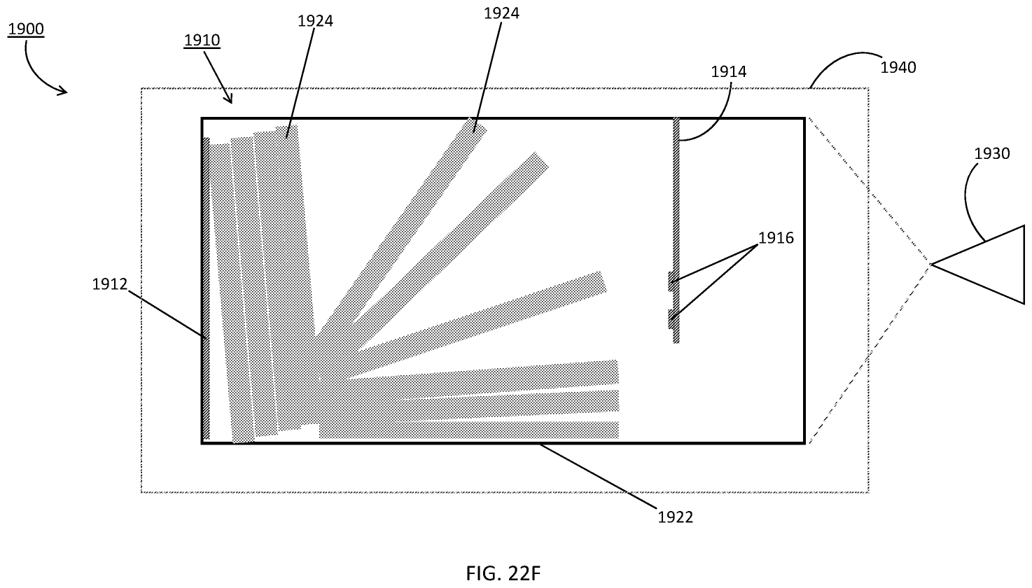

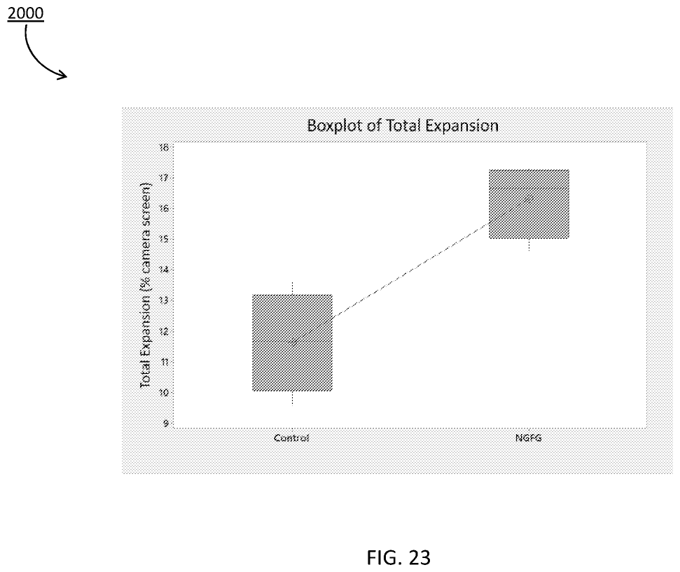

A testing system 1900, as shown in FIGS. 22A-22F, was designed to measure product expansion and product expansion rate in order to quantify this performance property consistently and accurately.

The testing system 1900 includes a frame 1910 constructed from T-slot aluminum framing. The frame 1910 measures 152.4 cm wide×182.9 cm long×76.2 cm tall (60 inches wide×72 inches long×30 inches tall). A 61.0 cm×76.2 cm (24-inch×60-inch) piece of plywood was positioned in the frame 1910 to serve as a backstop 1912. A clamp 1914 located at the top of the frame 1910 holds a pair of 72-inch compression bars 1916. The clamp 1914 is movable within the frame 1910 as shown by the arrow 1918, such that the compression bars 1916 can be moved toward and away from the backstop 1912. In this manner, a package in the form of a bag 1920 of insulation material can rest on a bottom surface 1922 of the frame 1910 and be held in place between the backstop 1912 and the compression bars 1916 (see FIG. 22B).

More specifically, the enclosed ends of the bag 1920 are cut off and the compression bars 1916 are moved into place against a front side of the bag 1920 and clamped in place (see FIG. 22C showing the ends of the bag 1920 partially removed; and FIG. 22D showing the ends of the bag 1920 fully removed). A USB camera 1930 is placed 80 inches from the frame 1910, centered along the side thereof, providing a picture (i.e., field of view) of the volume of the frame 1910 containing the bag 1920. A tarp 1940 was hung behind the frame 1910 to act as a “green” screen to facilitate collection of image data by the camera 1930.

Next, the bag 1920 was sliced open on the top with the compression bars 1916 in place (see FIG. 22E), while the camera 1930 takes an initial picture in the form of a digital image. With the camera 1930 taking pictures at a relatively rapid rate (e.g., ˜25-30 per second), the clamp 1914 is released and the compression bars 1916 pulled away simultaneously in a direction away from the backstop 1912. This allows the insulation material 1924 in the bag 1920 the freedom to naturally expand within the frame 1910 away from the backstop 1912.

Once the insulation material 1924 stops expanding (e.g., after approximately 7 seconds), the camera 1930 is stopped and a final picture is taken (see FIG. 22F). The image data corresponding to the final picture is subtracted from the image data corresponding to the initial picture to create a black-and-white image of the difference between the two pictures. A percentage of the white pixels in the black-and-white image is calculated and used to quantify the expansion of the insulation material 1924. While other portions of the testing system 1900 (e.g., the frame 1910) are recorded in the image data, these portions do not impact the assessment, as they are static from specimen to specimen.

Once the insulation stops expanding (˜7 seconds), the camera is stopped and a final image is taken. This image is subtracted from the original, and a black & white image of the difference between the two is created. A percentage of the white pixels is then calculated to quantify the expansion rate. It should be noted that testing structure, such as the frame 1910 and a trigger rope, are also recorded as part of the difference, but it is the same for every specimen.

Because the camera 1930 is taking pictures while the insulation material 1924 is expanding, this percentage is calculated for every frame and a table of percent change by time is created, as shown in Table 5.

TABLE 5

| Time (s) | % Change |
|---|---|
| 0 | 2.225911 |
| 0.083008 | 5.845052 |
| 0.143838 | 5.570964 |
| 0.179855 | 5.765625 |
| 0.212045 | 5.810872 |
| . . . | . . . |
| 7.464561 | 14.62858 |
| 7.498969 | 14.58431 |

Using this data, total expansion of the bag 1920 of insulation material 1924 could be calculated, along with the rate of said expansion (%/time). Other calculated parameters could include the maximum expansion rate between consecutive pictures taken by the camera 1930 and the maximum expansion rate seen over a 0.25 second period. Of course, still other parameters could also be calculated from this (or a similar) collection of data.

The testing system 1900 was used to run a first trial of the tests on 4 samples of a conventional R22 fiberglass insulation product (labeled “Control”) and 4 samples of an inventive R22 fiberglass insulation product (labeled “NGFG”). Each sample was a bag containing 10 batts under compression. As all of the samples were packaged by the same machinery, the same materials and parameters (e.g., packaging pressure) were used. Each of the control bags measured 121.9 cm×40.6 cm×38.1 cm (48 inches×16 inches×15 inches) with an average weight of 9.13 kg (20.13 lbs.). Each of the NGFG bags measured 121.9 cm×40.6 cm×38.1 cm (48 inches×16 inches×15 inches) with an average weight of 8.62 kg (19.00 lbs.). The batts in the control samples included fibers having an average diameter of about 4.06 m (16 HT) and a binder lacking a monomeric polyol, while each of the batts in the NGFG samples included fibers having an average diameter of 3.65 μm (14.4 HT) and a binder including a monomeric polyol. The control samples had a density of 12.33 kg/m3 (0.77 pcf), while the NGFG samples had a density of 12.01 kg/m3 (0.75 pcf). Furthermore, the control samples had a higher binder loading than the NGFG samples. Typically, the control samples represent an insulation product having a binder loading in the range of 4% to 7% (measured loss-on-ignition, LOI), while the NGFG samples represent an insulation product having a lower (e.g., 10% or more) binder loading in the range of 3.6% to 6.3% LOI. For purposes of the tests, the control samples had an LOI of 4.3%, while the NGFG samples had an LOI of 3.7%.

As shown in the graph 2000 of FIG. 23, the NGFG insulation product exhibited a greater amount (%) of total expansion compared to the control sample. For example, the NGFG insulation product achieved a total expansion greater than 14%, or greater than 15%, or greater than 16% (as measured by the image processing technique described above), as the batts transitioned from a compressed state in the bag to an uncompressed/unpackaged state.

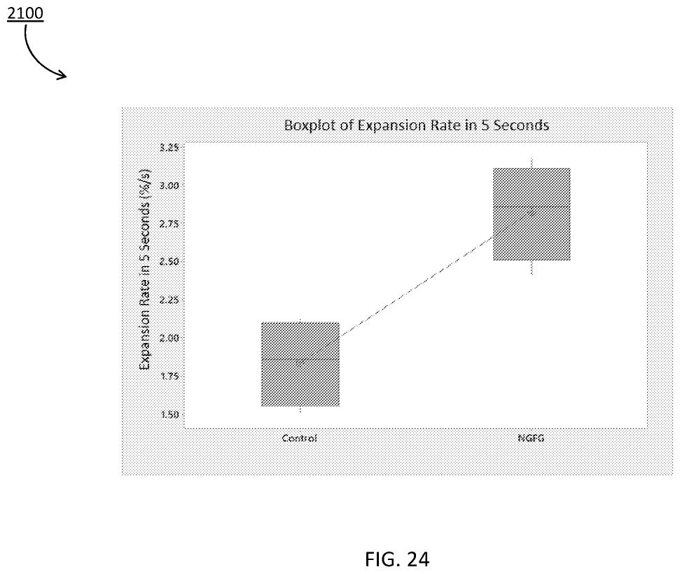

Furthermore, as shown in the graph 2100 of FIG. 24, the NGFG insulation product exhibited an increased rate of expansion (%/s) compared to the control sample. For example, the NGFG insulation product achieved a rate of expansion greater than 2.25% per second, or greater than 2.50% per second (as measured by the image processing technique described above), as the batts transitioned from a compressed state in the bag to an uncompressed/unpackaged state.

Thus, notwithstanding that the inventive insulation product (i.e., the NGFG insulation product) is made of finer fibers, has less (e.g., 5-15 lower wt. %) glass, has less (e.g., 10% or more less LOI) binder, and may have a lower ratio of fibers oriented in a direction perpendicular to the major faces of the insulation product than the conventional insulation product (i.e., the control insulation product), the inventive insulation product surprisingly exhibits superior compression resistance and recovery. The use of a binder having a monomeric polyol with the finer fibers is believed to contribute to the enhanced compressive strength and resiliency of the NGFG insulation product. Additionally, this recovery performance extends to hot/humid conditions, such as those encountered when the product is stored or placed somewhere hot and moist (e.g., a truck during transportation, an unconditioned building in the Summer, etc.), which allows the inventive insulation product to achieve even better long-term performance.

The testing system 1900 was also used to run a second trial of the tests on 3 samples of a first conventional R22 fiberglass insulation product (labeled “C1”), 3 samples of a second conventional R22 fiberglass insulation product (labeled “C2”), and 3 samples of an inventive R22 fiberglass insulation product (labeled “NGFG”). The C1 sample and the C2 sample were different fiberglass insulation products than the Control conventional fiberglass insulation product of the first trial. The C1 bags contained 10 batts under compression that measured 141.0 cm×39.4 cm×40.4 cm (55.5 inches×15.5 inches×15.9 inches) and a weight of 12.3 kg (27.2 lbs.), the C2 bags contained 10 batts under compression that measured 121.7 cm×38.9 cm×41.7 cm (47.9 inches×15.3 inches×16.4 inches) and a weight of 10.7 kg (23.5 lb.), and the NGFG bag containing 10 batts under compression that measured 140.2 cm×38.9 cm×37.3 cm (55.2 inches×15.3 inches×14.7 inches) and a weight of 9.1 kg (20.1 lbs.).

The batts of the C1 samples included fibers having an average diameter of about 5.51 μm (21.3 HT) and the batts of the C2 samples included fibers having an average diameter of about 5.08 μm (20 HT). The batts of the NGFG samples included fibers having an average diameter of 3.68 μm (14.5 HT) and a binder including a monomeric polyol. The C1 samples had a density of 17.14 kg/m3 (1.07 pcf), the C2 samples had a density of 15.70 kg/m3 (0.98 pcf), and the NGFG samples had a density of 13.94 kg/m3 (0.87 pcf). Furthermore, the C1 samples had an LOI of 4.1%, the C2 samples had an LOI of 3.6% and the NGFG samples had an LOI of 3.8%.

For the second trial, the rate of expansion (%/s) was calculated using a summation technique. In particular, instead of subtracting the image data corresponding to the final picture from the image data corresponding to the initial picture and calculating a difference, for the summation technique, the image analysis software calculates a percentage of white space in a specific image and calculates a difference in the percentage of white space versus the preceding image for all the images captured in the five second time period from when the package is open. Each of the differences in percentage of white space is then added to determine the final expansion rate. Specifically, the software calculates the percentage white space (X₁) in the first image captured after the package is opened and compares that percentage white space (X₁) to the percentage white space (X₀) of an initial image just prior to the package opening. The software then calculates the percentage white space (X₂) in the second image captured after the package is opened and compares that percentage white space (X₂) to the percentage white space (X₁) of the first image and so forth for all of the images captured during the five second period.

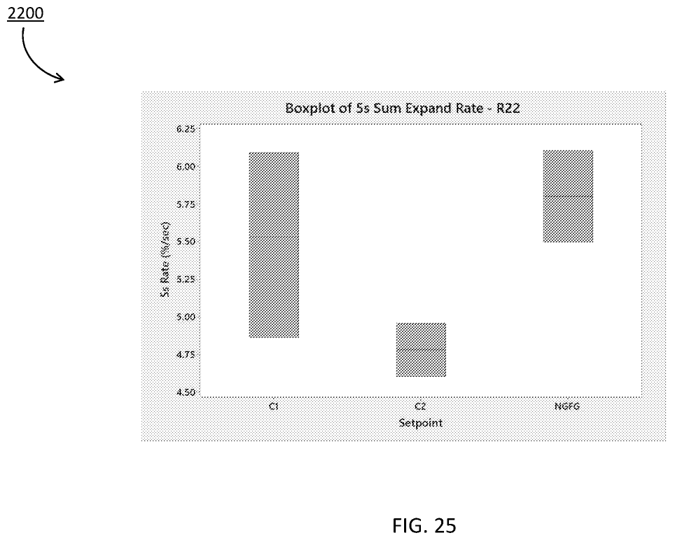

As shown in the graph 2200 of FIG. 25, the NGFG insulation product exhibited an increased summation rate of expansion (%/s) compared to the both the C1 and the C2 insulation products. For example, the NGFG insulation product achieved an average summation rate of expansion (at 5 seconds) greater than 5.7% per second (as measured by the image processing technique described above), as the batts transitioned from a compressed state in the bag to an uncompressed/unpackaged state.

For the second trial, the total expansion of the insulation products is calculated as a volume-based expansion ratio. In particular, instead of using the testing system 1900 to determine total expansion, the total expansion is determined by measuring the volume of each of the batts from the bag after expansion and comparing the total volume of all of the batts versus the volume of the bag prior to opening. In particular, initial bag volume was calculated for the C1, C2, and NGFG insulation products of the second trial by taking the circumference of the bag for each of the products and multiplying it by the length of the bag. Each of the bags is measured in the same way and ensured to be consistent in circumference from top to bottom of the bag.

To determine final product volume, each of the bags was opened as described above regarding the testing system 1900 and tested to determine expansion rate. After the expansion rate testing for the product is complete, the insulation batts were moved over to a scale and measurement area. Each batt from the original bag is picked up, placed on the scale for weight information, then placed on a stationary and calibrated table with measurement metrics to get width and length information. Each of the batts were left as untouched as possible, careful not to energize or compress the material and also careful to handle each batt in the same way. Once all batts have been weighted and measure for length and width, the product recovery is taken per ASTM C167, the standard for measuring thickness recovery, with the only deviation being that the products were not energized by dropping each batt on each side, followed by a 5-minute wait period. The final volume of each batt is then calculated from the length, width, and thickness. Total expansion for each sample is then expressed as an expansion ratio of the final product volume (i.e., summation of the measured final volume of all of the batts) divided by the initial bag volume.

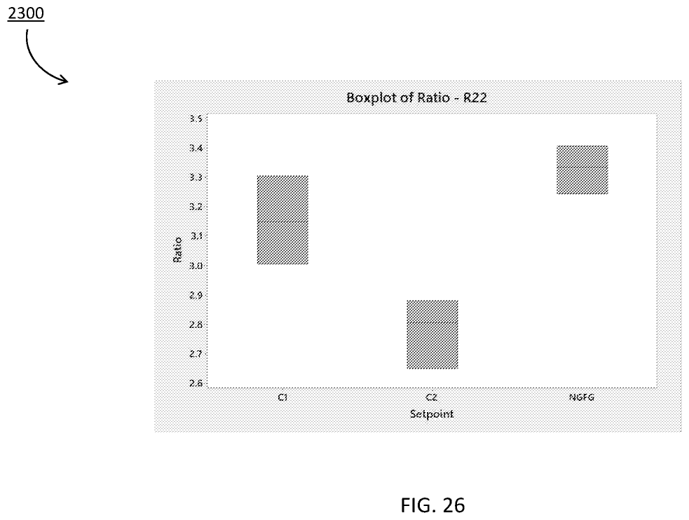

As shown in the graph 2300 of FIG. 26, the NGFG insulation product exhibited a greater expansion ratio as compared to the C1 and the C2 insulation products. For example, the NGFG insulation product achieved a total expansion ratio greater than 3.0, or greater than 3.2.

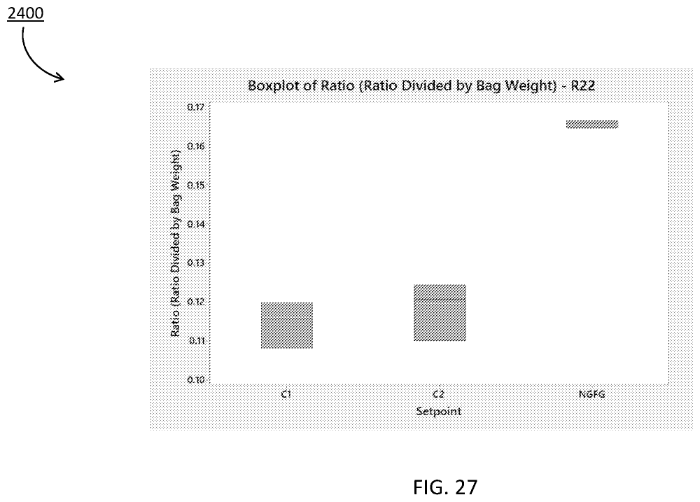

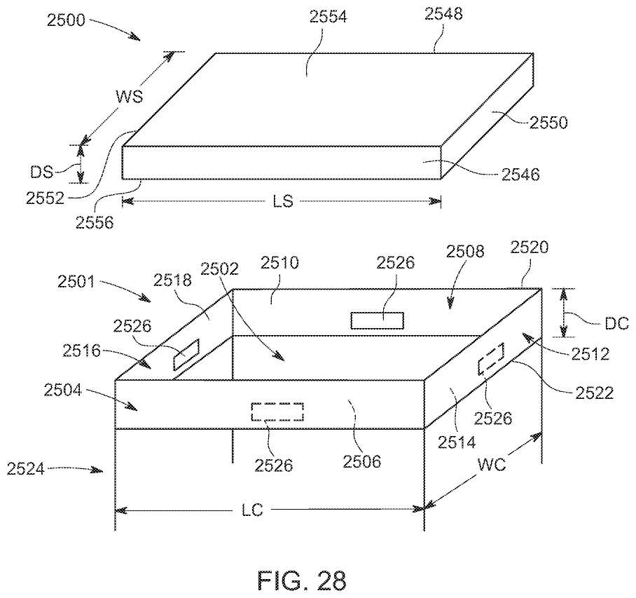

Furthermore, as shown in the graph 2400 of FIG. 27, when taking into account the bag weight for the C1, C2, and NGFG insulation products, the NGFG insulation product exhibited a greater expansion ratio by weight as compared to the C1 and the C2 insulation products. For example, the NGFG insulation product achieved a total expansion ratio by weight greater than 0.13, or greater than 0.14, or greater than 0.15, or greater than 0.16.

Thus, notwithstanding that the inventive insulation product (i.e., the NGFG insulation product) is made of finer fibers, has less or approximately the same binder loading, and may have a lower ratio of fibers oriented in a direction perpendicular to the major faces of the insulation product than the conventional insulation products (i.e., the C1 and C2 insulation products), the inventive insulation product surprisingly exhibits superior summation expansion rate (e.g., average summation rate of expansion (at 5 seconds) greater than 5.7% per second (as measured by the image processing technique described above)), superior expansion ratio (greater than 3.0, or greater than 3.2), and superior expansion ratio by weight (e.g., greater than 0.13, or greater than 0.14, or greater than 0.15, or greater than 0.16). The use of a binder having a monomeric polyol with the finer fibers is believed to contribute to the enhanced expansion performance. Additionally, this expansion performance extends to hot/humid conditions, such as encountered when the product is stored or placed somewhere hot and moist (e.g., a truck during transportation, an unconditioned building in the Summer, etc.), which allows the inventive insulation product to achieve even better long-term performance.

### Cavity Retention

In an exemplary embodiment, the fibrous insulation product 100 may be formed as a residential insulation product, such as an insulation batt, that has properties, such as recovery, stiffness, handling, cavity retention, etc., which are suitable for use as residential insulation. One such property, cavity retention. refers to the ability of the fibrous insulation layer 102, or the fibrous insulation product 100, to remain within a building cavity after being placed within the cavity. For example, one typical residential insulation product produced is an insulation batt or blanket, which is suitable for use as wall, ceiling, or floor insulation in residential dwellings. Fiberglass insulation batts are sized to fit within the cavity between, for example, ceiling joists/rafters/trusses or wall frame members. Some batts may include a facing that provides an effective way to hold the insulation in place. Unfaced batts, however, can also be used, and utilize the interface between the batt and the frame members to hold the batt in the cavity.

The ability of a fiberglass insulation batt to remain in the cavity can be influenced by a number of factors. For example, the stiffness of the insulation batt can influence cavity retention. A less stiff, more flexible product sags more when in a cavity than a stiffer product. Increased sagging decreases the force the product applies against the frame members forming the cavity. Stiffness can be influenced by, for example, the binder chemistry and loading, the product density, and the fiber diameter of the product. As fiber diameter decreases, the fibers become more flexible, which negatively impacts stiffness. Thus, producing a residential insulation product using fibers with a diameter that is smaller than the diameter of the glass fiber used in conventional residential fiberglass insulation products requires consideration of the impact on cavity retention.

The fibrous insulation products, according to the general inventive concepts disclosed and suggested herein, are believed to exhibit superior to comparable cavity retention as compared to conventional residential fiberglass insulation products. This results in a product that can utilize the thermal benefits of reduced diameter fibers while still being suitable for use as wall, ceiling, or floor insulation in residential dwellings.

Three cavity retention tests were designed to quantify cavity retention performance consistently and accurately. The first test (Test A) measures the normal force (i.e., the force perpendicular to the inner faces of the frame members), referred to as the average normal force, that an insulation sample 2500 exerts on the frame members defining a ceiling test cavity. The second test (Test B) measures the force, referred to as the maximum failure force (ceiling), that is required to push the installed insulation test sample 2500 downward out of the ceiling cavity. The third test (Test C) measure the force, referred to as the maximum failure force (wall), required to push an installed insulation sample 2500 downward a set distance in a wall cavity.

A ceiling cavity test system 2501, as shown in FIG. 28, was designed to perform the first test (Test A) and second test (Test B). The system 2501 includes a cavity 2502 configured to mimic a standard building ceiling or wall cavity formed between adjacent ceiling joists/rafters/trusses or wall frame members of a building. The cavity 2502 is formed with standard wooden 5.1 cm×25.4 cm (2 inches by 10 inches) frame members cut to length and fastened together to form the cavity 2502. In particular, the cavity 2502 is defined by a first frame member 2504 having a planar first inner face 2506, a second frame member 2508 having a planar second inner face 2510 spaced apart from and parallel to the first inner face 2506, a third frame member 2512 having a planar third inner face 2514 extending perpendicular between the first inner face 2506 and the second inner face 2510, and a fourth frame member 2516 having a fourth inner face 2518 spaced apart from and parallel to the third inner face 2514 and extending perpendicular between the first inner face 2506 and the second inner face 2510. The cavity 2502 is shaped as a cuboid having a length LC of 119.4 cm (47 inches) (i.e., the distance between the third inner face 2514 and the fourth inner face 2518), a width WC of 57.2 cm (22.5 inches) (i.e., the distance between the first inner face 2506 and the second inner face 2510) and a depth DC of 25.4 cm (10 inches) (i.e., the distance between an upper edge 2520 of the frame members and a lower edge 2522 of the frame members).

The frame members 2504, 2508, 2512, 2516 are supported above the ground by a support fixture 2524 such that the frame members 2504, 2508, 2512, 2516 are arranged horizontally in the length and width direction and the inner faces 2506, 2510, 2514, 2518 are arranged vertically. The support fixture 2524 also allows the cavity 2502 to be accessed from below.

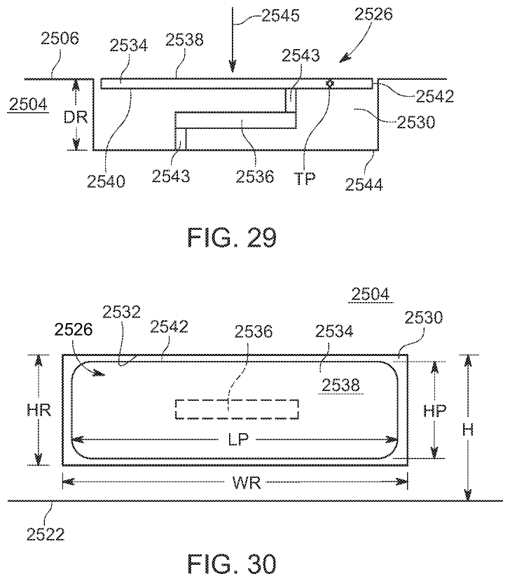

Each of the frame members 2504, 2508, 2512, 2516 includes a force sensing arrangement 2526 positioned in the respective inner faces 2506, 2510, 2514, 2518 that is configured to measure a force normal to each of the inner faces 2506, 2510, 2514, 2518. Referring to FIG. 29, the force sensing arrangement 2526 in the first inner face 2506 is illustrated. Identical force sensing arrangements 2526 are associated with the second, the third, and the fourth inner faces 2510, 2514, 2518; thus, the description of the force sensing arrangement 2526 in the first inner face 2506 applies equally to the force sensing arrangements in the second, the third, and the fourth inner faces 2510, 2514, 2518.

As shown in FIGS. 29-30, a rectangular recess 2530 is formed in the first inner face 2506. An upper edge 2532 of the recess 2530 is positioned a distance D of 6.99 cm (2.75 inches) from the bottom edge 2526 of the first frame member 2504. The recess 2530 has a width WR of 17.8 cm (7 inches), a height HR of 5.1 cm (2 inches) and a depth DR of 1.91 cm (0.75 inches). The force sensing arrangement 2526 includes a rectangular plate 2534 for the insulation batt to contact and apply a force to and a load cell 2536 attached to the plate 2534 for measuring the force applied to the plate 2534. The plate 2534 has a planar first face 2538, a planar second face 2540 opposite and parallel to the first face 2538, and an outer edge 2542 extending around the perimeter of the plate 2534 between the first face 2538 and the second face 2540. The plate 2534 is centered within the recess 2530 such that there is a gap between the outer edge 2542 and the first frame member 2504 surrounding the plate 2534. The plate 2534 is positioned such that the first face 2538 is coplanar (i.e., flush) with the first inner face 2506. The plate 2534 is acrylic having a length LP of 16.5 cm (6.5 inches), and width WP of 3.8 cm (1.5 inches), and a thickness TP of 0.64 cm (0.25 inches).

The load cell 2536 is mounted via linkages/fasteners 2543 between an inner surface 2544 of the recess 2530 and the planar second face 2540 of the plate 2534. The load cell 2536 is mounted, configured, and calibrated to accurately detect the amount of force being applied normal to the planar first face 2538 of the plate 2534, as shown by the arrow 2545 in FIG. 30.

The insulation test sample 2500 includes a first side surface 2546, a second side surface 2548 spaced apart from and opposite the first side surface 2546, a third side surface 2550 extending between the first side surface 2546 and the second side surface 2548, and a fourth side surface 2552 spaced apart from and opposite the third side surface 2550 and extending between the first side surface 2546 and the second side surface 2548. The fibrous insulation product 100 also includes a first face 2554 connecting the side surfaces 2546, 2548, 2550, 2552 and a second face 2556 parallel to, or generally parallel to, and opposite the first face 2554 and connecting the side surfaces 2546, 2548, 2550, 2552. The dimensions of each insulation test sample 2500 are controlled for consistency. In particular, for Test A and Test B, the insulation test sample 2500, when uncompressed, has a length LS of 119 cm (47 inches), a width WS of 58 cm (23 inches), and a thickness TS of 15 cm (6 inches).

The insulation test sample 2500 is non-faced (i.e., does not include a facing such as the facing 104 of the insulation layer 102). Thus, a facing does not contribute to the test results. The temperature and humidity during testing are monitored with the suggested test conditions being 73±4° F. (23±2° C.) and 40±10% relative humidity and the test samples are allowed to acclimate to the environmental conditions of the test rig for at least twenty-four (24) hours.

To perform Test A and Test B, the insulation test sample 2500 is installed into the cavity 2502 from the bottom so that the second face 2556 of the test sample 2500 is flush with the bottom edge 2522 of the dimensional lumber forming the cavity 2502. Thus, when installed in the cavity 2502, the entire first side surface 2546 is adjacent the first inner surface 2506, the entire second side surface 2548 is adjacent the second inner surface 2508, the entire third side first 2550 is adjacent the third inner surface 2514, and the entire fourth side surface 2552 is adjacent the fourth inner surface 2518.

The load cells 2536 are set-up and calibrated to measure the amount of normal force being applied to the plates 2534. A processing unit (not shown) (e.g., a touchscreen computer) is connected to the ceiling cavity test system 2501. The processing unit can be driven by software routines (e.g., scripts) that are configured to collect the data from each of the load cells 2536.

After the Test A completes, Test B is performed. To perform Test B, a rigid foam board (not shown) is placed on the top face 2554 of the installed insulation test sample 2500 and centered. A center point on the rigid foam board (not shown) is marked. Then, using a calibrated force gage, a downward force is applied to the center-point of the rigid foam (not shown) until the insulation test sample 2500 is pushed downward out of the cavity 2502. The maximum force recorded by the force gage is considered the maximum failure force for Test B.

Test A and Test B are repeated two more times. For Test A, the three force measurements (from the three tests) for each of the four load cells 2536 are averaged. Then, the average reading of each of the load cells 2536 are summed and recorded as the average normal force test result. For test B, the three maximum force measurements (from the three tests) are averaged and recorded as the maximum failure force (ceiling).

The ceiling cavity test system 2501 was used to test two different insulation types, Insulation 0 (“zero”) and Insulation 3 (“three”). Table 6, below, lists Test A and Test B results on Insulation 0 (“zero”) and Insulation 3 (“three”), with 10 samples tested for each insulation type. Insulation 0 is a commercially available insulation having an average R-value of 22.2, an average density of 12.98 kg/m3 (0.81 pcf), an average stiffness of 29.4, a measured fiber diameter of approximately 4.06 m (16 μHT) and formed with a first binder (binder A) lacking a monomeric polyol with a binder loading of 4.3% LOI. Insulation 3 is an inventive fiberglass insulation product according to the present disclosure having an average R-value of 22.4, an average density of 12.81 kg/m3 (0.80 pcf), an average stiffness of 12, a measured fiber diameter of approximately 3.65 μm (14.4 HT), and formed with a second binder (binder B) including a monomeric polyol with a binder loading of 3.7% LOI. Insulation 0 and insulation 3 were both made in the same facility within the same 12-hour period.

TABLE 6

| | Average | Density | Max Fail | Sum of Average |
|---|---|---|---|---|
| Sample | Stiffness | (pcf) | (Ceiling)(kg) | Normal Force (lbf) |
| 0-1 | 23 | 0.81 | 0 | 0 |
| 0-2 | 22 | 0.82 | 0 | 0 |
| 0-3 | 22 | 0.85 | 1.61 | 590.8 |
| 0-4 | 21 | 0.83 | 1.67 | 250.4 |
| 0-5 | 19 | 0.78 | 1.66 | 616.4 |
| 0-6 | 40 | 0.79 | 0 | 0 |
| 0-7 | 34 | 0.77 | 0 | 347.4 |
| 0-8 | 42 | 0.80 | 1.59 | 461.6 |
| 0-9 | 33 | 0.84 | 0 | 329.8 |
| 0-10 | 39 | 0.80 | 0 | 0 |
| 0 Avg | 29.43 | 0.81 | 0.65 | 259.64 |
| 3-1 | 12 | 0.79 | 3.39 | 924.8 |
| 3-2 | 10 | 0.79 | 2.91 | 1058.8 |
| 3-3 | 12 | 0.83 | 2.27 | 867.4 |
| 3-4 | 15 | 0.78 | 1.42 | 544 |
| 3-5 | 19 | 0.78 | 2.56 | 798 |
| 3-6 | 9 | 0.80 | 2.62 | 879.6 |
| 3-7 | 9 | 0.80 | 2.27 | 929.4 |
| 3-8 | 14 | 0.83 | 3.18 | 1355 |
| 3-9 | 8 | 0.81 | 2.86 | 1236.8 |
| 3-10 | 10 | 0.78 | 2.63 | 469.2 |
| 3 Avg | 11.50 | 0.80 | 2.61 | 906.30 |

As shown in Table 6, the four of the insulation 0 samples (0-1, 0-2, 0-6, and 0-10) would not stay in the cavity 2502 and fell out when released by the installer. As a result, those four insulation 0 samples produced a zero average normal force and a zero maximum failure force. In addition, two other insulation 0 samples (0-7 and 0-9) stayed in the cavity such that an average normal force value was recorded but fell out of the cavity when the slightest of downward force was placed on the samples during test B such that a zero maximum failure force (ceiling) was recorded. Conversely, all the insulation 3 samples produced non-zero reading for both average normal force and maximum failure force.

All testing methods have variability associated with them. As shown in Table 6, for Tests A and B there was some overlap in the test result data sets for the insulation 0 samples and the insulation 3 samples. To get a true indication of the performance of the two insulation types, enough tests need to be run on each insulation type to account for test variability. As indicated above, ten samples were tested for each insulation type and each sample was tested three times for a total of thirty (30) test results for each insulation type. The data sets were then analyzed in aggregate, as opposed to individual test results or individual sample results.

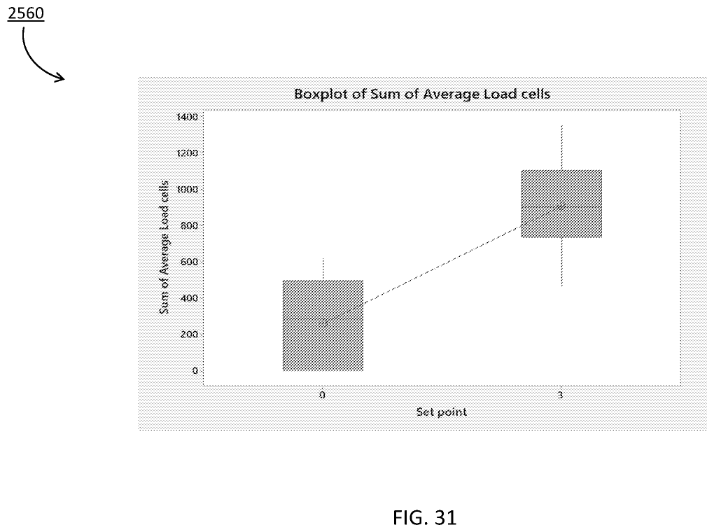

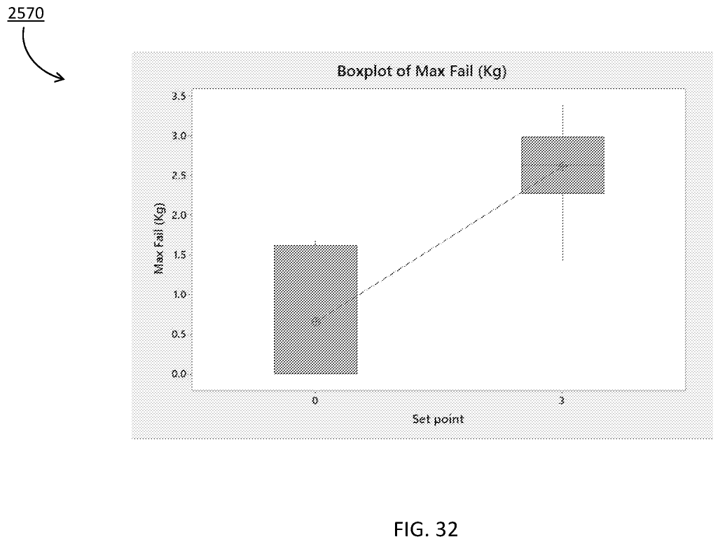

As shown in the box plot 2560 of FIG. 31, the insulation 3 product exhibited a statistically greater average normal force (lbf) as compared to insulation 0 insulation product. For example, the insulation 3 product achieved average normal force of 850 lbf (3781 N) or greater. Furthermore, as shown in the box plot 2570 of FIG. 32, insulation 3 showed a statistical greater maximum failure force (ceiling) (kg) as compared to insulation 0. For example, the insulation 3 product achieved maximum failure force (ceiling) (kg) of 2 kg or greater, or 2.5 kg or greater. Without being bound by theory, it is believed that the application of a strong binder to finer (more resilient) fibers resulted in improved performance in both test A and test B. The binder improves the stiffness enough to account for (i.e., offset) the lower stiffness expected from using finer fibers. Stiffness it is believed has a significant impact on test results in both Test A and Test B. In addition, it is believed that fiber orientation, as described above, contributes to the test results. In particular, more fibers (or fiber vectors) aligned in a horizontal plane, or nearer a horizontal plane, relative to the test cavity (i.e., parallel to the length LC of the cavity) provide increased resistance to being pushed out of the cavity (i.e., higher maximum failure force).

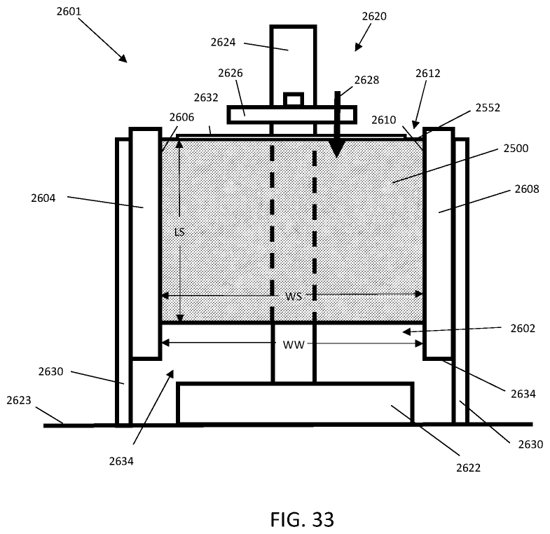

A wall cavity test system 2601, as shown in FIG. 33, was designed to perform the third test (Test C). The system 2601 includes a cavity 2602 configured to mimic a standard building wall cavity formed between adjacent vertical wood studs of a building. The cavity 2602 is defined by a first frame member 2604 having a planar first inner face 2606, a second frame member 2608 having a planar second inner face 2610 spaced apart from and parallel to the first inner face 2606. The cavity has an open upper end 2612 and an open bottom end 2614. The first and second frame members 2604, 2608 are standard wooden 5.1 cm (2 inch) by 15.2 cm (6 inch) frame members mounted vertically and spaced apart such that a width WW of the cavity 2602 between the first inner face 2606 and the second inner face 2610 is 35.6 cm (14 inches) (i.e., the frame members 2604, 2608 are 16 inches on center).

The system 2601 further includes an Instron compression testing machine 2620. The Instron compression testing machine 2620 includes a base 2622 configured to be supported on a flat surface 2623 (e.g., table top or ground), a vertical column 2624 mounted to the base 2622, and a 15.2 cm by 15.2 cm (6-inch by 6-inch) top compression plate 2626 supported by the column 2624 and movable vertically relative to the column 2624. The Instron compression testing machine 2620 is configured to move the compression plate 2626 downward toward the base 2622, as shown by arrow 2628. The Instron compression testing machine 2620 is also equipped with loading sensing equipment (not shown) to record the force the compression plate 2626 applies to an object (i.e., the insulation test sample 2500) between the compression plate 2626 and the base 2622 as the compression plate 2626 moves downward. The system 2601 further includes a support fixture 2630 configured to support the cavity 2602 above the base 2622 and under the compression plate 2626.

The dimensions of each insulation test sample 2500 are controlled for consistency. In particular, for Test C, the insulation test sample 2500, when uncompressed, has a length LS of 43.2 cm (17 inches), a width WS of 37.8 cm (14.9 inches), and a thickness (not shown) of 15.5 cm (6.1 inches). The insulation test sample 2500 is non-faced (i.e., does not include a facing such as the facing 104 of the insulation layer 102). Thus, a facing does not contribute to the test results. The temperature and humidity during testing are monitored with the suggested test conditions being 73±4° F. (23±2° C.) and 50±5% relative humidity and the test samples are allowed to acclimate to the environmental conditions of the test rig for at least twenty-four (24) hours.

To perform the Test C using the wall cavity test system 2601, the support fixture 2630 and the cavity 2602 are placed over top of the base 2622 such that the compression plate 2626 is centered between the first frame member 2604 and the second frame member 2608. The insulation test sample 2500 is placed between the first frame member 2604 and the second frame member 2608 adjacent the compression plate 2626 such that the machine direction of the insulation material is vertical. A load distributing plate 2632 is placed across the fourth side face 2552 of the installed insulation test sample 2500 to evenly distribute the force that will be applied to the insulation test sample 2500 by the compression plate 2626. In the exemplary test method, the load distributing plate 2630 is a thin 34.3 cm by 15.2 cm (13.5 inch by 6-inch) aluminum rectangle have a weight of 60 grams.

The compression plate 2626 is then moved downward toward the base 2622 at a speed of 12.7 cm/min (5 inches/min). The compression plate 2626 contacts the load distributing plate 2630 and as the compression plate 2626 continues to move downward, pushes the insulation test sample 2500 downward until the insulation test sample 2500 is moved past a bottom edge 2634 of the frame members 2604, 2608.

A processing unit (not shown) (e.g., a touchscreen computer) is connected to the wall cavity test system 2601. The processing unit can be driven by software routines (e.g., scripts) that are configured to collect the data from the load sensing equipment associated with the wall cavity test system 2601. The maximum force applied to the insulation test sample 2500 by the compression plate 2626 is recorded.

Test 3 is repeated two more times. For test 3, the three maximum force measurements (from the three tests) are averaged and recorded as the maximum failure force (wall)(kg).

The wall cavity test system 2601 was used to run a first trial on two different insulation types, Insulation 0 (“zero”) and Insulation 3 (“three”). Table 7, below, lists Test C results on the two different insulations, with 10 samples tested for each of the insulations 0 and 3. Insulation 0 is a commercially available insulation having an average R-value of 22.2, an average density of 12.98 kg/m3 (0.81 pcf), an average stiffness of 29.4, a measured fiber diameter of approximately 4.06 μm (16 HT), and formed with a first binder (binder A) lacking a monomeric polyol with a binder loading of 4.3% LOI. Insulation 3 is fibrous insulation according to the present disclosure having an average R-value of 22.4, an average density of 12.81 kg/m3 (0.80 pcf), an average stiffness of 12, a measured fiber diameter of approximately 3.65 μm (14.4 HT), and formed with a second binder (binder B) having a monomeric polyol with a binder loading of 3.7% LOI. Insulation 0 and insulation 3 were both made in the same facility within the same 12-hour period.

TABLE 7

| | Batt weight | Density | Max Fail | Max Fail Force by |
|---|---|---|---|---|
| Sample | (lbs) | (pcf) | Force (lbf) | weight (lbf/lbs) |
| 0-1 | 0.74 | 0.79 | 1.66 | 2.24 |
| 0-2 | 0.73 | 0.84 | 3.03 | 4.15 |
| 0-3 | 0.73 | 0.78 | 1.56 | 2.14 |
| 0-4 | 0.75 | 0.82 | 2.31 | 3.08 |
| 0-5 | 0.73 | 0.83 | 3.41 | 4.67 |
| 0-6 | 0.65 | 0.74 | 2.02 | 3.11 |
| 0-7 | 0.76 | 0.87 | 2.80 | 3.68 |
| 0-8 | 0.68 | 0.78 | 1.65 | 2.43 |
| 0-9 | 0.83 | 0.88 | 1.92 | 2.31 |
| 0-10 | 0.65 | 0.76 | 2.42 | 3.72 |
| 0 Avg | 0.73 | 0.81 | 2.28 | 3.15 |
| 3-1 | 0.70 | 0.71 | 3.89 | 5.56 |
| 3-2 | 0.72 | 0.76 | 4.18 | 5.81 |
| 3-3 | 0.72 | 0.81 | 3.69 | 5.13 |
| 3-4 | 0.68 | 0.80 | 2.36 | 3.47 |
| 3-5 | 0.68 | 0.74 | 2.68 | 3.94 |
| 3-6 | 0.70 | 0.83 | 3.93 | 5.61 |
| 3-7 | 0.68 | 0.77 | 3.75 | 5.51 |
| 3-8 | 0.64 | 0.82 | 1.66 | 2.59 |
| 3-9 | 0.69 | 0.77 | 2.23 | 3.23 |
| 3-10 | 0.67 | 0.81 | 1.83 | 2.73 |
| 3 Avg | 0.69 | 0.78 | 3.02 | 4.36 |

All testing methods have variability associated with them. As shown in Table 7, for Test C there was some overlap in the test result data sets for the insulation 0 samples and the insulation 3 samples. To get a true indication of the performance of the two insulation types, a sufficient number of tests need to be run on each insulation type to account for test variability. As indicated above, ten samples were tested for each insulation type and each sample was tested three times for a total of thirty (30) test results for each insulation type. The data sets were then analyzed in aggregate, as opposed to individual test results or individual sample results.

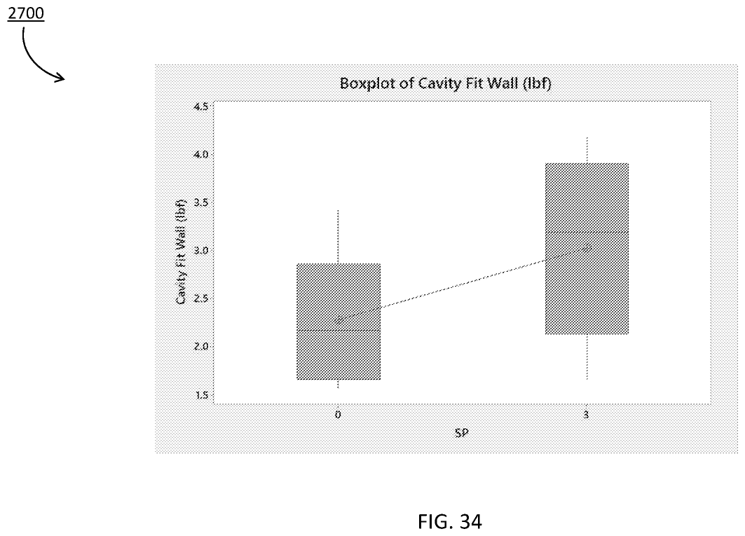

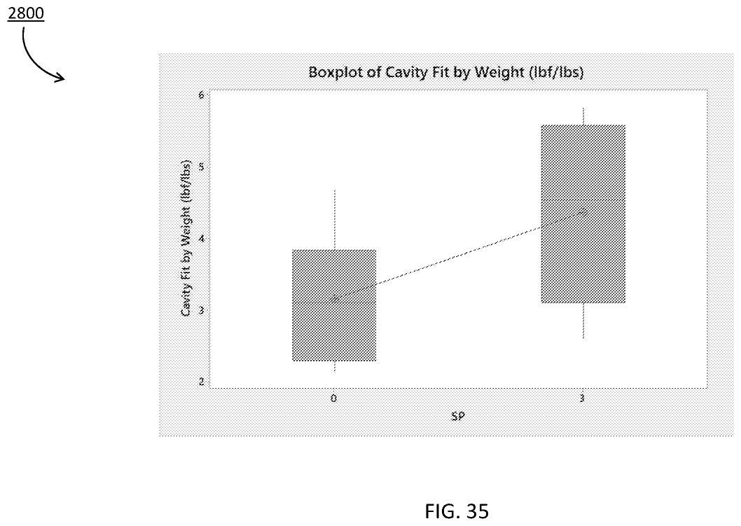

As shown in the box plot 2700 of FIG. 34, the insulation 3 product exhibited a greater average maximum failure force (lbf) as compared to insulation 0 insulation product. For example, the insulation 3 product achieved average maximum failure force of greater than 11.1 N (2.5 lbf). Furthermore, as shown in the box plot 2800 of FIG. 35, the insulation 3 product exhibited a statistically greater average maximum failure force by weight (lbf/lb.) as compared to insulation 0 insulation product. For example, the insulation 3 product achieved average maximum failure force by weight greater than 39.2 N/kg (4.0 lbf/lb.). Without being bound by theory, it is believed that the application of a strong binder to finer (more resilient) fibers resulted in improved performance in both Test C. The binder improves the stiffness enough to account for (i.e., offset) the lower stiffness expected from using finer fibers. Stiffness it is believed has a significant impact on test results in both Test C. Thus, the inventive fibrous insulation according to the present disclosure shows statistical improvement in cavity retention, as measured by Tests A, B, and C, as compared to a commercially available residential insulation product (i.e., Insulation 3) while also having a slightly higher R-value, a slightly lower weight, and a lower binder loading (i.e., LOI).

In addition, the wall cavity test system 2601 was used to run a second trial of the tests on 10 samples of a first conventional fiberglass insulation product (labeled “C1”), 10 samples of a second conventional fiberglass insulation product (labeled “C2”), and 10 samples of an inventive fiberglass insulation product (labeled “NGFG”). The C1 sample and the C2 sample were different fiberglass insulation products than the Control conventional fiberglass insulation product of the first trial. Each of the C1 samples included fibers having an average diameter of about 5.41 μm (21.3 HT), each of the C2 samples includes fibers having an average diameter of about 5.08 μm (20 HT), and each of the NGFG samples included fibers having an average diameter of 3.68 μm (14.5 HT) and a binder including a monomeric polyol. The C1 samples had a density of 17.14 kg/m3 (1.07 pcf), the C2 samples had a density of 15.70 kg/m3 (0.98 pcf), and the NGFG samples had a density of 13.94 kg/m3 (0.87 pcf). Furthermore, the C1 samples had an LOI of 4.1%, the C2 samples had an LOI of 3.6% and the NGFG samples had an LOI of 3.8%.

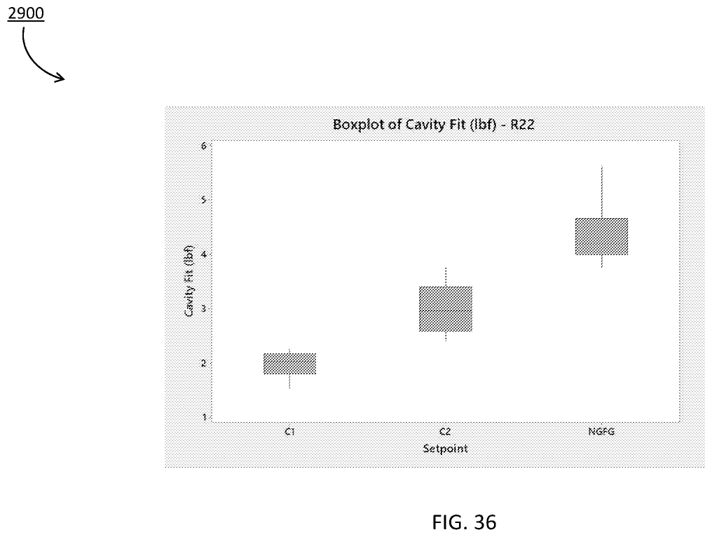

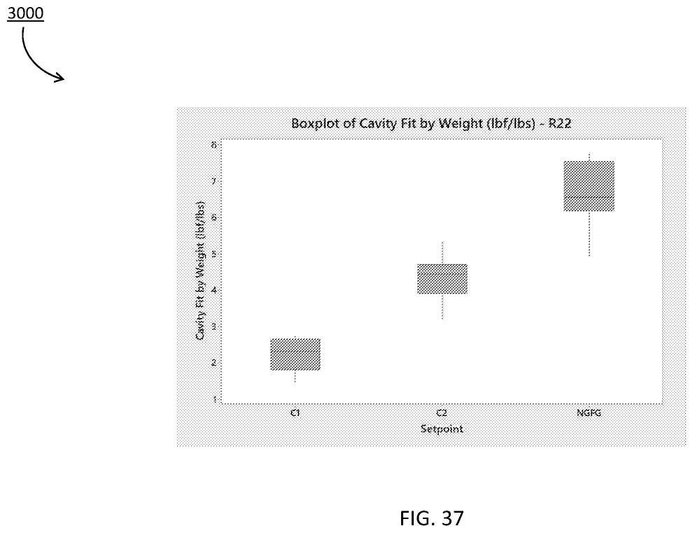

As shown in the box plot 2900 of FIG. 36, the NGFG insulation product exhibited a greater average maximum failure force (lbf) as compared to the C1 and C2 insulation products. For example, the NGFG insulation product achieved an average maximum failure force of greater than 17.8 N (4.0 lbf). Furthermore, as shown in the box plot 3000 of FIG. 37, the NGFG insulation product exhibited a statistically greater average maximum failure force by weight (lbf/lb.) as compared to the C1 and C2 insulation products. For example, the NGFG insulation product achieved an average maximum failure force by weight of greater than 58.8 N/kg (6 lbf/lb.), or greater than 49.1 N/kg (5.0 lbf/lb). Without being bound by theory, it is believed that the application of a strong binder to finer (more resilient) fibers resulted in improved performance in both Test C. The binder improves the stiffness enough to account for (i.e., offset) the lower stiffness expected from using finer fibers. Stiffness it is believed has a significant impact on test results in both Test C. Thus, the inventive fibrous insulation according to the present disclosure shows statistical improvement in cavity retention, as measured by Tests A, B, and C, as compared to a commercially available residential insulation product (i.e., Insulation 3) while also having a slightly higher R-value, a slightly lower weight, and a lower binder loading (i.e., LOI).

The fiberglass insulation materials of the present invention may have any combination or sub-combination of the properties disclosed and the ranges for those properties disclosed herein. While the present invention has been illustrated by the description of embodiments thereof, it is not the intention of the applicant to restrict or in any way limit the scope of the appended claims to such detail. Additional advantages and modifications will readily appear to those skilled in the art. While the fibrous insulation product has been illustrated herein as a flexible batt or blanket, other configurations and geometries can be used. Further, the fibrous insulation product may be used in a variety of ways and is not limited to any specific application. Therefore, the invention, in its broader aspects, is not limited to the specific details, the representative apparatus, and illustrative examples shown and described. Accordingly, departures can be made from such details without departing from the spirit or scope of the general inventive concepts.

1. A fibrous insulation product comprising:
a plurality of glass fibers; and
a cross-linked formaldehyde-free binder at least partially coating the fibers, wherein the cross-linked formaldehyde-free binder is formed from an aqueous binder composition comprising 5.0% by weight to 37.0% by weight of at least one monomeric polyol having at least four hydroxyl groups, based on the total solids content of the aqueous binder composition;
wherein the quantity of the cross-linked formaldehyde-free binder on the fibers is in the range of 2% to 10% by weight of the fibrous insulation product;
wherein the R-value of the fibrous insulation product is in the range of 10 to 54;
wherein the glass fibers have an average fiber diameter less than or equal to 3.81 μm;
wherein the fibrous insulation product has a density, when uncompressed, in the range of 4.80 kg/m³ to 43.25 kg/m³;
wherein the fibrous insulation product has a maximum failure force (wall) per product weight of 39.2 N/kg or greater.

2. The fibrous insulation product of claim 1, wherein the fibrous insulation product has a maximum failure force (wall) per product weight of 43.2 N/Kg or greater.

3. The fibrous insulation product of claim 1, wherein the glass fibers have an average fiber diameter in the range of 2.03 μm to 3.81 μm.

4. The fibrous insulation product of claim 1, wherein the glass fibers have an average fiber diameter in the range of 2.03 μm to 3.05 μm.

5. (canceled)

6. The fibrous insulation product of claim 1, wherein the aqueous binder composition further comprises at least 50.0% by weight of a cross-linking agent comprising a polymeric polycarboxylic acid having at least two carboxylic acid groups, based on the total solids content of the aqueous binder composition; and
wherein a ratio of molar equivalents of carboxylic acid groups to hydroxyl groups in the aqueous binder composition is between 0.60/1.0 and 1.0/0.6.

7. (canceled)

8. The fibrous insulation product of claim 1, wherein the quantity of the cross-linked formaldehyde-free binder on the fibers is in the range of 3.6% to 6.3% by weight of the fibrous insulation product;

9. The fibrous insulation product of claim 1, wherein the cross-linking agent is polyacrylic acid.

10. The fibrous insulation product of claim 9, wherein the cross-linking agent is present in the aqueous binder composition in an amount from 50.0% by weight to 85% by weight, based on the total solids content of the aqueous binder composition.

11. The fibrous insulation product of claim 1, wherein the monomeric polyol comprises at least five hydroxyl groups.

12. The fibrous insulation product of claim 11, wherein the monomeric polyol comprises one or more of a sugar alcohol, pentaerythritol, a primary alcohol, 1,2,4-butanetriol, trimethylolpropane, a short-chain alkanolamine, and mixtures thereof.

13. (canceled)

14. The fibrous insulation product of claim 1, wherein the aqueous binder composition further includes at least one long-chain polyol having at least two hydroxyl groups and a number average molecular weight of at least 2,000 Daltons.

15. (canceled)

16. (canceled)

17. The fibrous insulation product of claim 1, wherein the aqueous binder composition has a viscosity at 40% solids and 25° C. of 10 cP to 65 cP.

18. The fibrous insulation product of claim 1, wherein the aqueous binder composition has a viscosity at 40% solids and 25° C. of 300 cP to 500 cP.

19. The fibrous insulation product of claim 1, wherein the R-value of the fibrous insulation product is in the range of 10 to 16.

20. The fibrous insulation product of claim 1, wherein the R-value of the fibrous insulation product is in the range of 32 to 54.

21. The fibrous insulation product of claim 1,
wherein the quantity of the cross-linked formaldehyde-free binder on the fibers is in the range of 2% to 5% by weight of the fibrous insulation product;
wherein the R-value of the fibrous insulation product is in the range of 16 to 28;
wherein the glass fibers have an average fiber diameter of 3.05 μm to 3.81 μm; and
wherein the fibrous insulation product has a density, when uncompressed, in the range of 8.0 kg/m3 to 16.0 kg/m3.

22. A fibrous insulation product comprising:
a plurality of glass fibers; and
a cross-linked formaldehyde-free binder at least partially coating the fibers, wherein the cross-linked formaldehyde-free binder is formed from an aqueous binder composition comprising 5.0% by weight to 37.0% by weight of at least one monomeric polyol having at least four hydroxyl groups, based on the total solids content of the aqueous binder composition;
wherein the quantity of the cross-linked formaldehyde-free binder on the fibers is in the range of 2% to 10% by weight of the fibrous insulation product;
wherein the R-value of the fibrous insulation product is in the range of 10 to 54;
wherein the glass fibers have an average fiber diameter less than or equal to 3.81 μm HT;
wherein the fibrous insulation product has a density, when uncompressed, in the range of 4.80 kg/m3 to 43.25 kg/m3; and
wherein the fibrous insulation product has an average normal force of 3781 lbf or greater and maximum failure force (ceiling) of 2 kg or greater.

23. (canceled)

24. (canceled)

25. The fibrous insulation product of claim 22, wherein the glass fibers have an average fiber diameter in the range of 2.03 μm to 3.05 μm.

26. The fibrous insulation product of claim 22, wherein the aqueous binder composition further comprises at least 50.0% by weight of a cross-linking agent comprising a polymeric polycarboxylic acid having at least two carboxylic acid groups, based on the total solids content of the aqueous binder composition; and
wherein a ratio of molar equivalents of carboxylic acid groups to hydroxyl groups in the aqueous binder composition is between 0.60/1.0 and 1.0/0.6.

27. The fibrous insulation product of claim 26, wherein the ratio of molar equivalents of carboxylic acid groups to hydroxyl groups in the aqueous binder composition is between 0.80/1.0 and 1.0/0.8.

28. The fibrous insulation product of claim 22, wherein the quantity of the cross-linked formaldehyde-free binder on the fibers is in the range of 3.6% to 6.3% by weight of the fibrous insulation product.

29. (canceled)

30. The fibrous insulation product of claim 22, wherein the cross-linking agent is present in the aqueous binder composition in an amount from 50.0% by weight to 85% by weight, based on the total solids content of the aqueous binder composition.

31-36. (canceled)

37. The fibrous insulation product of claim 22, wherein the aqueous binder composition has a viscosity at 40% solids and 25° C. of 10 cP to 65 cP.

38. The fibrous insulation product of claim 22, wherein the aqueous binder composition has a viscosity at 40% solids and 25° C. of 300 cP to 500 cP.

39. (canceled)

40. (canceled)

41. The fibrous insulation product of claim 22,
wherein the quantity of the cross-linked formaldehyde-free binder on the fibers is in the range of 2% to 5% by weight of the fibrous insulation product;
wherein the R-value of the fibrous insulation product is in the range of 16 to 28;
wherein the glass fibers have an average fiber diameter of 3.05 μm to 3.81 μm; and
wherein the fibrous insulation product has a density, when uncompressed, in the range of 8.0 kg/m3 to 16.0 kg/m3.
